(19) United States
(12) Patent Application Publication
(10) Pub. No.: US 2026/0275157 A1
(43) Pub. Date: Sep. 17, 2026

(54) COMPOSITION, SURFACE TREATMENT AGENT, ARTICLE, AND METHOD FOR MANUFACTURING ARTICLE

(71) Applicant: AGC Inc., Tokyo (JP)

(72) Inventors: Masayuki HARAGUCHI, Tokyo (JP); Ryohei YAMAGUCHI, Tokyo (JP); Keigo MATSUURA, Tokyo (JP); Shimpei MORITA, Tokyo (JP); Yosuke TAKEDA, Tokyo (JP); Koki WATANABE, Tokyo (JP); Toyokazu ENTA, Tokyo (JP)

(73) Assignee: AGC Inc., Tokyo (JP)

(21) Appl. No.: 19/670,350

(22) Filed: May 7, 2026

Related U.S. Application Data
(63) Continuation of application No. PCT/JP2024/039595, filed on Nov. 7, 2024.

(30) Foreign Application Priority Data
Nov. 8, 2023 (JP) 2023-191141
Mar. 6, 2024 (JP) 2024-034019

(51) Int. Cl. C09D 183/04; B05D 1/00; B05D 5/08; G02B 1/18

(52) U.S. Cl. CPC C09D 183/04; B05D 1/60; B05D 5/08; G02B 1/18; B05D 2518/12

(57) ABSTRACT

A composition and the like capable of forming a surface-treated layer with excellent liquid repellency and excellent durability are provided. A composition comprises: a first compound having an organo (poly) siloxane residue, an alkylene chain comprising three or more carbon atoms, and a reactive silyl group a; and a second compound having: a hydrocarbon group comprising four or more carbon atoms, which has no organo (poly) siloxane residue and may have a functional group or a substituent; and a reactive silyl group b, wherein the composition satisfies Requirements (1) and (2) shown below: Requirement (1): in the first compound, one reactive silyl group a is connected to at least one of ends of the organo (poly) siloxane residue; and Requirement (2): in the second compound, one reactive silyl group b is connected to at least one of ends of the hydrocarbon group.

### INCORPORATION BY REFERENCE

This application is based upon and claims the benefit of priority from Japanese patent application No. 2023-191141, filed on Nov. 8, 2023, and Japanese patent application No. 2024-034019, filed on Mar. 6, 2024, and PCT application No. PCT/JP2024/039595 filed on Nov. 7, 2024, the disclosure of which is incorporated herein in its entirety by reference.

### BACKGROUND

The present disclosure relates to a composition, a surface treatment agent, an article, and a method for manufacturing an article.

In recent years, there has been a demand for a technique for preventing the surface of an article from being stained with fingerprints, and a technique for facilitating the removal of dirt in order to improve properties of the article such as its appearance and visibility. As a specific method, a method for treating the surface of an article by using a surface treatment agent is known.

For example, Patent Literature 1 discloses a mixed composition of an organosilicon compound (A1) comprising an organopolysiloxane residue represented by Formula (a1), an organosilicon compound (B) which may have a hydrocarbon group comprising 1 to 5 carbon atoms represented by Formula (b1), and an organosilicon compound (C) having a hydrocarbon group comprising 6 to 30 carbon atoms represented by Formula (c1), wherein the mass ratio of the compound (A1) to the sum total of the organosilicon compounds (B) and (C) is 0.060 or more.

Patent Literature 2 discloses a composition for forming a water-repellent layer, comprising a compound which may be partially hydrolytic condensed and/or co-condensed and comprises an organopolysiloxane residue represented by Formula (6), and a compound having an alkyl group comprising 8 to 30 carbon atoms represented by Formula (3) of which the content is 0.5 to 50 mass % based on 100 mass % of the content of the compound comprising the organopolysiloxane residue represented by Formula (6). Patent Literature 3 discloses a composition comprising an organosilicon compound (a) having at least one trialkylsilyl group and two or more hydrolyzable silicon groups, and a metal compound (b) in which at least one hydrolyzable group is bonded to a metal atom.
[Patent Literature 1] International Patent Publication No. WO2021/187184
[Patent Literature 2] Japanese Unexamined Patent Application Publication No. 2015-145463
[Patent Literature 3] Japanese Unexamined Patent Application Publication No. 2017-119849

### SUMMARY

A surface-treated layer formed by a surface treatment agent is required to have both water repellency and abrasion resistance.

According to the inventors of the present application, the surface-treated layers formed by the compositions disclosed in Patent Literatures 1 to 3 cannot have both water repellency and abrasion resistance.

The present disclosure has been made in view of the above-described circumstances, and a problem to be solved by an embodiment according to the present disclosure is to provide a composition capable of forming a surface-treated layer with excellent water repellency and excellent abrasion resistance for a substrate, and a surface treatment agent.

A problem to be solved by an embodiment according to the present disclosure is to provide an article having a surface-treated layer with excellent water repellency and excellent abrasion resistance, and a method for manufacturing such an article.

The present disclosure includes the below-shown aspects.

5<1>

A composition comprising:
a first compound having an organo (poly) siloxane residue, an alkylene chain comprising three or more carbon atoms, and a reactive silyl group a; and
a second compound having: a hydrocarbon group comprising four or more carbon atoms, which has no organo (poly) siloxane residue and may have a functional group or a substituent; and a reactive silyl group b, wherein
the composition satisfies Requirements (1) and (2) shown below:
Requirement (1): in the first compound, one reactive silyl group a is connected to at least one of ends of the organo (poly) siloxane residue; and
Requirement (2): in the second compound, one reactive silyl group b is connected to at least one of ends of the hydrocarbon group.
   <2>

The composition according to Item <1>, wherein the reactive silyl groups a and b are each independently represented by Formula (S1) or Formula (S2) shown below,

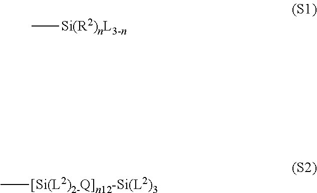

where
each R² is independently a monovalent hydrocarbon group,
each L is independently a hydrolyzable group, a group having a hydrolyzable group, or a hydroxyl group,
each L² is independently a hydrolyzable group, a group having a hydrolyzable group, a hydroxyl group, or a hydrocarbon group,
at least four of L² are hydrolyzable groups, groups having a hydrolyzable group, or hydroxyl groups,
each Q is independently an oxygen atom or an organic group having one carbon atom bonded to adjacent Si on both sides,
n is an integer of 0 to 2, and
n12 is an integer of 1 to 3.
   <3>

The composition according to Item <1> or <2>, wherein the organo (poly)siloxane residue contained in the first compound is represented by Formula (B1) shown below,

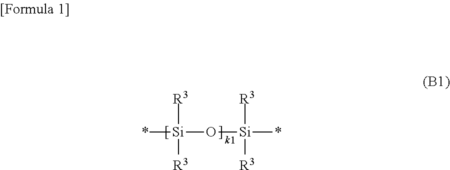

in Formula (B1),
each R³ is independently a hydrocarbon group,
k1 is a number of 1 or more, and
* indicates a part bonded to an adjacent atom.
   <4>

The composition according to any one of Items <1> to <3>, wherein the number of carbon atoms of the alkylene chain contained in the first compound is 11 or more.

<5>

The composition according to any one of Items <1> to <4>, wherein the first compound is represented by Formula (C) shown below,

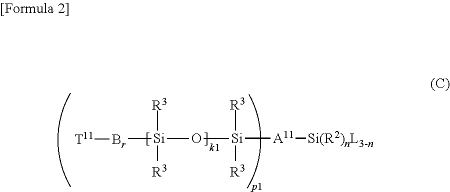

in Formula (C),
T¹¹ is a monovalent group comprising no reactive silyl group,
each B is independently —O— or —C(═O)—,
each r is independently 0 or 1,
each R³ is independently a hydrocarbon group,
k1 is a number of 1 or more,
p1 is an integer of 1 or more,
A¹¹ is a single bond or a linking group having a valence of (p1+1),
each R² is independently a hydrocarbon group,
each L is independently a hydrolyzable group, a group having a hydrolyzable group, or a hydroxyl group,
n is an integer of 0 to 2, and
at least one of T¹¹ and A comprises an alkylene chain comprising three or more carbon atoms.
   <6>

The composition according to Item <5>, wherein k1 is 2 to 600 in Formula (C).

<7>

The composition according to any one of Items <1> to <6>, wherein the hydrocarbon group contained in the second compound is not directly bonded to an oxygen atom or a nitrogen atom.

<8>

The composition according to any one of Items <1> to <7>, wherein in the second compound, the reactive silyl group b is connected to only one of ends of the hydrocarbon group.

<9>

The composition according to any one of Items <1> to <8>, wherein the second compound is represented by Formula (G),

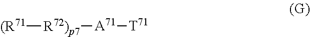

in Formula (G),
R⁷¹ is a hydrogen atom or [(CH₃)₃Q⁷¹-R⁷³]ₘ₇Q⁷²(CH₃)₃₋ₘ₇—,
each Q⁷¹ and Q⁷² is independently C or Si,
each R⁷³ is independently an alkylene group comprising 1 to 6 carbon atoms,
m7 is an integer of 0 to 3,
R⁷² is an alkylene group, and may have, when the number of carbon atoms is 2 or more, one or more groups selected from —O—, —S—, —C(═O)NH—, —NHC(═O)—, —C(═O)O—, —OC(═O)—, —C(═O)S—, —SC(═O)—, —S (═O)₂NH—, —NHS(═O)₂—, —S(═O)₂O—, —OS(═O)₂—, and a phenylene group between carbon atoms,
A⁷¹ is a single bond or a linking group having a valence of (p+1),
T⁷¹ is —Si(R²)ₙL₃₋ₙ,
each R² is independently a hydrocarbon group,
each L is independently a hydrolyzable group, a group having a hydrolyzable group, or a hydroxyl group,
n is an integer of 0 to 2, and
p7 is an integer of 1 or more.
   <10>

The composition according to any one of Items <1> to <9>, wherein the second compound is represented by Formula (E) shown below,

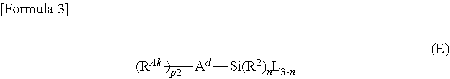

in Formula (E),
R^{Ak} is an alkyl group,
A^{d} is a single bond or a linking group having a valence of (p2+1),
p2 is an integer of 1 or more,
each R² is independently a hydrocarbon group,
each L is independently a hydrolyzable group, a group having a hydrolyzable group, or a hydroxyl group, and
n is an integer of 0 to 2.
   <11>

The composition according to Item <10>, wherein R^{Ak} is an alkyl group comprising 4 to 50 carbon atoms.

<12>

The composition according to Item <10> or <11>, wherein R^{Ak} is an alkyl group comprising 8 to 30 carbon atoms.

<13>

The composition according to any one of Items <1> to <9>, wherein the second compound is a composition represented by Formula (F) shown below,

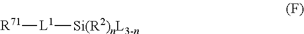

in Formula (F),
R⁷¹ is a hydrogen atom or [(CH₃)₃Q⁷¹-R⁷³—]ₘ₇Q⁷²(CH₃)₃₋ₘ₇—,
each Q⁷¹ and Q⁷² is independently C or Si,
at least one of Q⁷¹ and Q⁷² is Si,
each R⁷³ is independently an alkylene group comprising 1 to 6 carbon atoms,
m7 is an integer of 0 to 3,
L¹ is an alkylene group comprising 13 or more carbon atoms, and may have one or more groups selected from —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group between carbon atoms,
each R² is independently a hydrocarbon group,
each L is independently a hydrolyzable group, a group having a hydrolyzable group, or a hydroxyl group, and
n is an integer of 0 to 2.
   <14>

The composition according to Item <13>, wherein L¹ is an alkylene group comprising 13 to 36 carbon atoms.

<15>

The composition according to Item <13> or <14>, wherein R¹ is (CH₃)₃Si—.

<16>

The composition according to any one of Items <1> to <15>, wherein a mass ratio of the second compound to the first compound is 0.01 to 0.9.

<17>

The composition according to any one of Items <1> to <16>, wherein a mass ratio of the second compound to a total mass of the first and second compounds is 0.001 to 0.9.

<18>

The composition according to any one of Items <1> to <17>, further comprising a liquid medium.

<19>

A surface treatment agent comprising a composition according to any one of Items <1> to <18>.

<20>

A method for manufacturing an article including a surface-treated layer formed on a substrate by performing a surface treatment on the substrate by using the surface treatment agent according to Item <19>.

<21>

An article comprising a substrate, and a surface-treated layer disposed on the substrate, a surface of the surface-treated layer being treated with the surface treatment agent according to Item <19>.

<22>

The article according to Item <21>, wherein the article is an optical member.

<23>

The article according to Item <22>, wherein the article is a display or a touch panel.

According to an embodiment in accordance with the present disclosure, a composition capable of forming a surface-treated layer with excellent water repellency and excellent abrasion resistance for a substrate, and a surface treatment agent are provided.

According to an embodiment in accordance with the present disclosure, an article having a surface-treated layer with excellent water repellency and excellent abrasion resistance, and a method for manufacturing such an article are provided.

The above and other objects, features and advantages of the present disclosure will become more fully understood from the detailed description given hereinbelow.

### DESCRIPTION OF EMBODIMENTS

In the present disclosure, a numerical value range specified by using “-” includes numerical values before and after “-” as a lower limit value and an upper limit value, respectively, of the range.

In numerical ranges according to a stepwise manner in the present disclosure, the upper or lower limit value of one numerical range may be replaced with the upper or lower limit value of another numerical range according to a stepwise manner. Further, in numerical ranges disclosed in a stepwise manner in the present disclosure, the upper or lower limit value of a numerical range may be replaced with values shown in Examples.

In the present disclosure, the “surface-treated layer” refer to a layer that is formed on the surface of a substrate by a surface treatment.

In the present disclosure, “Me” may represent a methyl group.

In the present disclosure, when a compound or a group is represented by a specific formula (X), the compound or the group represented by this formula (X) may be expressed as a compound (X) or a compound X, and a group (X) or a group X, respectively.

In the present disclosure, “organo (poly)siloxane residue” refers to an organosiloxane residue or an organopolysiloxane residue.

### [Composition]

A composition according to the present disclosure comprises: a first compound having an organo (poly) siloxane residue, an alkylene chain comprising three or more carbon atoms, and a reactive silyl group a; and
a second compound having: a hydrocarbon group, which has no organo (poly) siloxane residue and may have a functional group or a substituent; and a reactive silyl group b, wherein,
the composition satisfies Requirements (1) and (2) shown below:

Requirement (1): in the first compound, one reactive silyl group a is connected to at least one of ends of the organo (poly) siloxane residue; and

Requirement (2): in the second compound, one reactive silyl group b is connected to at least one of ends of the hydrocarbon group.

According to the composition in accordance with the present disclosure, a surface-treated layer with excellent water repellency and excellent abrasion resistance can be formed.

Although the reason for why such an effect is obtained is not clear, it is presumed as follows.

The first compound contained in the composition according to the present disclosure has an organo (poly)siloxane residue and as a result, has excellent water repellency. Further, since the second compound contained in the composition according to the present disclosure comprises a hydrocarbon group, which has no organo (poly) siloxane residue and may have a functional group or a substituent, the composition has excellent abrasion resistance. To satisfy Requirements (1) and (2) refer to that in the first and second compounds, a reactive silyl group is connected to only one of the ends of the compound, or that one reactive silyl group is connected to each of both ends of the compound. It is considered that since each reactive silyl group contained in the first and second compounds can react with the substrate, it enables each of the first and second compounds to exert its effects, and as a result, making it possible to achieve both water repellency and abrasion resistance.

Each of components contained in the composition according to the present disclosure will be according to detail hereinafter.

### <First Compound>

The first compound has an organo (poly) siloxane residue, an alkylene chain comprising three or more carbon atoms, and a reactive silyl group a.

(Organo (poly)siloxane Residue)

The first compound comprises an organo (poly)siloxane residue. Only one organo (poly)siloxane residue may be contained in the first compound, or two or more organo (poly)siloxane residues may be contained in the first compound. When two or more organo (poly)siloxane residues are contained in the first compound, the two or more organo (poly)siloxane residues may be the same as each other or different from each other.

Examples of organo (poly)siloxane residues include a chain organo (poly)siloxane residue, a cyclic organo (poly)siloxane residue, and a cage-like organo (poly)siloxane residue. Among them, the organo (poly)siloxane residue is preferably a chain organo (poly)siloxane residue, and more preferably a divalent chain organo (poly)siloxane residue.

Examples of organo (poly)siloxane residues include chain organo (poly)siloxane residues represented by Formulas (B1) and (B2) shown below. In particular, the organo (poly)siloxane residue is preferably one represented by Formula (B1).

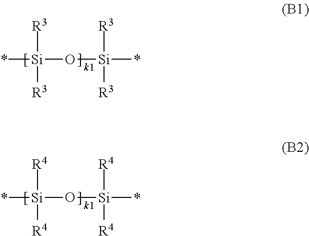

In Formula (B1),
each R³ is independently a hydrocarbon group,
k1 is a number of 1 or more, and
* indicates a part bonded to an adjacent atom.

In Formula (B2),
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more, and
* indicates a part bonded to an adjacent atom.

Examples of the hydrocarbon group represented by R³ or R⁴ in Formulas (B1) and (B2) include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, and a cyclic alkyl group, and is preferably a linear alkyl group, more preferably a methyl group, an ethyl group, an n-propyl group, or an n-butyl group, and still more preferably a methyl group. Further, the aromatic hydrocarbon group is preferably a phenyl group.

In Formulas (B1) and (B2), k1 is a number of 1 or more, preferably 1 to 600, more preferably 1 to 500, still more preferably 3 to 500, particularly preferably 9 to 50, extremely preferably 11 to 30, and most preferably 11 to 25.

In Formula (B2), each R⁴ is independently a hydrocarbon group or T¹¹-Bᵣ—(SiR³₂—O)ₖ₁—, and is preferably a hydrocarbon group. Details of the hydrocarbon group are the same as those of the hydrocarbon group represented by R³.

Each T¹¹ is independently a monovalent group, and its specific form is the same as that in T¹¹ in Formula (C) described later.

Specific embodiments of B and r are the same as those of B and r in Formula (C) described later.

### (Reactive Silyl Group)

The number of reactive silyl groups a contained in the first compound is 1 to 2.

In the first compound, one reactive silyl group a may be connected to one of ends of the organo (poly) siloxane residue, or one reactive silyl group a may be connected to each of both ends of the organo (poly) siloxane residue.

The reactive silyl group refers to a group in which a reactive group is bonded to a Si atom. The reactive group is preferably a hydrolyzable group, a group having a hydrolyzable group, or a hydroxyl group.

The hydrolyzable group is a group which becomes a hydroxyl group through a hydrolysis reaction. That is, a hydrolyzable silyl group represented by Si-L becomes a silanol group represented by Si—OH through a hydrolysis reaction. Such silanol groups further react with each other and form a Si—O—Si bond. Further, such a silanol group has a dehydration condensation reaction with a silanol group derived from an oxide present on the surface of the substrate, and thereby can form a Si—O—Si bond.

Examples of hydrolyzable groups include an alkoxy group, an aryloxy group, a halogen atom, an acyl group, an acyloxy group, an amino group, —O—N═CR^{r2}, and an isocyanato group (—NCO). The alkoxy group is preferably an alkoxy group comprising 1 to 4 carbon atoms.

The aryloxy group is preferably an aryloxy group comprising 3 to 10 carbon atoms. Note that the aryl group of the aryloxy group includes a heteroaryl group. The halogen atom is preferably a chlorine atom. The acyl group is preferably an acyl group comprising 1 to 6 carbon atoms.

The acyloxy group is preferably an acyloxy group comprising 1 to 6 carbon atoms. Each R^{r} is independently an alkyl group comprising 1 to 10 carbon atoms.

The group having a hydrolyzable group may be, for example, the group having a hydrolyzable group shown above as an example. The group having a hydrolyzable group is preferably —O-L^{A}-L^{B}. L^{A} is a divalent linking group, and L^{B} is a hydrolyzable group. The divalent linking group in L^{A} is preferably an alkylene group, and the number of carbon atoms of the alkylene group is preferably 1 to 10. Further, the divalent linking group in L^{A} preferably has an oxygen atom between carbon atoms. The hydrolyzable group represented by L^{B} is synonymous with the hydrolyzable group represented by R¹ described above, and its preferred embodiments are also the same as those described above. Specific examples of groups having a hydrolyzable group include —O—CH₂CH₂—OCH₃.

The reactive silyl group is preferably a group represented by Formula (S1) or (S2) shown below.

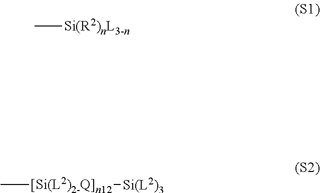

where
each R² is independently a monovalent hydrocarbon group,
each L is independently a hydrolyzable group, a group having a hydrolyzable group, or a hydroxyl group,
each L² is independently a hydrolyzable group, a group having a hydrolyzable group, a hydroxyl group, or a hydrocarbon group,
at least four of L² are hydrolyzable groups, groups having a hydrolyzable group, or hydroxyl groups,
each Q is independently an oxygen atom or an organic group having one carbon atom bonded to adjacent Si on both sides,
n is an integer of 0 to 2, and
n12 is an integer of 1 to 3.

When there are a plurality of reactive silyl groups in one molecule, the plurality of reactive silyl groups may be the same as each other or different from each other. The plurality of reactive silyl groups are preferably the same as each other in view of the availability of raw materials and the ease of the manufacturing of the compound.

Each R² is independently a monovalent hydrocarbon group, and is preferably a saturated monovalent hydrocarbon group.

Examples of the hydrocarbon group of R² include an alkyl group, a cycloalkyl group, an alkenyl group, and an allyl group, and in view of the ease of the synthesis and the like, is preferably a saturated hydrocarbon group and more preferably an alkyl group. The number of carbon atoms of the hydrocarbon group is preferably 1 to 6, more preferably 1 to 3, and still more preferably 1 to 2. The number of carbon atoms of R² is preferably 1 to 6, more preferably 1 to 3, and still more preferably 1 to 2.

Each L is independently a hydrolyzable group, a group having a hydrolyzable group, or a hydroxyl group. Each L² is independently a hydrolyzable group, a group having a hydrolyzable group, a hydroxyl group, or a hydrocarbon group. Details of the hydrolyzable groups in L and L² are the same as those described above.

In particular, each of L and L² is preferably an alkoxy group comprising 1 to 4 carbon atoms, an alkylene oxide-modified alkoxy group, or a halogen atom in view of the ease of the manufacturing of the compound. Each of L and L² is preferably an alkoxy group comprising 1 to 4 carbon atoms and more preferably an ethoxy group or a methoxy group in view of the fact that outgassing during the application is small and because the storage stability of the compound becomes more excellent.

n is an integer of 0 to 2, preferably 0 or 1, and more preferably 0. The presence of a plurality of L makes the adhesive property of the surface-treated layer for the substrate stronger.

n12 is an integer of 1 to 3, and is preferably 1 to 2 and more preferably 1 in view of the ease of the synthesis.

A plurality of L or L² present in one molecule may be the same as each other or different from each other. The plurality of L are preferably the same as each other in view of the availability of raw materials and the ease of the manufacturing of the compound. A plurality of R² present in one molecule may be the same as each other or different from each other. The plurality of R² are preferably the same as each other in view of the availability of raw materials and the ease of the manufacturing of the compound.

Each Q is independently an oxygen atom, or an organic group having one carbon atom bonded to adjacent Si on both sides. Note that “an organic group having one carbon atom bonded to adjacent Si on both sides” means that two Si are bonded to each other through one carbon atom. The organic group in Q is, for example, a group represented by —CR⁸₂—. Note that each R⁸ is independently a hydrogen atom or a hydrocarbon group. The hydrocarbon group in R⁸ is, for example, an alkyl group comprising 1 to 6 carbon atoms, and is preferably an alkyl group comprising 1 to 3 carbon atoms. In view of the durability of the surface-treated layer, Q is preferably an oxygen atom, —CH₂—, or —C(CH₃)₂—, more preferably an oxygen atom or —CH₂—, and still more preferably an oxygen atom.

The group (S2) is preferably —[Si(OR¹⁸)₂—O]ₙ₁₂—Si(OR¹⁸)₃ because the durability of the surface-treated layer becomes excellent, and is particularly preferably —Si(OR¹⁸)₂—O—Si(OR¹⁸)₃ where n12=1. Note that each R¹⁸ is independently a hydrocarbon group. Examples of the hydrocarbon group include an alkyl group, a cycloalkyl group, an alkenyl group, and an allyl group, and in view of the ease of the synthesis, is preferably a saturated hydrocarbon group and more preferably an alkyl group. The number of carbon atoms of R² is preferably 1 to 6, more preferably 1 to 3, and still more preferably 1 to 2.

Specific examples of the group (S2) include —Si(OCH₃)₂—O—Si(OCH₃)₃, —Si(OCH₃)₂—CH₂—Si(OCH₃)₃, —Si(OCH₃)₂—C(CH₃)₂—Si(OCH₃)₃, —Si(OCH₂CH₃)₂—O—Si(OCH₃)₃, —Si(OCH₃)₂—O—Si(OCH₂CH₃)₃, —Si(OCH₂CH₃)₂—O—Si(OCH₂CH₃)₃, —Si(OCH₂CH₃)₂—CH₂—Si(OCH₃)₃, —Si(OCH₃)₂—CH₂—Si(OCH₂CH₃)₃, —Si(OCH₂CH₃)₂—CH₂—Si(OCH₂CH₃)₃, —Si(OCH₂CH₃)₂—C(CH₃)₂—Si(OCH₃)₃, —Si(OCH₃)₂—C(CH₃)₂—Si(OCH₂CH₃)₃, —Si(OCH₂CH₃)₂—C(CH₃)₂—Si(OCH₂CH₃)₃, —Si(OH)₂—O—Si(OH)₃, —Si(OH)₂—O—Si(OCH₃)₃, —Si(OCH₃)₂—O—Si(OH)₃, —Si(OH)₂—CH₂—Si(OH)₃, —Si(OH)₂—CH₂—Si(OCH₃)₃, —Si(OCH₃)₂—CH₂—Si(OH)₃, —Si(OH)₂—C(CH₃)₂—Si(OH)₃, —Si(OH)₂—C(CH₃)₂—Si(OCH₃)₃, and —Si(OCH₃)₂—C(CH₃)₂—Si(OH)₃

The reactive silyl group is preferably an alkoxysilyl group or a trichlorosilyl group because the homogeneity and the durability of the surface-treated layer become excellent. The reactive silyl group is more preferably an alkoxysilyl group in view of the ease of the handling of by-products generated in the reaction with the substrate. The alkoxysilyl group is preferably a dialkoxysilyl group or a trialkoxysilyl group, and more preferably a trialkoxysilyl group.

Further, the reactive silyl group may be a group represented by Formula (S3) shown below.

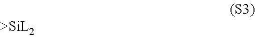

L is the same as L in Formula (S1).

### (Alkylene Chain Comprising Three or More Carbon Atoms)

The first compound comprises an alkylene chain comprising three or more carbon atoms.

The alkylene chain may be linear or branched, and is preferably linear.

The number of carbon atoms of the alkylene chain is preferably 11 or more, preferably 11 to 42, more preferably 11 to 30, and still more preferably 18 to 30.

The number average molecular weight (Mn) of the first compound is preferably 500 to 20,000, more preferably 600 to 18,000, and still more preferably 700 to 15,000.

When Mn is 500 or larger, the abrasion resistance of the surface-treated layer becomes more excellent. When Mn is 20,000 or less, the viscosity can be easily adjusted within an appropriate range and the solubility is improved, so that the handling property during the film formation (i.e., during the deposition of the compound) becomes excellent.

The composition according to the present disclosure may contain impurities such as by-products and the like generated in the manufacturing process of the first compound.

The content of the first compound is preferably 0.001 to 50 mass %, more preferably 0.01 to 20 mass %, and still more preferably 0.1 to 10 mass % based on the total amount of the composition according to the present disclosure. In the case where the composition according to the present disclosure is used in a wet-coating method, the content of the first compound may be 0.01 to 10 mass %, 0.02 to 5 mass %, 0.03 to 3 mass %, or 0.05 to 2 mass % based on the total amount of the composition according to the present disclosure.

Examples of the first compound include a compound having a chain organo (poly)siloxane residue and a reactive silyl group connected to only one of the ends of the chain organo (poly)siloxane residue (hereinafter also referred to as a “first compound S”), and a compound having a chain organo (poly)siloxane residue and reactive silyl groups respectively connected to both ends of the chain organo (poly)siloxane residue (hereinafter also referred to as a “first compound D”).

As the first compound, the first compound S may be used alone; the first compound D may be used alone; or the first compound S and the first compound D may be used in combination. In any of the cases, one type of first compound S may be used alone; two or more types thereof may be used in combination; one type of first compound D may be used alone; or two or more types thereof may be used in combination.

### [First Compound S]

The first compound S has a chain organo (poly)siloxane residue and a reactive silyl group connected to only one of the ends of the chain organo (poly)siloxane residue. In the present disclosure, the term “reactive silyl group connected to only one of the ends of a chain organo (poly)siloxane residue” refers to a reactive silyl group connected to only one of the ends of a chain organo (poly)siloxane residue directly or indirectly through another chemical structure.

### (Chain Organo (Poly)siloxane Residue)

The first compound S comprises a chain organo (poly)siloxane residue. Only one chain organo (poly)siloxane residue may be contained in the first compound S, or two or more chain organo (poly)siloxane residues may be contained in the first compound S. When two or more chain organo (poly)siloxane residues are contained in the first compound S, the two or more chain organo (poly)siloxane residues may be the same as each other or different from each other. When two or more chain organo (poly)siloxane residues are contained in the first compound S, it is sufficient if there is no chain organo (poly)siloxane residue to which reactive silyl groups are connected to the ends on both sides, and a reactive silyl group is connected to the end on one of the sides of at least one chain organo (poly)siloxane.

Details of the chain organo (poly)siloxane residues are the same as those described above for the chain organo (poly)siloxane residue contained in the first compound. In particular, the chain organo (poly)siloxane residue is preferably represented by Formula (B1) or (B2), and more preferably represented by Formula (B1).

(Reactive Silyl Group) Details of the reactive silyl groups are the same as those described above for the reactive silyl group contained in the first compound.

The number of reactive silyl groups contained in the first compound S is 1.

### (Compound (C))

In an embodiment, the first compound S is preferably represented by Formula (C) shown below.

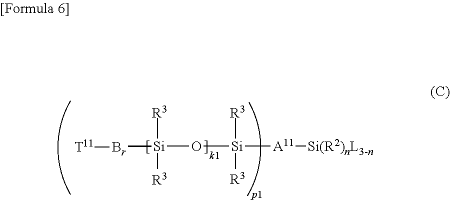

in Formula (C),
T¹¹ is a monovalent group comprising no reactive silyl group,
each B is independently —O— or —C(═O)—,
each r is independently 0 or 1,
each R³ is independently a hydrocarbon group,
each k1 is independently a number of 1 or more,
p1 is an integer of 1 or more,
A¹¹ is a linking group having a valence of (p1+1),
each R² is independently a hydrocarbon group,
each L is independently a hydrolyzable group, a group having a hydrolyzable group, or a hydroxyl group,
n is each independently an integer of 0 to 2, and
at least one of T¹¹ and A comprises an alkylene chain comprising three or more carbon atoms.

In Formula (C), R³ and k1 are the same as R³ and k1 in Formula (B1).

R², L, and n are the same as R², L, and n in Formula (Si).

In Formula (C), T¹¹ is a monovalent group.

Examples of T¹¹ include an alkyl group, each T¹₃M¹- (note that M¹ is Si, Sn, or Ge; and T¹ is independently a hydrocarbon group or a trialkylsilyloxy group), each T¹₃M¹-R¹— (note that M¹ is Si, Sn, or Ge; each T¹ is independently a hydrocarbon group or a trialkylsilyloxy group; and R¹ is an alkylene group), a monovalent cyclic polysiloxane residue, a monovalent cage-like polysiloxane residue, and a combination of a monovalent cyclic polysiloxane residue or a monovalent cage-like polysiloxane residue and a divalent hydrocarbon group.

The alkyl group represented by T¹¹ may be any of a linear alkyl group, a branched alkyl group, and a cyclic alkyl group, and is preferably a linear alkyl group or a branched alkyl group. The number of carbon atoms of the alkyl group may be one, or may be two or more. When the number of carbon atoms of the alkyl group is two or more, the number of carbon atoms is preferably 2 to 30, more preferably 3 to 28, and still more preferably 4 to 22.

M¹ in T¹₃M¹- and T¹₃M¹-R¹— are preferably Si.

T¹ in T¹₃M¹- and T¹₃M¹-R¹— is preferably an alkyl group or a trialkylsilyloxy group, and more preferably a methyl group, a butyldimethylsilyloxy group, a trimethylsilyloxy group, or a triethylsilyloxy group.

R¹ is preferably an alkylene group comprising 1 to 20 carbon atoms, more preferably an alkylene group comprising 1 to 10 carbon atoms, still more preferably an alkylene group comprising 1 to 5 carbon atoms, and particularly preferably an ethylene group.

In an embodiment, T¹¹ is preferably an alkyl group or a trialkylsilyl group, and more preferably a methyl group or a trimethylsilyl group.

The monovalent cyclic polysiloxane residue is preferably a group represented by Formula (T1) shown below.

In Formula (T1),
each R^{T} is independently a hydrocarbon group or a hydrocarbon group having a substituent, and
s is an integer of 1 to 4.

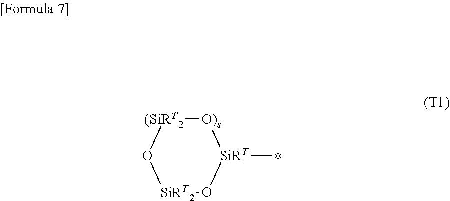

Examples of the hydrocarbon group represented by R^{T} include an aliphatic hydrocarbon group and an aromatic hydrocarbon group. In particular, the hydrocarbon group is preferably an aliphatic hydrocarbon group and more preferably an alkyl group.

Among hydrocarbon groups represented by R^{T}, the alkyl group may be any of a linear alkyl group, a branched alkyl group, and a cyclic alkyl group, and is preferably a linear alkyl group. The number of carbon atoms of the alkyl group is preferably 1 to 10, more preferably 1 to 8, and still more preferably 1 to 4. Specifically, the alkyl group is preferably a methyl group, an ethyl group, an n-propyl group, or an n-butyl group, and more preferably a methyl group.

Examples of the hydrocarbon group contained in the hydrocarbon group having the substituent represented by R^{T} include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, and a cyclic alkyl group, and is preferably a linear alkyl group. The number of carbon atoms of the alkyl group contained in the substituted alkyl group is preferably 1 to 10, more preferably 1 to 8, and still more preferably 2 to 4.

Examples of the substituent in the hydrocarbon group having the substituent represented by R^{T} include a halogen atom, a hydroxyl group, an alkoxy group, a trialkylsilyl ether group, a trialkylsilyl group, an amino group, a nitro group, a cyano group, a sulfonyl group, and a trifluoromethyl group.

The plurality of R^{T} may be the same as each other or different from each other, but are preferably the same as each other in view of the ease of the manufacturing.

Examples of monovalent cyclic polysiloxane residues include groups shown below.

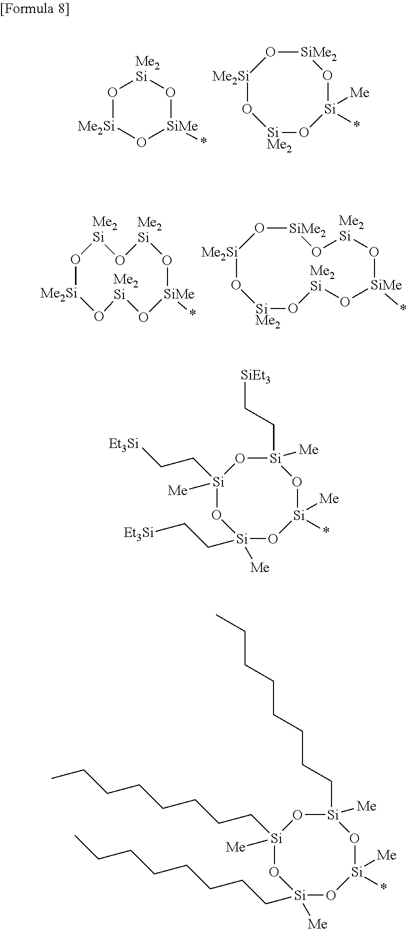

The monovalent cage-like polysiloxane residue is preferably a group represented by Formula (T2) shown below.

In Formula (T2),
each R⁵ is independently a hydrocarbon group or a trialkylsilyloxy group.

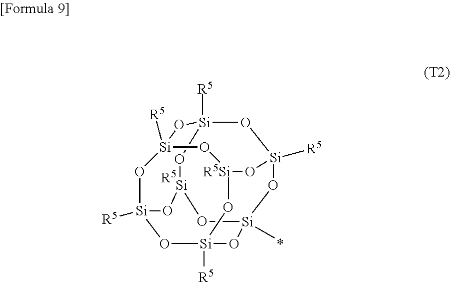

Examples of the hydrocarbon group represented by R⁵ include an aliphatic hydrocarbon group and an aromatic hydrocarbon group. In particular, the hydrocarbon group is preferably an aliphatic hydrocarbon group and more preferably an alkyl group. The alkyl group may be any of a linear alkyl group, a branched alkyl group, and a cyclic alkyl group, and preferably a linear alkyl group or a branched alkyl group, more preferably a methyl group, an ethyl group, an n-propyl group, an n-butyl group, or an isobutyl group, and still more preferably an isobutyl group.

The alkyl group contained in the trialkylsilyloxy group represented by R⁵ may be any of a linear alkyl group, a branched alkyl group, and a cyclic alkyl group, and preferably a linear alkyl group, more preferably a methyl group, an ethyl group, an n-propyl group, or an n-butyl group, and still more preferably a methyl group. When R⁵ is a trialkylsilyloxy group, the three alkylsilyloxy groups may be the same as each other or different from each other, but is preferably the same as each other in view of the ease of the manufacturing.

Examples of monovalent cage-like polysiloxane residues include groups shown below.

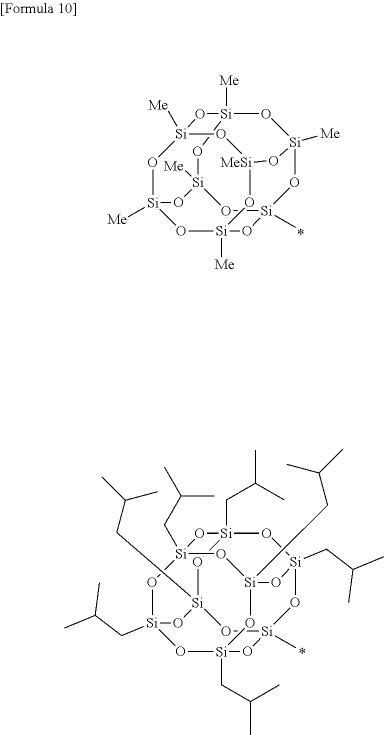

Examples of the divalent hydrocarbon group in the combination of the monovalent cyclic polysiloxane residue or the monovalent cage-like polysiloxane residue and the divalent hydrocarbon group include an alkylene group. The number of carbon atoms of the alkylene group is preferably 1 to 20, more preferably 1 to 10, and still more preferably 1 to 5.

In Formula (C), each B is independently —O— or —C(═O)—, and is preferably —O—. Further, in Formula (C), r is 0 or 1, and when r is 0, T¹¹ is directly bonded to Si.

In Formula (C), p1 is an integer of 1 or more, and preferably an integer of 1 to 3, more preferably 1 to 2, and still more preferably 1. When p1 is 2 or more, a plurality of T¹¹-Bᵣ—[Si(R³)₂—O]ₖ₁—Si(R³)₂— may be the same as each other or different from each other.

In Formula (C), A¹¹ is a linking group having a valence of (p1+1). Examples of A¹¹ include: an alkylene group, an organo (poly)siloxane residue, a polyalkylene oxide group, and combinations thereof; and combinations of them with a group having a valence of (p1+1).

Examples of alkylene groups include an alkylene group comprising 1 to 30 carbon atoms which may or may not have an etheric oxygen atom. Further, the alkylene group is preferably an alkylene group comprising 1 to 20 carbon atoms.

Examples of organo (poly)siloxane residues include a group represented by the above-shown Formula (B1).

Examples of polyalkylene oxide groups include a group represented by Formula (XO)ₘ. Note that each X is independently an alkylene group comprising 1 to 5 carbon atoms, and m is an integer of 1 or more. The number of carbon atoms of X is preferably 1 to 4 and more preferably 2 or 3. m is preferably 1 to 200, more preferably 1 to 20, and still more preferably 1 to 10.

Examples of A¹¹ include A in Formula A(Si(R²)ₙL₃₋ₙ)_{q1} described later.

In particular, A¹¹ preferably comprises an alkylene chain comprising three or more carbon atoms, and preferred embodiments of the alkylene chain comprising three or more carbon atoms are the same as those described above.

In an embodiment, T¹¹ in Formula (C) is preferably a trialkylsilyl group or an alkyl group, and more preferably a trimethylsilyl group or a methyl group.

B is preferably O, and r is 0 or 1.

R³ is preferably a methyl group.

k1 is preferably 2 to 600, more preferably 3 to 500, still more preferably 6 to 50, particularly preferably 6 to 30, and most preferably 6 to 25.

p1 is preferably an integer of 1 to 15, more preferably an integer of 1 to 6, still more preferably an integer of 1 to 4, and particularly preferably 1.

A¹¹ is preferably an alkylene group comprising 1 to 30 carbon atoms or a group obtained by eliminating Si(R²)ₙ L₃₋ₙ from a group (3-1A) described later, and more preferably an alkylene group comprising 1 to 30 carbon atoms or a group obtained by eliminating Si(R²)ₙL₃₋ₙ from a group (3-1A-4) described later.

The number average molecular weight (Mn) of the first compound S is preferably 500 to 20,000, more preferably 600 to 18,000, and still more preferably 700 to 15,000.

In an embodiment, Mn of the first compound S may be 500 to 5,000 or 500 to 3,000.

When Mn is 500 or larger, the abrasion resistance of the surface-treated layer becomes more excellent. When Mn is 20,000 or less, the viscosity can be easily adjusted within an appropriate range and the solubility is improved, so that the handling property during the film formation (i.e., during the deposition of the compound) becomes excellent.

The composition according to the present disclosure may comprise only one type of first compound S or may comprise two or more types of first compounds S.

The composition according to the present disclosure may comprise impurities such as by-products generated in the manufacturing process of the first compound S.

The content of the first compound S is preferably 0.001 to 50 mass %, more preferably 0.01 to 20 mass %, and still more preferably 0.1 to 10 mass % based on the total amount of the composition according to the present disclosure. In the case where the composition according to the present disclosure is used in a wet-coating method, the content of the first compound may be 0.01 to 10 mass %, 0.02 to 5 mass %, 0.03 to 3 mass %, or 0.05 to 2 mass % based on the total amount of the composition according to the present disclosure.

The content of the first compound S is preferably 5 mass % or more and less than 65 mass %, more preferably 10 to 64 mass % based on the total solid content of the composition according to the present disclosure, and may be 20 to 60 mass % or 30 to 50 mass % based thereon.

### [First Compound D]

The first compound D has a chain organo (poly)siloxane residue and reactive silyl groups respectively connected to both ends of the chain organo (poly)siloxane residue. In the present disclosure, “reactive silyl groups respectively connected to both ends of a chain organo (poly)siloxane residue” refer to reactive silyl groups respectively connected to both ends of a chain organo (poly)siloxane residue directly or indirectly through another chemical structure.

### (Chain Organo (Poly)siloxane Residue)

The first compound D comprises a chain organo (poly)siloxane residue. Only one chain organo (poly)siloxane residue may be contained in the first compound D, or two or more chain organo (poly)siloxane residues may be contained in the first compound D. When two or more chain organo (poly)siloxane residues are contained in the first compound D, the two or more chain organo (poly)siloxane residues may be the same as each other or different from each other. When two or more chain organo (poly)siloxane residues are contained in the first compound D, it is sufficient if reactive silyl groups are connected to the ends on both sides of at least one chain organo (poly)siloxane residue.

Details of the chain organo (poly)siloxane residues are the same as those described above for the chain organo (poly)siloxane residue contained in the specific silane compound. In particular, the chain organo (poly)siloxane residue is preferably represented by Formula (B1) or (B2), and more preferably represented by Formula (B1).

### (Reactive Silyl Group)

Details of the reactive silyl groups are the same as those described above for the reactive silyl group contained in specific silane compounds.

The number of reactive silyl groups contained in the first compound D is 1 or more for each end of the chain organo (poly) siloxane residue.

### (Compound (D))

In an embodiment, the first compound D is preferably represented by Formula (D) shown below.

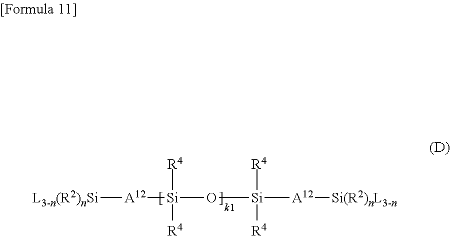

In Formula (D),
each R⁴ is independently a hydrocarbon group or T¹¹-Bᵣ—(SiR³₂—O)ₖ₁—,
each T¹¹ is independently a monovalent group,
each B is independently —O— or —C(═O)—,
each r is independently 0 or 1,
each R³ is independently a hydrocarbon group,
each k1 is independently a number of 1 or more,
each A12 is independently a divalent linking group,
each R² is independently a hydrocarbon group, and
each L is independently a hydrolyzable group, a group having a hydrolyzable group, or a hydroxyl group,
each n is independently an integer of 0 to 2.

In Formula (D), R⁴ and k1 are the same as R⁴ and k1 in Formula (B2).

R², L, and n are the same as R², L, and n in Formula (Si).

Examples of A¹² include an alkylene group, an organo (poly) siloxane residue, a polyalkylene oxide group, and combinations thereof.

Examples of alkylene groups include an alkylene group comprising 1 to 30 carbon atoms which may or may not have an etheric oxygen atom. Further, the alkylene group is preferably an alkylene group comprising 1 to 20 carbon atoms.

Examples of organo (poly)siloxane residues include a group represented by the above-shown Formula (B1) or (B2).

Examples of polyalkylene oxide groups include a group represented by Formula (XO)ₘ. Note that each X is independently an alkylene group comprising 1 to 5 carbon atoms, and m is an integer of 1 or more. The number of carbon atoms of X is preferably 1 to 4 and more preferably 2 or 3. m is preferably 1 to 100, more preferably 1 to 10, and still more preferably 1 to 5.

Examples of A¹² include, among A in A(Si(R²)ₙL₃₋ₙ) described later, a divalent group.

In an embodiment, R⁴ is preferably a methyl group. k1 is preferably 2 to 600, more preferably 3 to 500, still more preferably 6 to 50, particularly preferably 6 to 30, and most preferably 6 to 25.

A¹² is preferably an alkylene group comprising 1 to 30 carbon atoms or a group obtained by eliminating Si(R²)ₙ L₃₋ₙ from a group (3-1A) described later, and more preferably an alkylene group comprising 1 to 30 carbon atoms or a group obtained by eliminating Si(R²)ₙ L₃₋ₙ from a group (3-1A-4) described later.

q1 is preferably an integer of 1 to 15, more preferably an integer of 1 to 6, still more preferably an integer of 1 to 4, and particularly preferably 2 or 3.

The number average molecular weight (Mn) of the first compound D is preferably 500 to 20,000, more preferably 600 to 18,000, and still more preferably 700 to 15,000. In an embodiment, Mn of the first compound D may be 500 to 5,000 or 500 to 3,000.

When Mn is 500 or larger, the abrasion resistance of the surface-treated layer becomes more excellent. When Mn is 20,000 or less, the viscosity can be easily adjusted within an appropriate range and the solubility is improved, so that the handling property during the film formation (i.e., during the deposition of the compound) becomes excellent.

The composition according to the present disclosure may comprise only one type of the first compound D or may comprise two or more types of first compounds D.

The composition according to the present disclosure may comprise impurities such as by-products generated in the manufacturing process of the first compound D.

The content of the first compound D is preferably 0.001 to 50 mass %, more preferably 0.01 to 20 mass %, and still more preferably 0.1 to 10 mass % based on the total amount of the composition according to the present disclosure. In the case where the composition according to the present disclosure is used in a wet-coating method, the content of the first compound D may be 0.01 to 10 mass %, 0.02 to 5 mass %, 0.03 to 3 mass %, or 0.05 to 2 mass % based on the total amount of the composition according to the present disclosure.

The content of the first compound D is preferably more than 35 mass % and not more than 95 mass %, and more preferably 36 to 90 mass % based on the total solid content of the composition according to the present disclosure, and may be 40 to 80 mass % or 50 to 70 mass % based thereon.

### [Partial Structure of First Compound S and First Compound D]

Preferred embodiments of A¹¹(Si(R²)ₙL₃₋ₙ) in Formula (C) and A¹²(Si(R²)ₙL₃₋ₙ) in Formula (D) will be disclosed hereinafter in detail. Hereinafter, A¹¹(Si(R²)ₙL₃₋ₙ) in Formula (C) and A¹²(Si(R²)ₙL₃₋ₙ)_{q1} in Formula (D) will be collectively referred to as A(Si(R²)ₙL₃₋ₙ).

However, A is a group having a valence of (p1+1) in the case of Formula (C), and is a divalent group in the case of Formula (D).

The group represented by A(Si(R²)ₙL₃₋ₙ) is preferably a group (3-1A) or a group (3-1B), and more preferably the group (3-1A).

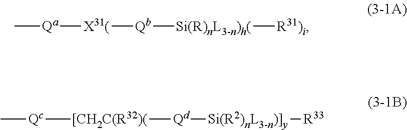

Note that in Formulas (3-1A) and (3-1B), the definitions of R², L, and n are the same as those described above.

In Formula (3-1A), Q^{a} is a single bond or a divalent linking group.

Examples of divalent linking groups include a divalent hydrocarbon group, a divalent heterocyclic group, —O—, —S—, —SO₂—, —N(R^{d})—, —C(O)—, —Si(R^{a})₂—, and groups in which two or more of these groups are combined.

The aforementioned divalent hydrocarbon group may be a saturated divalent hydrocarbon group, a divalent aromatic hydrocarbon group, an alkenylene group, or an alkynylene group. The saturated divalent hydrocarbon group may be a straight chain, a branched chain, or a ring, and its examples include an alkylene group. The number of carbon atoms of the alkylene group is preferably 1 to 30, more preferably 1 to 20, still more preferably 4 to 20, and particularly preferably 5 to 15. Further, the divalent aromatic hydrocarbon group is preferably one comprising 5 to 20 carbons atoms, and examples include a phenylene group. Alternatively, the divalent aromatic hydrocarbon group may be an alkenylene group comprising 2 to 20 carbon atoms or an alkynylene group comprising 2 to 20 carbon atoms.

The aforementioned R^{a} is an alkyl group (preferably one comprising 1 to 10 carbon atoms) or a phenyl group. The aforementioned R^{d} is a hydrogen atom or an alkyl group (preferably one comprising 1 to 10 carbon atoms).

Note that examples of groups in which two or more of the aforementioned groups are combined include —OC(O)—, —C(O)O—, —C(O) S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, an alkylene group having —SO₂N(R^{d})—, and an alkylene group-Si(R^{a})₂-phenylene group-Si(R^{a})₂.

In Formula (3-1A), X³¹ is a single bond, an alkylene group, a carbon atom, a nitrogen atom, a silicon atom, an organo (poly)siloxane residue having a valence of 2 to 8, or a group having a ring having a valence of (i+1).

Note that the alkylene group may have O—, a silphenylene skeleton group, a divalent organo (poly)siloxane residue, or a dialkylsilylene group. The alkylene group may have a plurality of groups selected from the group consisting of —O—, a silphenylene skeleton group, a divalent organo (poly)siloxane residue, and a dialkylsilylene group.

The number of carbon atoms of the alkylene group represented by X³¹ is preferably 1 to 20 and more preferably 1 to 10.

Examples of organo (poly)siloxane residues having a valence of 2 to 8 include a divalent organo (poly)siloxane residue and an organo (poly)siloxane residue having a valence of (w2+1) described later.

In Formula (3-1A), when X³¹ is a group having a ring having a valence of (i+1), Q^{a}, (-Q^{b}-Si(R²)ₙ L₃₋ₙ), and R³¹ are directly bonded to an atom(s) constituting the ring. However, this ring is a ring other than the organopolysiloxane ring.

The ring in X³¹ may be any of a monocyclic ring, a condensed polycyclic ring, a bridged ring, a spiro ring, and an assembled polycyclic ring, and the atoms constituting the ring may be a carbon ring consisting solely of carbon atoms or a heterocyclic ring consisting of heteroatoms having a valence of 2 or more and carbon atoms. Further, the bond between the atoms constituting the ring may be a single bond or multiple bonds. Further, the ring may be an aromatic ring or a non-aromatic ring.

The monocyclic ring is preferably a 4 to 8 membered ring, and more preferably a 5 membered ring or a 6 membered ring. The condensed polycyclic ring is preferably a condensed polycyclic ring in which two or more 4 to 8 membered rings are condensed, more preferably a condensed polycyclic ring in which two or three rings each selected from a 5 membered ring and a 6 membered ring are bonded, and still more preferably a condensed polycyclic ring in which one or two rings each selected from a 5 membered ring and a 6 membered ring and one 4 membered ring are bonded. The bridged ring is preferably a bridged ring in which a 5 membered ring or a 6 membered ring is the largest ring, and the spiro ring is preferably a spiro ring consisting of two 4 to 6 membered rings. The assembled polycyclic ring is preferably an assembled polycyclic ring in which two or three rings each selected from a 5 membered ring and a 6 membered ring are bonded through a single bond, through one to three carbon atoms, or through one heteroatom having a valence of two or three. Note that in the assembled polycyclic ring, one of Q^{a}, (-Q^{b}-Si(R²)ₙ L₃₋ₙ), and R³¹ (when i=1 or more) is preferably bonded to each ring.

The heteroatoms constituting the aforementioned ring are preferably nitrogen atoms, oxygen atoms, and sulfur atoms, and more preferably nitrogen atoms and oxygen atoms. The number of heteroatoms constituting the ring is preferably three or less. Further, when the number of heteroatoms constituting the ring is two or more, these heteroatoms may be different from one another.

In view of the ease of the manufacturing of the compound and because the abrasion resistance of the surface-treated layer becomes more excellent, the ring in X³¹ is preferably one selected from the group consisting of a 3 to 8 membered aliphatic ring, a benzene ring, a 3 to 8 membered heterocyclic ring, a condensed ring in which two or three of these rings are condensed, a bridged ring in which a 5 membered ring or a 6 membered ring is the largest ring, and an assembled polycyclic ring having two or more such rings in which the linking group is a single bond, an alkylene group comprising three or fewer carbon atoms, an oxygen atom, or a sulfur atom.

Preferred rings are a benzene ring, a 5 or 6 membered aliphatic ring, a 5 or 6 membered heterocyclic ring having a nitrogen atom or an oxygen atom, and a condensed ring consisting of a 5 or 6 membered carbon ring and a 4 to 6 membered heterocyclic ring.

Specific examples of rings include rings shown below, a 1,3-cyclohexadiene ring, a 1,4-cyclohexadiene ring, an anthracene ring, a cyclopropane ring, a decahydronaphthalene ring, a norbornene ring, a norbornadiene ring, a furan ring, a pyrrole ring, a thiophene ring, a pyrazine ring, a morpholine ring, an aziridine ring, an isoquinoline ring, an oxazole ring, an isoxazole ring, a thiazole ring, an imidazole ring, a pyrazole ring, a pyran ring, a pyridazine ring, a pyrimidine ring, and an indene ring. Note that rings having an oxo group (═O) are also shown below.

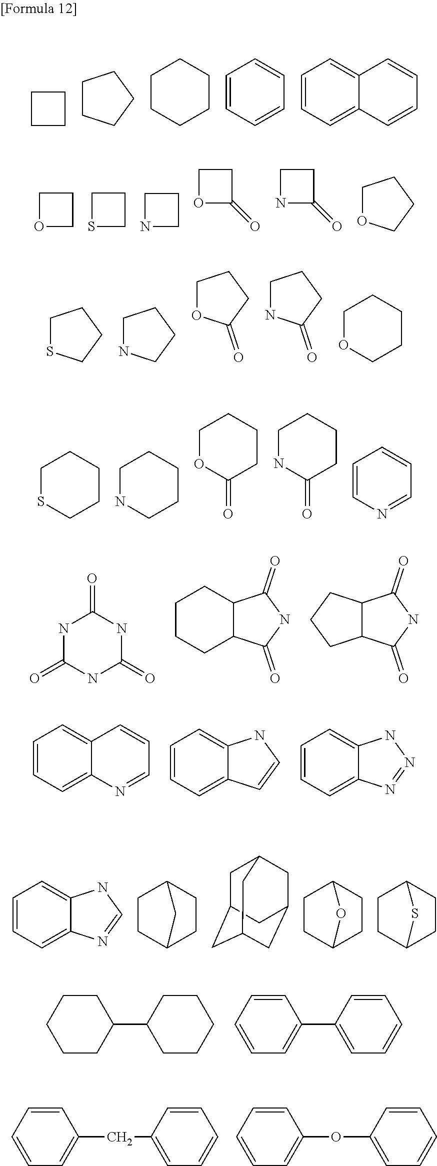

The bond that does not constitute the ring of atoms constituting the ring in X³¹ is a bond that is bonded to Q^{a}, (-Q^{b}Si(R²)ₙ L₃₋ₙ), or R³¹. When there is a remaining bond(s), the remaining bond(s) is bonded to a hydrogen atom or a substituent. Examples of such substituents include a halogen atom, an alkyl group (which may comprise an etheric oxygen atom between carbon atoms), a cycloalkyl group, an alkenyl group, an allyl group, an alkoxy group, and an oxo group (═O).

Further, when one of the carbon atoms constituting the ring (hereinafter also referred to as ring constituent carbon atoms) has two bonds bonded to Q^{a}, (-Q^{b}-Si(R²)ₙL₃₋ₙ), or R³¹, Q^{a} and (-Q^{b}-Si(R²)ₙL₃₋ₙ) may be bonded to this one carbon atom, or two (-Q^{b}-Si(R²)ₙL₃₋ₙ) may be bonded to this one carbon atom. Q^{a}, and (-Q^{b}-Si(R²)ₙ L₃₋ₙ), or R³¹ are preferably bonded to ring constituent atoms different from each other. h (-Q^{b}-Si(R²)ₙL₃₋ₙ) (i.e., h units of (-Q^{b}-Si(R²)ₙL₃₋ₙ)) may be respectively bonded to ring constituent atoms different from each other, and/or two of them may be bonded to one of the ring constituent carbon atoms. Further/alternatively, there may be two or more ring constituent carbon atoms to each of which two (-Q^{b}-Si(R²)ₙ L₃₋ₙ) are bonded. i R³¹ (i.e., i units of R³¹) may be bonded to ring constituent atoms different from each other, or two of them may be bonded to one ring constituent carbon atom. Alternatively, there may be two or more ring constituent carbon atoms to which two R³¹ are bonded.

In particular, X³¹ is preferably a group having a carbon atom, a nitrogen atom, a silicon atom, an organo (poly)siloxane residue having a valence of 4 to 8, or a ring having a valence of (i+1), and more preferably a carbon atom in order to improve the abrasion resistance of the surface-treated layer.

In Formula (3-1A), Q^{b} is a single bond or a divalent linking group.

The definition of the divalent linking group is synonymous with the definition described above for Q^{a}.

In particular, Q^{b} is preferably an alkylene group which may have an etheric oxygen atom. The number of carbon atoms of the alkylene group is preferably 1 to 30, more preferably 1 to 20, still more preferably 2 to 20, and may be 2 to 10, 2 to 6, or 2 to 5. For example, the number of carbon atoms is 2, 3, 8, 9 or 11. Further, the number of carbon atoms may be 1 to 10.

In Formula (3-1A), R³¹ is a hydrogen atom, a hydroxyl group, or an alkyl group.

The number of carbon atoms of the alkyl group is preferably 1 to 5, more preferably 1 to 3, and still more preferably 1.

When X³¹ is a single bond or an alkylene group, i is 0,
when X³¹ is a nitrogen atom, i is 1,
when X³¹ is a carbon atom or a silicon atom, i is 2,
when X³¹ is an organo (poly) siloxane residue having a valence of 2 to 8, i is an integer of 0 to 6, and
when X³¹ is a group having a ring having a valence of (i+1), i is an integer of 0 to 6.

In particular, i is preferably 0 in order to improve the abrasion resistance of the surface-treated layer.

In Formula (3-1B), Q^{c} is a single bond or a divalent linking group.

The definition of the divalent linking group is synonymous with the above-described definition of Q^{a}.

In Formula (3-1B), R³² is a hydrogen atom or an alkyl group comprising 1 to 10 carbon atoms, and is preferably a hydrogen atom in view of the ease of the manufacturing of the compound.

The alkyl group is preferably a methyl group.

In Formula (3-1B), Q^{d} is a single bond or an alkylene group. The number of carbon atoms of the alkylene group is preferably 1 to 10 and more preferably 1 to 6. In view of the ease of the manufacturing of the compound, Q^{d} is preferably a single bond or CH₂—.

In Formula (3-1B), R³³ is a hydrogen atom or a halogen atom, and is preferably a hydrogen atom in view of the ease of the manufacturing of the compound.

The group (3-1A) is preferably one of groups (3-1A-1), (3-1A-4), (3-1A-6), and (3-1A-7).

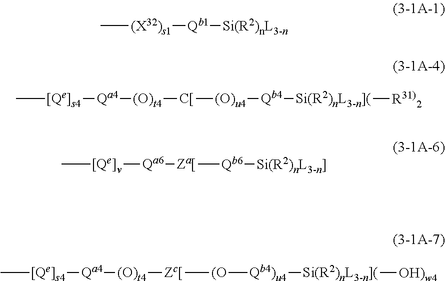

Note that in the groups (3-1A-1), (3-1A-4), (3-1A-6), and (3-1A-7), the definitions of R², L, and n are the same as those described above.

Among them, the group (3-1A) is preferably the group (3-1A-4).

In the group (3-1A-1), X³² is —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—; or a combination of them with a divalent linking group (note that N in the formula is bonded to Q^{b1})

The definition of R^{d} is the same as those described above.

s1 is 0 or 1.

When X³² is a combination of —O—, —S—, —N(R^{d})—, —C(O)—, —C(O)O—C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, and a divalent linking group, the divalent linking group is bonded to Si(R³)₂ or Si(R⁴)₂ of Formula (C) or (D).

Examples of divalent linking groups include an alkylene group, an organo (poly)siloxane residue, a polyalkylene oxide group, and combinations thereof.

Q^{b1} is a single bond or an alkylene group. Note that the alkylene group may have —O—, a silphenylene skeleton group, or a dialkylsilylene group. The alkylene group may have a plurality of groups selected from the group consisting of —O—, a silphenylene skeleton group, a divalent organo (poly)siloxane residue, and a dialkylsilylene group.

Note that when the alkylene group has —O—, a silphenylene skeleton group, a divalent organo (poly)siloxane residue, or a dialkylsilylene group, it preferably has these groups between carbon atoms.

The number of carbon atoms of the alkylene group represented by Q^{b1} is preferably 1 to 30, more preferably 1 to 20, still more preferably 2 to 20, and particularly preferably 2 to 6. Further, the number of carbon atoms may be 1 to 10.

In the group (3-1A-4), Q^{c} is —C(O)O—, —SO₂N(R^{d})—, —N(R^{d})SO₂—, —N(R^{d})C(O)—, or —C(O)N(R^{d})—; or a combination of one of them with a divalent linking group.

When Q^{c} is a combination of —C(O)O—, —SO₂ N(R^{d})—, —N(R^{d})SO₂—, —N(R^{d})C(O)—, or —C(O)N(R^{d})— and a divalent linking group, the divalent linking group is bonded to Si(R³)₂ or Si(R⁴)₂ of Formula (C) or (D).

Examples of divalent linking groups include an alkylene group, an organo (poly) siloxane residue, a polyalkylene oxide group, and combinations thereof.

The definition of R³¹ is the same as that described above. When w1 is 1 to 2, R³¹ is preferably a hydrogen atom.

s4 is 0 or 1.

Q^{a4} is a single bond, or an alkylene group which may have an etheric oxygen atom.

The number of carbon atoms of the alkylene group which may have an etheric oxygen atom is preferably 1 to 20, more preferably 1 to 10, still more preferably 1 to 6, and particularly preferably 1 to 3.

t4 is 0 or 1 (is 0 when Q^{a4} is a single bond).

In view of the ease of the manufacturing of the compound, -Q^{a4}—(O)ₜ₄— is preferably a single bond, —CH₂O—, —CH₂OCH₂—, —CH₂OCH₂CH₂O—, —CH₂OCH₂CH₂OCH₂—, or —CH₂OCH₂CH₂CH₂CH₂OCH₂-when s4 is 0, and is preferably a single bond, —CH₂—, or —CH₂CH₂-when s4 is 1.

Q^{b4} is an alkylene group, and the aforementioned alkylene group may have —O—, —C(O)N(R^{d})— (the definition of R^{d} is the same as that described above), a silphenylene skeleton group, a divalent organo (poly) siloxane residue, or a dialkylsilylene group.

Note that when the alkylene group has —O— or a silphenylene skeleton group, it preferably has —O— or a silphenylene skeleton group between carbon atoms. Further, when the alkylene group has —C(O)N(R^{d})—, a dialkylsilylene group, or a divalent organo (poly) siloxane residue, it preferably has these groups between carbon atoms or at the end on the side which is bonded to (O)ᵤ₄.

The number of carbon atoms of the alkylene group represented by Q^{b4} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

u4 is 0 or 1.

In view of the ease of the manufacturing of the compound, —(O)ᵤ₄-Q^{b4}- is preferably —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂₀Si(CH₃)₂CH₂CH₂CH₂—, —CH₂CH₂CH₂Si(CH₃)₂PhSi(CH₃)₂CH₂CH₂— (note that the right side is bonded to Si).

The definition of Q^{c} in the group (3-1A-6) is the same as that defined in the above-described group (3-1A-4).

v is preferably 0 or 1.

Q^{a6} is an alkylene group which may have an etheric oxygen atom.

The number of carbon atoms of the alkylene group which may have an etheric oxygen atom is preferably 1 to 10 and particularly preferably 2 to 6.

In view of the ease of the manufacturing of the compound, Q^{a6} is preferably —CH₂OCH₂CH₂CH₂—, —CH₂OCH₂CH₂OCH₂CH₂CH₂—, —CH₂CH₂—, or —CH₂CH₂CH₂— (note that the right side is bonded to Z^{a}).

Z^{a} is a divalent organo (poly) siloxane residue or a divalent group having an alkylene group between the organo (poly) siloxane residues.

Q^{b6} is an alkylene group or a group having an etheric oxygen atom or a divalent organo (poly) siloxane residue between carbon atoms of the alkylene group comprising two or more carbon atoms.

The number of carbon atoms of the alkylene group represented by Q^{b6} is preferably 1 to 30, more preferably 1 to 20, still more preferably 2 to 20, and may be 2 to 10 or 2 to 6. For example, the number of carbon atoms is 2, 3, 8, 9 or 11. Further, the number of carbon atoms may be 1 to 10.

The number of carbon atoms of the group having an etheric oxygen atom or a divalent organo (poly) siloxane residue between carbon atoms of the alkylene group comprising two or more carbon atoms, represented by Q^{b6} is preferably 2 to 20, more preferably 2 to 10, and still more preferably 2 to 6.

Q^{b6} is preferably —CH₂CH₂— or —CH₂CH₂CH₂— in view of the ease of the manufacturing of the compound.

In the group (3-1A-7), Z^{c} is a hydrocarbon group having a valence of (w4+2).

w4 is an integer of 0 or more.

The definitions and the preferred ranges of Q^{c}, s4, Q^{a4} t4, Q^{b4}, and u4 are the same as those of the same symbols in the group (3-1A-4).

Z^{c} may consist of a hydrocarbon chain, may have an etheric oxygen atom between carbon atoms of a hydrocarbon chain, and preferably consists of a hydrocarbon chain.

The valence of Z^{c} is preferably 5 to 20, more preferably 5 to 10, still more preferably 5 to 8, and particularly preferably 5 to 6.

The number of carbon atoms of Z^{c} is preferably 3 to 50, more preferably 4 to 40, and still more preferably 5 to 30.

w4 is preferably 0 to 10, more preferably 0 to 8, still more preferably 0 to 6, particularly preferably 0 to 3, and most preferably 0 and 1.

A in Formula A(Si(R²)ₙL₃₋ₙ) may be one of groups (g2-1), (g2-2), and (g2-4) to (g2-7).

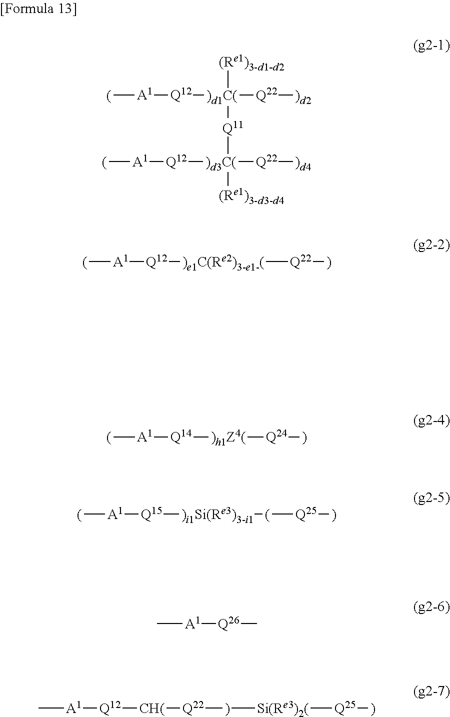

Note that in Formulas (g2-1), (g2-2), and (g2-4) to (g2-7), the A¹ side is bonded to Si(R³)₂ or Si(R⁴)₂, and the Q²², Q²³, Q²⁴, Q²⁵ or Q²⁶ side is bonded to [—Si(R²)ₙL₃₋ₙ].

A¹ is a single bond, —C(O)NR⁶—, —C(O)—, —OC(O)O—, —NHC(O)O—, —NHC(O)NR⁶—, —O—, or SO₂NR⁶—.

Q¹¹ is a single bond, —O—, an alkylene group, or a group having —C(O)NR⁶—, —C(O)—, —NR⁶—, or O— between carbon atoms of an alkylene group comprising two or more carbon atoms.

Q¹² is a single bond, an alkylene group, or a group having —C(O)NR⁶—, —C(O)—, —NR⁶—, or O— between carbon atoms of an alkylene group comprising two or more carbon atoms. Further, when A has two or more Q¹², the two or more Qi2 may be the same as each other or different from each other.

Q¹³ is a single bond (note that A¹ is —C(O)—), an alkylene group, or a group having —C(O)NR⁶—, —C(O)—, —NR⁶—, or O— between carbon atoms of an alkylene group comprising two or more carbon atoms, or a group having —C(O)— at the end on the N-side of an alkylene group.

Q¹⁴ is Q¹² when the atom in Z⁴ to which Q¹⁴ is bonded is a carbon atom, and is Q¹³ when the atom in Z⁴ to which Q¹⁴ is bonded is a nitrogen atom. Further, when A has two or more Q¹⁴, the two or more Q¹⁴ may be the same as each other or different from each other.

Q¹⁵ is an alkylene group, or a group having —C(O)NR⁶—, —C(O)—, —NR⁶—, or O— between carbon atoms of an alkylene group comprising two or more carbon atoms. Further, when A has two or more Q¹⁵, the two or more Q¹⁵ may be the same as each other or different from each other.

Q²² is an alkylene group, a group having —C(O)NR⁶—, —C(O)—, —NR⁶—, or O— between carbon atoms of the alkylene group comprising two or more carbon atoms, a group having —C(O)NR⁶—, —C(O)—, —NR⁶—, or O— at the end of the alkylene group on the side thereof which is not connected to Si, or a group having —C(O)NR⁶—, —C(O)—, —NR⁶—, or 0-between carbon atoms of the alkylene group comprising two or more carbon atoms and having —C(O)NR⁶—, —C(O)—, —NR⁶—, or O— at the end on the side which is not connected to Si. Further, when A has two or more Q²², the two or more Q²² may be the same as each other or different from each other.

Q²³ is an alkylene group, or a group having —C(O)NR⁶—. —C(O)—, —NR⁶—, or O— between carbon atoms of an alkylene group comprising two or more carbon atoms. Further, the two Q²³ may be the same as each other or different from each other.

Q²⁴ is Q²² when the atom in Z⁴ to which Q²⁴ is bonded is a carbon atom, and is Q²³ when the atom in Z⁴ to which Q²⁴ is bonded is a nitrogen atom. Further, when A has two or more Q²⁴, the two or more Q²⁴ may be the same as each other or different from each other.

Q²⁵ is an alkylene group or a group having —C(O)NR⁶—, —C(O)—, —NR⁶—, or O— between carbon atoms of an alkylene group comprising two or more carbon atoms. Further, when A has two or more Q²⁵, the two or more Q²⁵ may be the same as each other or different from each other.

Q²⁶ is an alkylene group, or a group having —C(O)NR⁶—, —C(O)—, —NR⁶—, or O— between carbon atoms of an alkylene group comprising two or more carbon atoms.

When Q²², Q²³, Q²⁴, Q²⁵ and Q²⁶ are alkylene groups, the number of carbon atoms is preferably 1 to 20, more preferably 1 to 10, and still more preferably 1 to 6.

Z⁴ is a group having a ring structure having a valence of (h1+h2), and having a carbon atom or a nitrogen atom to which Q¹⁴ is directly bonded and having a carbon atom or a nitrogen atom to which Q²⁴ is directly bonded.

R^{c1} is a hydrogen atom or an alkyl group. Further, when A has two or more R^{c1}, the two or more R^{c1} may be the same as each other or different from each other.

R^{e2} is a hydrogen atom, a hydroxyl group, an alkyl group, or an acyloxy group.

R^{e3} is an alkyl group. R⁶ is a hydrogen atom, an alkyl group comprising 1 to 6 carbon atoms, or a phenylene group.

d1 is an integer of 0 to 3, and is preferably 1 to 2.

d2 is 0 or 1.

d1+d2 is an integer of 1 to 3.

d3 is an integer of 0 to 3, and is preferably 0 or 1.

d4 is 0 or 1.

d3+d4 is an integer of 1 to 3.

d1+d3 is an integer of 1 to 5, and is preferably 1 to 2.

d2+d4 is 1.

e1 is an integer of 1 to 3, and is preferably 1 to 2.

h1 is an integer of 1 or more, and is preferably 1 to 2.

i1 is an integer of 1 to 3, and is preferably 1 to 2.

The number of carbon atoms of the alkylene groups of Q¹¹, Q¹², Q¹⁴, Q¹⁵, Q²², Q²⁴, Q²⁵ and Q²⁶ are preferably 1 to 30, more preferably 1 to 20, still more preferably 2 to 20, and may be 2 to 10 or 2 to 6 in view of the ease of the manufacturing of the compound and because the abrasion resistance of the surface-treated layer becomes more excellent. For example, the number of carbon atoms is 2, 3, 8, 9 or 11. Further, the aforementioned number of carbon atoms may be 1 to 10, 1 to 6, or 1 to 4. However, when the alkylene group has a specific bond between carbon atoms, the lower limit value of its number of carbon atoms is 2.

Examples of the ring structure in Z⁴ include the ring structures described above, and its preferred embodiments are also the same as those described above. Note that Q¹⁴ and Q²⁴ are directly bonded to the ring structure in Z⁴, so that a situation in which, for example, the alkylene group is bonded to the ring structure, and Q¹⁴ and Q²⁴ are bonded to the alkylene group never occurs.

The number of carbon atoms of the alkyl group of R^{e1}, R^{e2}, or R^{e3} is preferably 1 to 6, more preferably 1 to 3, and particularly preferably 1 to 2 in view of the ease of the manufacturing of the compound.

The number of carbon atoms the alkyl group moiety of the acyloxy group of R^{e2} is preferably 1 to 6, more preferably 1 to 3, and particularly preferably 1 to 2 in view of the ease of the manufacturing of the compound.

h1 is preferably 1 to 6, more preferably 1 to 4, still more preferably 1 to 2, and particularly preferably 1 in view of the ease of the manufacturing of the compound and because the abrasion resistance of the surface-treated layer becomes more excellent.

Examples of other embodiments of A in Formula A(Si(R²)ₙL₃₋ₙ) include the groups (g2-8), (g2-9), and (g2-11) to (g2-14).

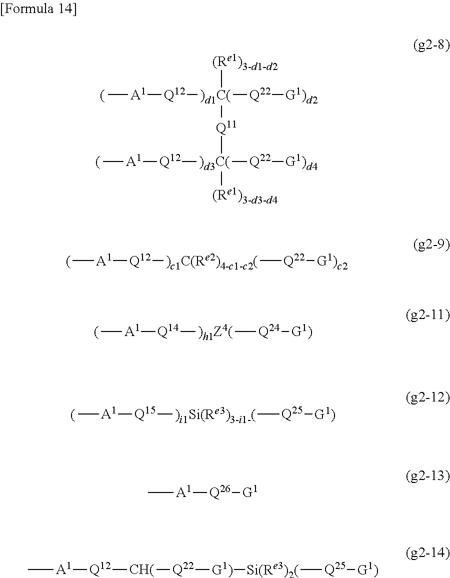

In Formulas (g2-8), (g2-9), and (g2-11) to (g2-14), the A¹ side is bonded to Si(R³)₂ or Si(R⁴)₂, and the G¹ side is bonded to [—Si(R²)ₙL₃₋ₙ].

G¹ is the below-shown group (g3), and two or more G¹ included in A may be the same as each other or different from each other. Symbols other than G¹ are the same as those in Formulas (g2-1), (g2-2), and (g2-4) to (g2-7).

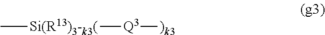

In the group (g3), the Si side is bonded to Q²², Q²³. Q²⁴. Q²⁵ and Q²⁶, and the Q³ side is bonded to [—Si(R²)ₙ L₃₋ₙ]. R¹³ is an alkyl group. Q³ is an alkylene group, a group having —C(O)NR⁶—, —C(O)—, —NR⁶—, or —O— between carbon atoms of an alkylene group comprising two or more carbon atoms, or (OSi(R⁹)₂)ₚ—O—. Further, two or more Q³ may be the same as each other or different from each other. k3 is 2 or 3. R⁶ is a hydrogen atom, an alkyl group comprising 1 to 6 carbon atoms, or a phenylene group. R⁹ is an alkyl group, a phenyl group, or an alkoxy group, and two R⁹ may be the same as each other or different from each other. p is an integer of 0 to 5. Further, when p is 2 or more, two or more (OSi(R⁹)₂) may be the same as each other or different from each other.

The number of carbon atoms of the alkylene group of Q³ is preferably 1 to 30, more preferably 1 to 20, still more preferably 2 to 20 in view of the ease of the manufacturing of the compound and because the abrasion resistance of the surface-treated layer becomes more excellent, and may be 2 to 10 or 2 to 6. For example, the number of carbon atoms is 2, 3, 8, 9 or 11. Further, the number of carbon atoms may be 1 to 10, 1 to 6, or 1 to 4. However, when the alkylene group has a specific bond between carbon atoms, the lower limit value of its number of carbon atoms is 2.

The number of carbon atoms of the alkyl group of R¹³ is preferably 1 to 6, more preferably 1 to 3 and still more preferably 1 to 2 in view of the ease of the manufacturing of the compound.

The number of carbon atoms of the alkyl group of R⁹ is preferably 1 to 6, more preferably 1 to 3, and still more preferably 1 to 2 in view of the ease of the manufacturing of the compound.

The number of carbon atoms of the alkoxy group of R⁹ is preferably 1 to 6, more preferably 1 to 3, and particularly preferably 1 to 2 because the storage stability of the compound becomes excellent.

p is preferably 0 or 1.

### [Example of First Compound S and First Compound D]

Specific examples of the first compound S and the first compound D will be described hereinafter in detail.

Specific examples of the first compound S include compounds (1)-(3), (4A), and (5) shown below.

Specific examples of the first compound D include a compound (4B) shown below.

### Compound (1)

A compound comprising the below-shown group 1a, a chain organo (poly)siloxane residue, a partial structure which is an alkylene chain or a polyalkylene oxide chain comprising three or more carbon atoms, and the below-shown group 1b.
Group 1a: -M¹T¹₃
Group 1b: —Si(R²)ₙ L₃₋ₙ
M¹ is Si, Sn, or Ge,
each T¹ is independently a hydrocarbon group or a trialkylsilyloxy group,
each R² is independently a monovalent hydrocarbon group,
each L is independently a hydrolyzable group, a group having a hydrolyzable group, or a hydroxyl group, and
each n is independently an integer of 0 to 2.
R², L, and n are the same as R², L, and n in the above-shown Formula (S1).

Details of the group 1a are the same as those of T¹₃M¹- in the description of T¹¹ in Formula (C).

### Compound (2)

A compound comprising an alkyl group comprising two or more carbon atoms, a chain organo (poly)siloxane residue, and a reactive silyl group.

### Compound (3)

A compound comprising the below-shown group 3a, a partial structure comprising a divalent chain organo (poly)siloxane residue, and the below-shown group 3b. Further, the partial structure is a divalent chain organo (poly)siloxane residue or a combination of a divalent chain organo (poly)siloxane residue and at least one of an alkylene chain and a polyalkylene oxide chain.
Group 3a: a monovalent cyclic polysiloxane residue or a monovalent cage-like polysiloxane residue
Group 3b: —Si(R²)ₙL₃₋ₙ
each R² is independently a monovalent hydrocarbon group,
each L is independently a hydrolyzable group, a group having a hydrolyzable group, or a hydroxyl group, and
each n is independently an integer of 0 to 2.
each R², L, and n are the same as R², L, and n in the above-shown Formula (Si).

### Compound (4A), (4B)

A compound represented by Formula (4A) or (4B)

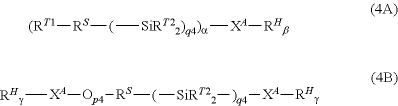

In Formulas (4A) and (4B),
each R^{S} is independently a divalent linear organosiloxane group,
each R^{T1} is independently a hydrocarbon group,
each R^{T2} is independently a hydrocarbon group,
p4 is 0 or 1,
each q4 is independently 0 or 1,
R^{H} is a group represented by one of Formulas (W1) to (W4) shown below,

In R^{H}, there are two or more Si atoms to which a hydroxyl group or a hydrolyzable group is bonded,
each X^{A} is independently a single bond or a group represented by Formula (W5) shown below,
α is an integer of 1 to 9,
β is 1, and
γ is 1.

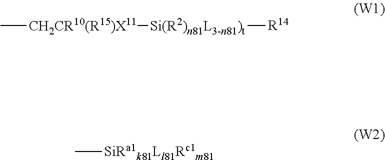

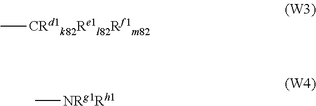

In Formulas (W1) to (W4),
each L is independently a hydrolyzable group, a group having a hydrolyzable group, or a hydroxyl group,
each R² is independently a monovalent hydrocarbon group,
each n₈₁ is independently an integer of 0 to 3 for each (SiR²ₙ₈₁L₃₋ₙ₈₁) unit,
each X¹¹ is independently a single bond or a divalent organic group,
each R¹⁰ is independently a hydrogen atom or a monovalent organic group,
t is 1,
each R¹⁴ is independently a hydrogen atom, a halogen atom, or —X¹¹—Si(R²)ₙ₈₁L₃₋ₙ₈₁,
each R¹⁵ is independently a single bond, an oxygen atom, an alkylene group comprising 1 to 6 carbon atoms, or an alkyleneoxy group comprising 1 to 6 carbon atoms,
each R^{a1} is independently —Z⁸¹—SiR²¹ₚ81L_{q81}R²³ᵣ₈₁,
each Z⁸¹ is independently a divalent organic group,
each R²¹ is independently —Z^{1′}—SiR^{21′}_{p1′}L_{q1′}R^{23′}r_{1′},
each R²³ is independently a monovalent organic group,
each p81 is independently an integer of 0 to 3,
each q81 is independently an integer of 0 to 3,
each r81 is independently an integer of 0 to 3,
p81+q81+r81 is 3,
each Z^{1′} is independently a divalent organic group,
each R^{21″} is independently —Z^{1″}-SiL_{q1″}R^{23″}_{r1″},
each R^{23′} is independently a monovalent organic group,
each p1′ is independently an integer of 0 to 3,
each q1′ is independently an integer of 0 to 3,
each r1′ is independently an integer of 0 to 3,
p1′+q1′+r1′ is 3,
each Z^{1″} is independently a divalent organic group,
each R^{23″} is independently a monovalent organic group,
each q1″ is independently an integer of 0 to 3,
each r1″ is independently an integer of 0 to 3,
q1″+r1″ is 3,
each R^{c1″} is independently a monovalent organic group,
each k81 is independently an integer of 0 to 3,
each 181 is independently an integer of 0 to 3,
each m81 is independently an integer of 0 to 3,
k81+181+m81 is 3,
each R^{d1} is independently —Z⁸²—CR⁹¹ₚ82R⁹²_{q82}R⁹³ᵣ₈₂,
each Z⁸² is independently a single bond, an oxygen atom, or a divalent organic group,
each R⁹¹ is independently —Z^{2′}—CR^{32′}_{q2′}R^{33′}_{r2′},
each R⁹² is independently —Z⁸³—SiLₙ₈₂R³⁵₃₋ₙ₈₂,
each R⁹³ is independently a hydrogen atom, a hydroxyl group, or a monovalent organic group,
each p82 is independently an integer of 0 to 3,
each q82 is independently an integer of 0 to 3,
each r82 is independently an integer of 0 to 3,
p82+q82+r82 is 3,
each Z^{2′} is independently a single bond, an oxygen atom or a divalent organic group,
each R^{32′} is independently —Z⁸³—SiLₙ₈₂R³⁵₃₋ₙ₈₂,
each R^{33′} is independently a hydrogen atom, a hydroxyl group or a monovalent organic group,
each q2′ is independently an integer of 0 to 3,
each r2′ is independently an integer of 0 to 3,
q2′+r2′ is 3,
each Z⁸³ is independently a single bond, an oxygen atom, or a divalent organic group,
each R³⁵ is independently a monovalent organic group,
each n82 is independently an integer of 0 to 3,
each R¹ is independently —Z⁸³—SiLₙ₈₂R³⁵₃₋ₙ₈₂,
each R^{f1} is independently a hydrogen atom, a hydroxyl group or a monovalent organic group,
each k82 is independently an integer of 0 to 3,
each 182 is independently an integer of 0 to 3,
each m82 is independently an integer of 0 to 3,
k82+182+m82 is 3,
each R^{g1} and R^{h1} is independently —Z⁸⁴—SiLₙ₈₁R²₃₋ₙ₈₁, —Z⁸⁴—SiR^{a1}ₖ₈₁L₁₈₁R^{c1}ₘ₈₁, or —Z⁸⁴—CR^{d1}ₖ₈₂R^{e1}₁₈₂R^{f1}ₘ₈₂,
each Z⁸⁴ is independently a single bond, an oxygen atom, or a divalent organic group, and
note that in Formulas (W1), (W2), (W3), and (W4), there are at least two Si atoms bonded to a hydrolyzable group, a group having a hydrolyzable group, or a hydroxyl group.

R² and L are the same as R² and L in Formula (S1).

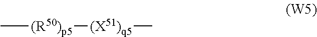

in Formula (W5),
R⁵⁰ is a single bond, —(CH₂)ₛ₅—, or an o-, m- or p-phenylene group,
s5 is an integer of 1 to 20,
X⁵¹ is —(X⁵²)₁₅—,
X⁵² is, for each appearance, each independently a group selected from the group consisting of —O—, —S—, an o-, m- or p-phenylene group, —CO—, —C(O)O—, —CONR⁵⁴—, —O—CONR⁵⁴—, —NR⁵⁴—, and —(CH₂)ₙ₅—,
R⁵⁴ is, for each appearance, each independently a hydrogen atom or a monovalent organic group,
n5 is, for each appearance, each independently an integer of 1 to 20,
15 is an integer of 1 to 10,
p5 is 0 or 1,
q5 is 0 or 1, and
at least one of p5 and q5 is 1, and (R⁵⁰)ₚ₅ and (X⁵¹)_{q5} may be present in an arbitrary order.
each X^{A} is preferably each independently a single bond, an alkylene group comprising 1 to 20 carbon atoms, —(CH₂)ₛ₅—X⁵³—, —X⁵³—(CH₂)ₜ₅—, or —(CH₂)ₛ₅—X⁵³—(CH₂)ₜ₅—.
each X⁵³ is independently a single bond, —O—, —CO—, —CONR⁵⁴—, —O—CONR⁵⁴—, —O—(CH₂)ᵤ₅—CONR⁵⁴—, or —O—(CH₂)ᵤ₅—CO—,
each R⁵⁴ is, for each appearance, each independently a hydrogen atom, a phenyl group, an alkyl group comprising 1 to 6 carbon atoms, or an oxyalkylene-comprising group comprising 1 to 10 carbon atoms,
s5 is an integer of 1 to 20,
t5 is an integer of 1 to 20, and
u5 is preferably an integer of 1 to 20.
   Compound (5) A compound represented by Formula (5) shown below.

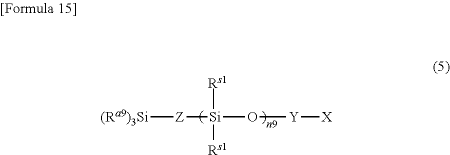

In Formula (5),
Y represents a single bond or *—Si(R^{s2})₂-L^{s1}-.
* indicates a bond with an oxygen atom.
Z represents an oxygen atom or a divalent hydrocarbon group comprising 1 to 10 carbon atoms.
each R^{a9} is independently represents a hydrocarbon group or a trialkylsilyloxy group.

Note that when R^{a9} are all hydrocarbon groups, the hydrocarbon groups represented by R^{a9} are alkyl groups.
each R^{s1} and R^{s2} is independently an alkyl group comprising 1 to 10 carbon atoms.
L^{s1} represents a divalent hydrocarbon group comprising 1 to 10 carbon atoms.
X is a group represented by one of Formulas (X-1) to (X-2) shown below,
n9 represents a number of 1 to 150.

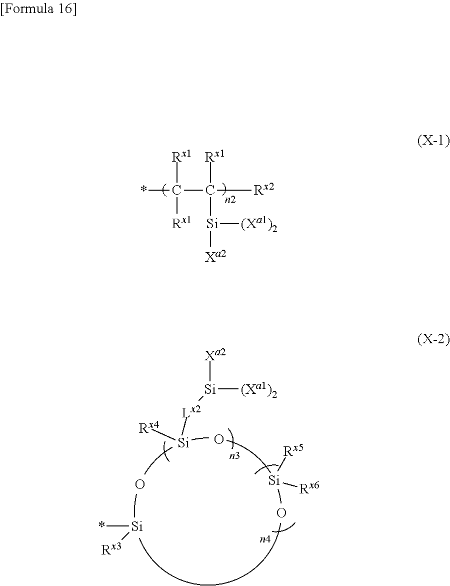

In Formulas (X-1) to (X-2),
L^{x2} represents a divalent hydrocarbon group comprising 1 to 20 carbon atoms, and a methylene group (—CH₂—) contained in the divalent hydrocarbon group may be replaced with —O— or —O—Si(R^{x7})₂—.
each R^{x1} to R^{x6} independently represents a hydrogen atom or a hydrocarbon group comprising 1 to 10 carbon atoms.
each X^{a1} independently represents a hydrolyzable group, a group having a hydrolyzable group, or a trialkoxysilyloxy group.
each X^{a2} independently represents a trialkylsilyl-comprising group, a hydrocarbon chain-comprising group, a siloxane skeleton-comprising group, a hydrolyzable group, a group having a hydrolyzable group, or a trialkoxysilyloxy group. Further, when X^{a2} is a hydrolyzable group, X^{a2} and X^{a1} may be the same as each other or different from each other.
n2 represents an integer of 1 to 50.
n3 is 1.
n4 represents a number of 0 to 5.

In Formula (X-3), the order of the units represented by (Si(R^{x4})(-L^{x2}-Si(X^{a2})(X^{a1})₂)—O—) and (Si(R^{x5})(R^{x6})—O—) are arbitrary.

The compounds (1) to (5) will be described hereinafter.

### (Compound (1))

A compound (1) is preferably a compound represented by Formula (TA) shown below.

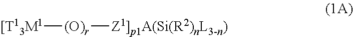

In Formula (TA),
M¹ is Si, Sn, or Ge,
each T¹ is independently a hydrocarbon group or a trialkylsilyloxy group,
r is 0 or 1,
each Z¹ is independently an alkylene chain or a polyalkylene oxide chain, or a combination of an alkylene chain and a divalent chain organo (poly) siloxane residue, and A is a single bond or a linking group having a valence of (p1+q1).
each R² is independently a monovalent hydrocarbon group;
each L is independently a hydrolyzable group, a group having a hydrolyzable group, or a hydroxyl group;
each n is independently an integer of 0 to 2, and
p1 is an integer of 1 or more.

Note that when each Z¹ is independently an alkylene chain or a polyalkylene oxide chain, A is a linking group comprising a chain organo (poly) siloxane residue and having a valence of (p1+1).

T¹ and M¹ are the same as T¹ and M¹ in the above-described group 1a, and therefore their descriptions are omitted.

M¹ is preferably Si.

T¹ is preferably a trialkylsilyloxy group, and more preferably a butyldimethylsilyloxy group, a trimethylsilyloxy group, or a triethylsilyloxy group.

R², L, and n are the same as R², L, and n in the above-shown Formula (S1).

The combination of an alkylene chain and a divalent chain organo (poly) siloxane residue, represented by Z¹ is preferably represented by Formula (D1), (D2), or (D3) shown below.

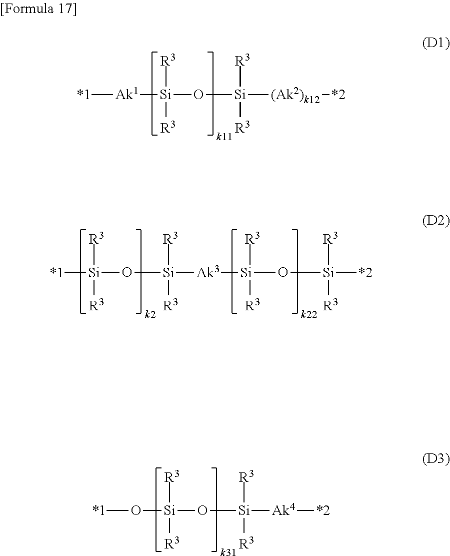

In Formula (D1), each Ak¹ and Ak² independently represent an alkylene chain. R³ is the same as R³ in Formula (B1). k11 is a number of 1 or more. k12 is 0 or 1.

In Formula (D2), Ak³ represents an alkylene chain. R³ is the same as R³ in Formula (B1). Each k21 and k22 are independently a number of 1 or more.

In Formula (D3), Ak⁴ represents an alkylene chain. R³ is the same as R³ in Formula (B1).

k31 is a number of 1 or more. In Formula (D1), (D2), or (D3), *1 is connected to the group 1a side, and *2 is connected to the group 1b side.

A may be any group that does not impair the effects of the present disclosure, and its examples include an alkylene group which may have an etheric oxygen atom or a divalent chain organo (poly)siloxane residue, a carbon atom, a nitrogen atom, a silicon atom, an organo (poly)siloxane residue comprising 2 to 8 carbon atoms, and groups obtained by eliminating Si(R²)ₙ L₃₋ₙ from the above-described groups (3-1A), (3-1B), (3-1A-1), (3-1A-4), (3-1A-6), and (3-1A-7).

A may comprise a triptycene structure. The triptycene structure refers to a partial structure obtained by eliminating two or more hydrogen atoms from triptycene.

Further, A may be one of the above-shown group (g2-1), (g2-2), (g2-4) to (g2-9), (g2-11), and (g2-14).

p1 is an integer of 1 or more. p1 is preferably 1 to 6 and more preferably 2 to 4 because the water repellency of the surface-treated layer becomes more excellent. p1 may be 1.

When p1 is 2 or more, the plurality of [T¹₃M¹-(O)ᵣ—Z¹] may be the same as each other or different from each other.

Preferred embodiments of the group A (Si(R²)ₙ L₃₋ₙ) in Formula (1A) are the same as those of the group A (Si(R²)ₙ L₃₋ₙ) in “Partial Structure of First Compound S and First Compound D” described above. However, A in the group A (Si(R²)ₙL₃₋ₙ)_{q1} is connected to [T¹₃M¹-(O)ᵣ—Z¹]ₚ₁ of Formula (1A). When the end of Z¹ on the side which is bonded to A is an alkylene chain, the end of A on the side which is bonded to Z¹ is not an alkylene chain. When the end of Z¹ on the side which is bonded to A is a polyalkylene oxide chain, the end of A on the side which is bonded to Z¹ is not a polyalkylene oxide chain.

The compound (1) is preferably a compound represented by Formula (1B) shown below,

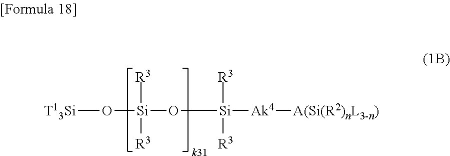

In Formula (1B), T¹ is the same as T¹ in the group 1a.

R³ is the same as R³ in Formula (B1). k31 is the same as k31 in Formula (D3).

The group represented by A(Si(R²)ₙ L₃₋ₙ) is the same as the group represented by A(Si(R²)ₙ L₃₋ₙ) in Formula (1A).

Ak⁴ is the same as Ak⁴ in Formula (D3).

The compound (1) is preferably a compound represented by Formula (1C), (lD), or (IE) shown below.

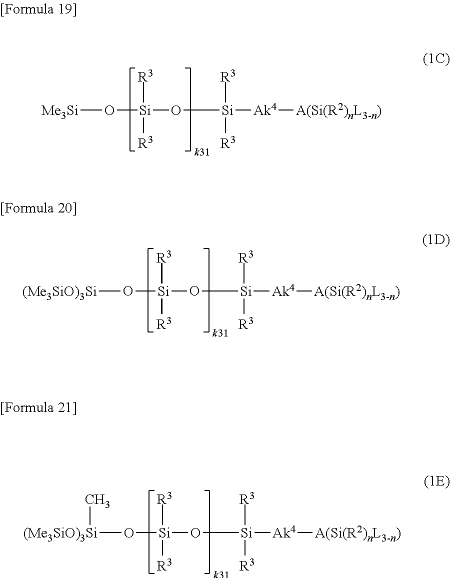

In Formulas (1C), (lD), and (IE), R³ is the same as R³ in Formula (B1).

k31 is the same as k31 in Formula (D3). The group represented by A(Si(R²)ₙ L₃₋ₙ) is the same as the group represented by A(Si(R²)ₙ L₃₋ₙ) in Formula (1A).

Ak⁴ is the same as Ak⁴ in Formula (D3).

Specific examples of the compound (1) include compounds shown below.

In the below-shown formula, n10 is a number of 1 or more, is preferably 1 to 60, and may be a number of 3 to 50, 5 to 30, or 7 to 25.

m10 is an integer of 6 to 99. p¹¹ is, for example, 21, 26, or 36.

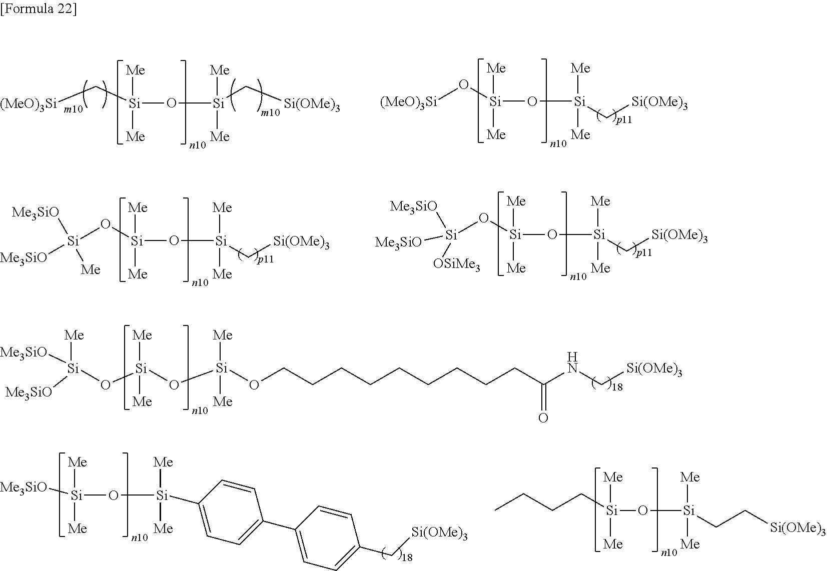

In the below-shown formula, k is preferably 1 to 80, more preferably 3 to 50, and still more preferably 3 to 30. m is preferably 1 to 30, more preferably 3 to 20, and still more preferably 3 to 10.

t is preferably 1 to 30, more preferably 3 to 20, and still more preferably 3 to 10.

In the below-shown formula, n10 is a number of 1 or more, is preferably 1 to 60, and may be a number of 3 to 50, 5 to 30, or 7 to 25.

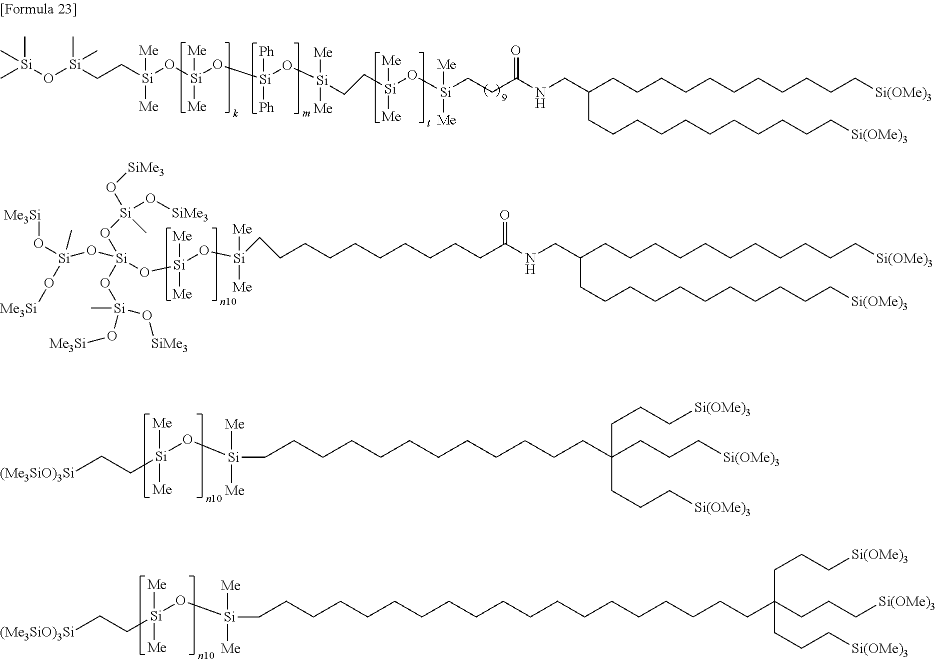

In the below-shown formula, n10 is a number of 1 or more, is preferably 1 to 60, and may be a number of 3 to 50, 5 to 30, or 7 to 25.

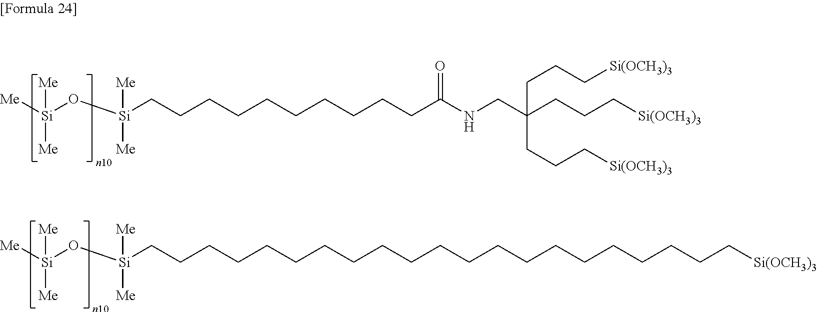

### (Compound (2))

In the compound (2), an alkyl group refers to an unsubstituted alkyl group. The alkyl group may be any of a linear alkyl group, a branched alkyl group, and a cyclic alkyl group, and is preferably a linear alkyl group or a branched alkyl group. The number of carbon atoms of the alkyl group is preferably 2 to 30, more preferably 3 to 28, and still more preferably 4 to 22.

Only one alkyl group may be contained in the compound, or two or more alkyl groups may be contained therein. Since the alkyl group is a monovalent group, it is located at the end of the compound.

The compound (2) is preferably a compound represented by Formula (2A) shown below.

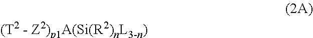

In Formula (2A),
T² is an alkyl group comprising two or more carbon atoms,
Z² is a divalent chain organo (poly)siloxane residue,
A is a single bond or a linking group having a valence of (p1+1),
each R² is independently a monovalent hydrocarbon group;
each L is independently a hydrolyzable group, a group having a hydrolyzable group, or a hydroxyl group;
n is an integer of 0 to 2, and
p1 is an integer of 1 or more.

Preferred embodiments of the alkyl group comprising two or more carbon atoms represented by T² are the same as those described above.

The divalent chain organo (poly)siloxane residue represented by Z² is preferably a group represented by the above-shown Formula (B1).

R², L, and n are the same as R², L, and n in the above-shown Formula (S1).

The group represented by A(Si(R²)ₙ L₃₋ₙ) is the same as the group represented by A(Si(R²)ₙL₃₋ₙ) in the above-shown Formula (1A) except for the matters described below.

p1 is the same as p1 in the above-shown Formula (1A).

The group represented by A(Si(R²)ₙ L₃₋ₙ) is preferably the group (3-1A) or (3-1B), and more preferably the group (3-1A).

In Formula (3-1A), Q^{a} is a single bond or a divalent linking group.

Note that the end of Q^{a} on the side which is bonded to Z² is not an oxysilyl group.

In Formula (3-1A), X³¹ is a single bond, an alkylene group, a carbon atom, a nitrogen atom, a silicon atom, an organo (poly)siloxane residue having a valence of 2 to 8, or a group having a ring having a valence of (i+1).

Note that when Q^{a} is a single bond, the end of X³¹ on the side which is bonded to Z² is not an oxysilyl group. In the other cases, the end of X³¹ may be an oxysilyl group.

In Formula (3-1A), Q^{b} is a single bond or a divalent linking group.

However, when Q^{a} and X³¹ are single bonds, the end of Q^{b} on the side which is bonded to Z² is not an oxysilyl group. In the other cases, the end of Q^{b} may be an oxysilyl group.

In Formula (3-1B), Q^{c} is a single bond or a divalent linking group.

However, the end of Q^{c} on the side which is bonded to Z² is not an oxysilyl group.

The group (3-1A) is preferably one of the groups (3-1A-1), (3-1A-4), (3-1A-6), and (3-1A-7).

However, the ends of the groups (3-1A-1), (3-1A-4), (3-1A-6), and (3-1A-7) on the sides which are bonded to Z² are not an oxysilyl group.

In the group (3-1A-1), X³² is preferably —O—, —S—, —N(R^{d})—, —C(O)O—, —C(O)S—, —N(R^{d})C(O)N(R^{d})—, —OC(O)N(R^{d})—, or —C(O)N(R^{d})— and more preferably —C(O)O— or —C(O)N(R^{d})—.

s1 is preferably 0, and Q^{b1} is preferably an alkylene group comprising 2 to 6 carbon atoms.

A in Formula (2A) may be one of the groups (g2-1), (g2-2), and (g2-4) to (g2-7).

However, in Formulas (g2-1), (g2-2), and (g2-4) to (g2-7), the A¹ side is bonded to Z², and the Q²², Q²⁴, Q²⁵, or Q²⁶ side is bonded to [—Si(R²)ₙL₃₋ₙ].

Examples of other embodiments of A include groups (g2-8), (g2-9), and (g2-11) to (g2-14).

However, in Formulas (g2-8), (g2-9), and (g2-11) to (g2-14), the A¹ side is bonded to Z², and the G¹ side is bonded to [—Si(R²)ₙ L₃₋ₙ].

The compound (2) is preferably a compound represented by Formula (2B) shown below.,

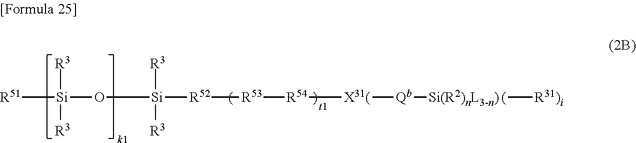

In Formula (2B), R⁵¹ is an alkyl group comprising two or more carbon atoms.

Each R⁵² and R⁵⁴ are independently an alkylene group.

R⁵³ is —C(O)O—, —SO₂N(R^{d})—, —N(R^{d})SO₂—, —N(R^{d})C(O)—, or —C(O)N(R^{d})—.

R³ is the same as R³ in Formula (B1).

k1 is the same as k1 in Formula (B31).

A group represented by X³¹(-Q^{b}-Si(R²)ₙL₃₋ₙ)(—R³¹), is the same as the group represented by X³¹(-Q^{b}-Si(R³)ₙL₃₋ₙ)(—R³¹), in Formula (3-1A).

t1 is 0 or 1.

Preferred embodiments of the alkyl group represented by R⁵¹ are the same as those described above for the alkyl group.

The alkylene group represented by R⁵² may be linear, branched, or cyclic. The number of carbon atoms of the alkylene group is preferably 1 to 30, more preferably 1 to 20, still more preferably 4 to 20, and particularly preferably 5 to 15.

The alkylene group represented by R⁵⁴ may be linear, branched, or cyclic. The number of carbon atoms of the alkylene group is preferably 1 to 20, more preferably 1 to 10, still more preferably 1 to 6, and particularly preferably 1 to 3.

Examples of the compound (2) include compounds shown below. n the below-shown formula, n10 is a number of 1 or more, is preferably 1 to 60, and may be a number of 3 to 50, 5 to 30, or 7 to 25.

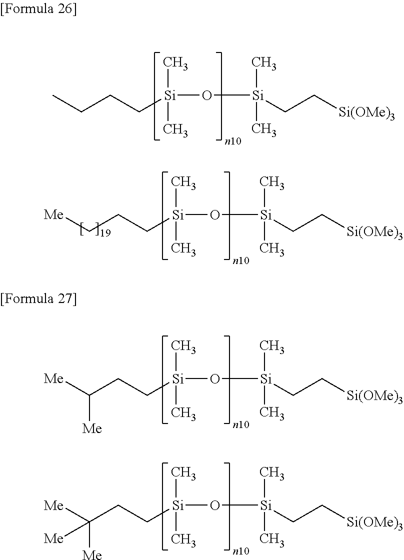

The compound (3) is preferably a compound represented by Formula (3A) shown below.

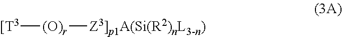

In Formula (3A),
T³ is a monovalent cyclic polysiloxane residue or a monovalent cage-like polysiloxane residue,
r is 0 or 1,
Z³ is a divalent chain organo (poly) siloxane residue or a combination of a divalent chain organo (poly) siloxane residue and at least one of an alkylene chain and a polyalkylene oxide chain,
A is a single bond or a linking group having a valence of (p1+1),
each R² is independently a monovalent hydrocarbon group,
each L is independently a hydrolyzable group, a group having a hydrolyzable group, or a hydroxyl group,
n is an integer of 0 to 2, and p1 is an integer of 1 or more.

R², L, and n are the same as R², L, and n in the above-shown Formula (S1).

The group represented by A(Si(R²)ₙ L₃₋ₙ) is the same as the group represented by A(Si(R²)ₙ L₃₋ₙ) in the above-shown Formula (1A) except for the matters described below.

p1 is the same as p1 in the above-shown Formula (1A).

Details of the monovalent cyclic polysiloxane residue or the monovalent cage-like polysiloxane residue are the same as those described for T¹¹ of Formula (C).

The group represented by A(Si(R²)ₙ L₃₋ₙ) is preferably the group (3-1A) or (3-1B), and more preferably the group (3-1A).

In Formula (3-1A), Q^{a} is a single bond or a divalent linking group.

However, the end of Q^{a} on the side which is bonded to Z³ is not any of an alkylene group, a polyalkylene oxide chain, and a divalent organo (poly) siloxane residue.

When the end of the A side of Z³ is an alkylene chain, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d}), —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—, more preferably —OC(O)—, an alkylene group having —C(O)N(R^{d})—, an alkylene group having —OC(O)N(R^{d})—, an alkylene group having an etheric oxygen atom, an alkylene group having —S—, an alkylene group having —C(O)O—, an alkylene group having —C(O)S—, an alkylene group having —N(R^{d})—, or an alkylene group having —N(R^{d})C(O)N(R^{d})—, and still more preferably an alkylene group having —C(O)O— or an alkylene group having —C(O)N(R^{d}).

When the end of the A side of Z³ is a polyalkylene oxide chain, Q^{a} is preferably a divalent hydrocarbon group other than an alkylene group, a divalent heterocyclic group, —SO₂—, —C(O)—, —Si(R^{a})₂—, —C(O)O—, —C(O)S—, —C(O)N(R^{d})—, —SO₂N(R^{d})—, an alkylene group having —C(O)N(R^{d})—, an alkylene group having —C(O)O—, or an alkylene group having —SO₂N(R^{d})—, and more preferably —C(O)—.

When the end of the A side of Z³ is a divalent chain organo (poly)siloxane residue, Q^{a} is preferably a divalent hydrocarbon group other than an alkylene group, a divalent heterocyclic group, —O—, —S—, —SO₂—, —N(R^{d})—, —C(O)—, —Si(R^{a})₂—, —OC(O)—, —C(O)O—, —C(O)S—, —C(O)N(R^{d})—, —N(R^{d})C(O)—, —N(R^{d})C(O)N(R^{d})—, —N(R^{d})C(O)O—, —OC(O)N(R^{d})—, —SO₂N(R^{d})—, —N(R^{d})SO₂—, an alkylene group having —C(O)N(R^{d})—, an alkylene group having —N(R^{d})C(O)—, an alkylene group having —OC(O)N(R^{d})—, an alkylene group having an etheric oxygen atom, an alkylene group having —S—, an alkylene group having —OC(O)—, an alkylene group having —C(O)O—, an alkylene group having —C(O)S—, an alkylene group having —N(R^{d})—, an alkylene group having —N(R^{d})C(O)N(R^{d})—, or an alkylene group having —SO₂N(R^{d})—.

In Formula (3-1A), X³¹ is a single bond, an alkylene group, a carbon atom, a nitrogen atom, a silicon atom, an organo (poly) siloxane residue having a valence of 2 to 8, or a group having a ring having a valence of (i+1).

However, when Q^{a} is a single bond, the end of X³¹ on the side which is bonded to Z³ is not any of an alkylene group, a polyalkylene oxide chain, and a divalent organo (poly) siloxane residue. In the other cases, the end of X³¹ may be any of an alkylene group, a polyalkylene oxide chain, and a divalent organo (poly) siloxane residue.

In Formula (3-1A), Q^{b} is a single bond or a divalent linking group.

However, when Q^{a} and X³¹ are single bonds, the end of Q^{b} on the side which is bonded to Z³ is not any of an alkylene group, a polyalkylene oxide chain, and a divalent organo (poly) siloxane residue. In the other cases, the end of Q^{b} may be any of an alkylene group, a polyalkylene oxide chain, and a divalent organo (poly) siloxane residue.

In Formula (3-1A), when Q^{a}, X³¹, and Q^{b} are single bonds, [Si(R²)ₙ L₃₋ₙ] is directly bonded to Z³, and Z³ is an alkylene chain.

In Formula (3-1B), Q^{c} is a single bond or a divalent linking group.

However, the end of Q^{c} on the side which is bonded to Z³ is not any of an alkylene group, a polyalkylene oxide chain, and a divalent organo (poly) siloxane residue.

The group (3-1A) is preferably one of groups (3-1A-1) to (3-1A-7).

However, the ends of the groups (3-1A-1) to (3-1A-7) on the sides which are bonded to Z³ are not any of an alkylene group, a polyalkylene oxide chain, and a divalent organo (poly) siloxane residue.

In the group (3-1A-1), when the end of the A side of Z³ is an alkylene chain, X³² is preferably —O—, —S—, —N(R^{d})—, —C(O)—, —C(O)O—, —C(O)S—, —SO₂N(R^{d})—, —N(R^{d})SO₂—, —N(R^{d})C(O)—, —N(R^{d})C(O)N(R^{d})—, —OC(O)N(R^{d})—, or —C(O)N(R^{d})—, more preferably —O—, —S—, —N(R^{d})—, —C(O)O—, —C(O)S—, —N(R^{d})C(O)—, —N(R^{d})C(O)N(R^{d})—, —OC(O)N(R^{d})—, or —C(O)N(R^{d})—, and still more preferably —C(O)O— or —N(R^{d})C(O)—.

When the end of the A side of Z³ is a polyalkylene oxide chain, X³² is preferably —C(O)—, —C(O)O—, —C(O)S—, —SO₂N(R^{d})—, or —C(O)N(R^{d})—, and more preferably —C(O)—.

When the A end of Z³ is a divalent chain organo (poly) siloxane residue, X³² is preferably —O—, —S—, —N(R^{d})—, —C(O)—, —C(O)O—, —C(O)S—, —SO₂ N(R^{d})—, —N(R^{d})SO₂—, —N(R^{d})C(O)—, —N(R^{d})C(O)N(R^{d})—, —OC(O)N(R^{d})—, or —C(O)N(R^{d})—, with —O— being more preferred.

When the end on the A side of Z³ is an alkylene chain, s1 is preferably 0 and Q^{b1} is preferably a single bond, or s1 is preferably 1 and Q^{b1} is preferably an alkylene group comprising 2 to 6 carbon atoms.

When the end on the A side of Z³ is a polyalkylene oxide chain, s1 is preferably 1 and Q^{b1} is preferably an alkylene group comprising 2 to 6 carbon atoms.

When the end on the A side of Z³ is a divalent chain organo (poly) siloxane residue, s1 is preferably 1 and Q^{b1} is preferably a single bond.

In Formula (3A), A may be one of the groups (g2-1), (g2-2), and (g2-4) to (g2-7).

However, in Formulas (g2-1), (g2-2), and (g2-4) to (g2-7), the A¹ side is bonded to Z³, and the Q²², Q²³, Q²⁴, Q²⁵, or Q²⁶ side is bonded to [—Si(R²)ₙL₃₋ₙ].

Examples of other embodiments of A include the groups (g2-8), (g2-9), and (g2-11) to (g2-14).

However, in Formulas (g2-8), (g2-9), and (g2-11) to (g2-14), the A¹ side is bonded to Z³, and the G¹ side is bonded to [—Si(R²)ₙ L₃₋ₙ].

Specific examples of the compound (3) include compounds shown below. In the below-shown formula, n10 is a number of 1 or more, is preferably 1 to 60, and may be a number of 3 to 50, 5 to 30, or 7 to 25.

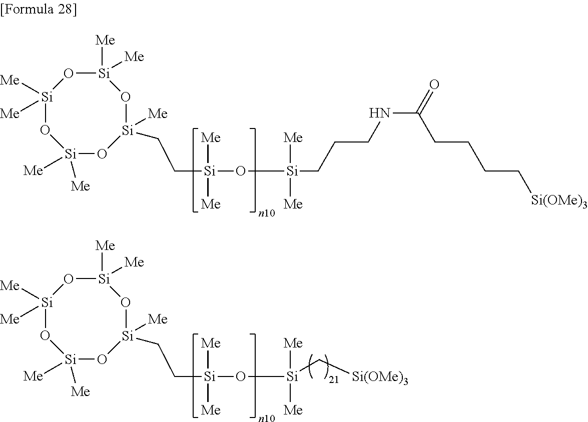

### (Compounds (4A) and (4B))

In the compounds (4A) and (4B),
each X^{A} is preferably each independently,

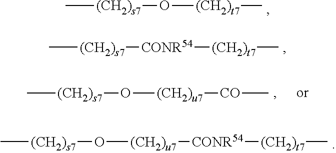

Each R⁵⁴ is independently a hydrogen atom, a phenyl group, an alkyl group comprising 1 to 6 carbon atoms, or an oxyalkylene-comprising group comprising 1 to 10 carbon atoms,
s7 is an integer of 1 to 20,
t7 is an integer of 1 to 20,
u7 is an integer of 1 to 20.

Each X^{A} is preferably each independently a group represented by Formula (W6) shown below.

In Formula (W6), each X^{a} is independently a single bond or a divalent organic group.

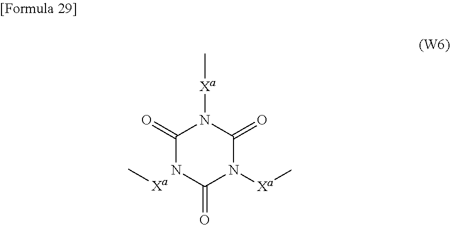

Specific examples of the compound (4A) include compounds shown below. —(CH₃)₃Si—(OSi(CH₃)₂)₁₉—(CH₂)₁₀—CONH—CH₂CH₂CH₂CH₂CH₂Si(OCH₃)₃

### (Compound (5))

When the surface treatment agent according to the present disclosure comprises the compound (5), the surface treatment agent according to the present disclosure preferably further comprises a metal compound.

The metal compound is preferably a compound represented by Formula (M6a) or (M6b) shown below.

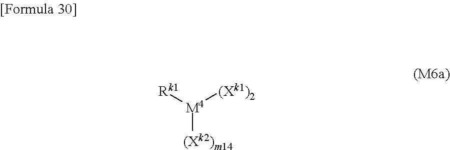

In Formula (M6a),
R^{k1} represents a siloxane skeleton-containing group, a hydrocarbon chain-containing group, or a hydrolyzable group,
the plurality of each X^{k1} each independently represent a hydrolyzable group, and
X^{k2} represents a siloxane skeleton-containing group, a hydrocarbon chain-containing group, or a hydrolyzable group.

The number of atoms of the siloxane skeleton-containing group in R^{k1} and X^{k1} is less than the number of atoms of the trialkylsilyl group-containing molecular chain represented by (R^{a9})₃Si—Z—(Si(R^{s1})₂—O—)ₙ₉—Y— of the compound (5), and the number of carbon atoms of the longest linear chain of the hydrocarbon chain contained in the hydrocarbon chain-containing group in R^{k1} and X^{k1} is less than the number of atoms of the trialkylsilyl group-containing molecular chain represented by (R^{a9})₃Si—Z—(Si(R^{s1})₂—O—)ₙ₉—Y— of the compound (5).

When R^{k1} and X^{k2} are siloxane skeleton-containing groups or hydrocarbon chain-containing groups, R^{k1} and X^{k2} may be the same as each other or different from each other.

When X^{k2} is a hydrolyzable group, X^{k2} and X^{k1} may be the same as each other or different from each other. Further, R^{k1} and X^{k2} may be the same as each other or different from each other. M⁴ represents a trivalent or tetravalent metal atom capable of forming a metal alkoxide. m14 represents an integer of 0 or 1 according to M⁴.

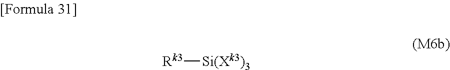

In Formula (M6b),
R^{k3} represents a hydrolyzable silane oligomer residue, and
X^{k3} represents a hydrolyzable group, a fluorine-containing alkyl group containing 1 to 4 carbon atoms, or an alkyl group comprising 1 to 4 carbon atoms.

Specific examples of the compound (5) include compounds shown below. In the below-shown formula, n10 is a number of 1 or more, is preferably 1 to 60, and may be a number of 3 to 50, 5 to 30, or 7 to 25.

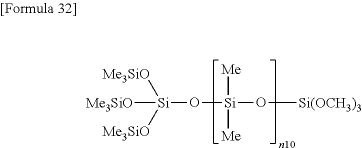

### <Second Compound>

The second compound has: a hydrocarbon group comprising four or more carbon atoms, which has no organo (poly)siloxane residue and may have a functional group or a substituent; and a reactive silyl group b.

Examples of organo (poly)siloxane residues that are not contained in the second compound include organo (poly)siloxane residues contained in the above-described first compound, represented by Formulas (B1) and (B2).

Examples of the second compound include a compound having a reactive silyl group b connected to only one of the ends of the above-described hydrocarbon group (hereinafter also referred to as a “second compound S”), and a compound having reactive silyl groups b respectively connected to both ends of the above-described hydrocarbon group (hereinafter also referred to as a “second compound D”).

As the second compound, the second compound S may be used alone; the second compound D may be used alone; or a combination of the second compound S and the second compound D may be used. In any of the cases, one type of second compound S may be used alone; two or more types thereof may be used in combination; one type of second compound D may be used alone; or two or more types thereof may be used in combination.

In particular, in the second compound, the reactive silyl group b is preferably connected to only one of the ends of the above-described hydrocarbon group.

### (Reactive Silyl Group)

The second compound comprises a reactive silyl group b. The preferred embodiments of the reactive silyl group b contained in the second compound are the same as those of the reactive silyl group a contained in the first compound.

Specifically, the reactive silyl group a and the reactive silyl group b are preferably each independently represented by the above-shown Formula (S1). Details of Formula (S1) are the same as those described above.

### (Hydrocarbon Group)

The second compound has a hydrocarbon group comprising four or more carbon atoms, which has no organo (poly) siloxane residue and may have a functional group or a substituent.

Note that the “number of carbon atoms of a hydrocarbon group” does not include carbon atoms contained in the functional group or the substituent.

Hereinafter, a hydrocarbon group comprising four or more carbon atoms which may have a functional group or a substituent is referred to as a “hydrocarbon group M”.

The hydrocarbon group M may or may not have a functional group or a substituent.

Examples of the hydrocarbon group include an aliphatic hydrocarbon group and an aromatic hydrocarbon group. In particular, the hydrocarbon group is preferably an aliphatic hydrocarbon group and more preferably an alkyl group.

The alkyl group may be any of a linear alkyl group, a branched alkyl group, and a cyclic alkyl group.

The number of carbon atoms of the hydrocarbon group is preferably 4 to 50 and particularly preferably 8 to 30.

Examples of functional groups or substituents that the hydrocarbon group M may have include an amide group and an ester group.

In particular, the hydrocarbon group M is preferably an unsubstituted hydrocarbon group.

Further, the hydrocarbon group M is preferably not directly bonded to an oxygen atom or a nitrogen atom.

In the second compound, the hydrocarbon group and the reactive silyl group may be directly bonded to each other, or the hydrocarbon group and the reactive silyl group may be bonded to each other through another group.

The second compound is preferably a compound represented by Formula (G).

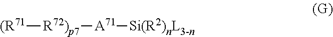

in Formula (G),
R⁷¹ is a hydrogen atom or [(CH₃)₃Q⁷¹-R⁷³-]ₘ₇Q⁷²(CH₃)₃₋ₘ₇—,
each Q⁷¹ and Q⁷² is independently C or Si,
each R⁷³ is independently an alkylene group comprising 1 to 6 carbon atoms,
m7 is an integer of 0 to 3,
R⁷² is an alkylene group, and may have, when a number of carbon atoms is 2 or more, one or more groups selected from —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group between carbon atoms,
A⁷¹ is a single bond or a linking group having a valence of (p+1),
each R² is independently a hydrocarbon group,
each L is independently a hydrolyzable group, a group having a hydrolyzable group, or a hydroxyl group;
n is an integer of 0 to 2, and
p7 is an integer of 1 or more, and

When R⁷¹ is a hydrogen atom, R⁷¹-R⁷² in Formula (G) are alkyl groups. Examples of such alkyl groups include those the same as R^{Ak} in Formula (E) described later.

When the aforementioned R⁷¹ is [(CH₃)₃Q⁷¹-R⁷³-]ₘ₇Q⁷²(CH₃)₃₋ₘ₇—, R⁷¹-R⁷² is an alkyl group comprising a trimethylsilyl group (TMS) or a tert-butyl group (tBu) at the tip. Regarding the second compound having TMS or tBu at the tip, when the surface-treated layer is formed, TMS or tBu is positioned on the air interface side, so that the second compound has excellent water repellency and excellent oil repellency, and the fingerprint wiping property is further improved.

R⁷³ is an alkylene group comprising 1 to 6 carbon atoms. By having R⁷³, the steric hindrance is eased even when two or more TMS and tBu are present at the tip, so that the mobility of the molecule is increased. As a result, a surface-treated layer with excellent water repellency and excellent oil repellency can be formed. The alkylene group in R⁷³ may be linear or branched.

Examples of R⁷³ include —CH₂—, —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH(CH₃)—, —CH(CH₃)CH₂—, —CH(CH₃)CH₂CH₂—, —CH(CH₂CH₃)CH₂CH₂—, —CH₂ C(CH₂)₂CH₂—, —CH₂CH(CH₃)CH₂CH₂CH₂—, and —CH₂CH₂CH(CH₃)CH₂CH₂—. When R⁷³ is a branched alkylene group having a branch, the number of carbon atoms of the branched chain is preferably 1 to 2, and more preferably 1 (i.e., a methyl group) in order to further improve the abrasion resistance. The number of carbon atoms of the alkylene group in R² is preferably 1 to 5 and more preferably 1 to 4.

m7 is an integer of 0 to 3. In order to further improve the abrasion resistance, the acid resistance, and the hot-water resistance, m7 is preferably 0 to 2 and more preferably 0 to 1.

R⁷² is an alkylene group comprising one or more carbon atoms, and may have, when the number of carbon atoms is 2 or more, one or more bonds selected from —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group between carbon atoms. The number of bonds in R⁷² is preferably 0 to 2 and more preferably 0 or 1.

p7 is an integer of 1 or more, and when R⁷¹ is [(CH₃)₃Q⁷¹-R⁷³-]ₘ₇Q⁷²(CH₃)₃₋ₘ₇—, p7 is preferably 1.

A⁷¹ is a single bond or a linking group having a valence of (p+1), and examples of linking groups include linking groups the same as those of A¹¹ in Formula (C) and A in Formula (TA).

Further, R², L, and n in —Si(R²)~L₃₋ₙ in T⁷¹ are the same as R², L, and n in the above-shown Formula (Si).

The second compound is preferably, among the compounds (G), a compound represented by Formula (E) or (F) in view or the water repellency, the abrasion resistance, and the fingerprint removal property.

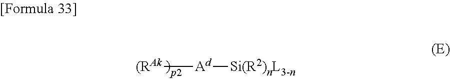

In Formula (E),
each R^{Ak} is independently an alkyl group,
A^{d} is a single bond, or a linking group having a valence of (p2+1) other than an oxygen atom,
p2 is an integer of 1 or more,
each R² is independently a hydrocarbon group,
each L is independently a hydrolyzable group, a group having a hydrolyzable group, or a hydroxyl group; and
n is an integer of 0 to 2.

R², L, and n in Formula (E) are the same as R², L, and n in the above-shown Formula (Si).

In Formula (E), p2 is preferably 1 to 15, more preferably 1 to 6, still more preferably 2 to 4, and particularly preferably 2 or 3. p² may be 1.

A^{d} is the same as A in the above-shown Formula (TA) except that A^{d} is not an oxygen atom.

In particular, the group represented by A^{d}(Si(R²)ₙL₃₋ₙ) is preferably the group (3-TA) or (3-1B), more preferably the group (3-TA), and still more preferably the group (3-1A-4).

each R^{Ak} is independently an alkyl group, and may be any of a linear alkyl group, a branched alkyl group, and a cyclic alkyl group.

The number of carbon atoms of R^{Ak} is preferably 4 to 50, more preferably 8 to 40, and particularly preferably 8 to 30.

Examples of R^{Ak} include groups shown below.

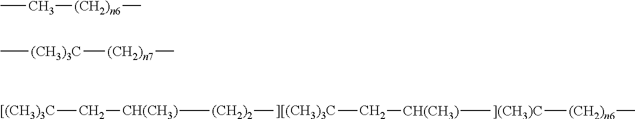

n6 is, for example, 7, 8, 9, 10, 11, 12, 13, 14, 15, 16, 17, 18, 19, 20, or 22.
n7 is, for example, 20.
n8 is, for example, 20.

The compound (E) is preferably a compound represented by Formula (E1) or (E2) shown below.

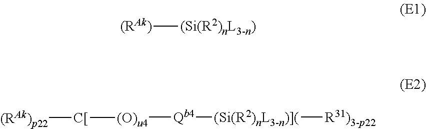

In Formula (E1),
R^{Ak} is an alkyl group,
each R² is independently a hydrocarbon group,
L is a hydrolyzable group, a group having a hydrolyzable group, or a hydroxyl group, and
n is an integer of 0 to 2.

In Formula (E2),
each R^{Ak} is independently an alkyl group,
p22 is an integer of 1 to 3,
u4 is 0 or 1,
Q^{b4} is an alkylene group,
R³¹ is a hydrogen atom, a hydroxyl group, or an alkyl group,
each R² is independently a hydrocarbon group,
L is a hydrolyzable group, a group having a hydrolyzable group, or a hydroxyl group, and
n is an integer of 0 to 2.

R², L, and n in Formulas (E1) and (E2) are the same as R², L, and n in the above-shown Formula (Si).

R^{Ak} in Formulas (E1) and (E2) is the same as R^{Ak} in the above-shown Formula (E).

u4, Q^{b4}, and R³¹ in Formula (E2) are the same as u4, Q^{b4}, and R³¹ in the above-shown group (3-1A-4).

p22 is preferably 1 to 2.

Specific examples of the compound (E) are as follows.

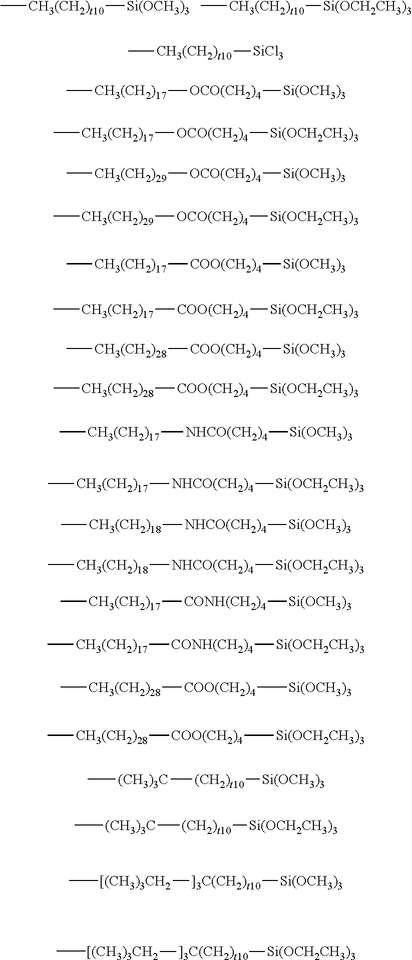

In the above-shown Formula (F), 110 is an integer of 3 to 49 such as 7, 8, 9, 10, 11, 12, 13, 14, 15, 16, 17, 18, 19, or 20.

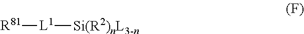

in Formula (F),
R⁸¹ is [(CH₃)₃Q⁷¹-R⁷³—]ₘ₇Q⁷²(CH₃)₃₋ₘ₇—,
each Q⁷¹ and Q⁷² is independently C or Si,
at least one of Q⁷¹ and Q⁷² is Si,
each R⁷³ is independently an alkylene group comprising 1 to 6 carbon atoms,
m7 is an integer of 0 to 3,
L¹ is an alkylene group comprising 13 or more carbon atoms, and may have one or more groups selected from —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group between carbon atoms,
each R² is independently a hydrocarbon group,
each L is independently a hydrolyzable group, a group having a hydrolyzable group, or a hydroxyl group;
n is an integer of 0 to 2.

In the compound (F), R⁷³, Q⁷¹, Q⁷², m7, R², L, and n are the same as those in the above-described compound (G). However, at least one of Q⁷¹ and Q⁷² is Si.

m7 is an integer of 0 to 3, preferably 0 to 2, and more preferably 0 to 1. When m7 is 0, Q⁷² is Si and R⁸¹ is (CH₃)₃Si—.

Examples of R⁸¹ include groups shown below. Note that * indicates a position of the bond with L¹.

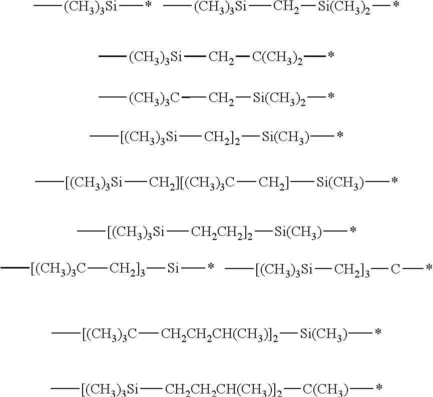

L¹ is an alkylene group comprising 13 or more carbon atoms, and may have one or more groups (bonds) selected from —O—, —S—, —C(═O)NH—, —NHC(═O)—, —C(═O)O—, —OC(═O)—, —C(═O)S—, —SC(═O)—, —S (═O)₂NH—, —NHS(═O)₂—, —S(═O)₂O—, —OS(═O)₂—, and a phenylene group between carbon atoms.

Since L¹ is an alkylene group comprising 13 or more carbon atoms, a surface-treated layer with excellent hot-water resistance and excellent friction resistance in addition to excellent acid resistance can be formed. The number of carbon atoms of L¹ may be 13 or more, and in order to further improve the acid resistance, the hot-water resistance, and the friction resistance of the surface-treated layer, is preferably 15 or more and more preferably 19 or more. Meanwhile, the upper limit of the number of carbon atoms of L¹ is not limited to any particular numbers. However, the upper limit may be, for example, 100 or less, and in view of the ease of the manufacturing of the compound (1), is preferably 36 or less. Note that the carbons contained in each of the above-described bonds (e.g., carbons contained in —C(═O)O—) are not included in the number of carbon atoms of the alkylene group.

The alkylene group of L¹ may be linear or branched. In the case of a branched one, the number of carbon atoms of the branched chain is preferably 1 to 2 and more preferably 1 (i.e., a methyl group). On the other hand, in order to further improve the acid resistance, the hot-water resistance, and the friction resistance of the surface-treated layer, L¹ is preferably a linear alkylene group.

In order to further improve the acid resistance, the hot-water resistance, and the friction resistance of the surface-treated layer, the number of groups (bonds) in L¹ is preferably 0 to 2 and more preferably 0 or 1.

When L¹ has the above-described group, in order to further improve the acid resistance, the hot-water resistance, and the friction resistance of the surface-treated layer, the group is preferably present on the T¹ side of the center of L¹.

L¹ is preferably a group represented by Formula (L) shown below.

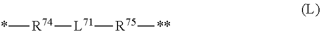

In Formula (L),
R⁷⁴ is a linear alkylene group comprising six or more carbon atoms,
R⁷⁵ is a single bond or a linear alkylene group comprising 1 to 6 carbon atoms,
L⁷¹ is a single bond, —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, or a phenylene group,
when L⁷¹ is a single bond, R⁷⁵ is a single bond and R⁷⁴ is a linear alkylene group comprising 13 or more carbon atoms,
when L⁷¹ is not a single bond, R⁷⁵ is a linear alkylene group comprising 1 to 6 carbon atoms and the total number of carbon atoms of R⁷⁴ and R⁷⁵ is 13 or more, and
* indicates a position of the bond with R⁸¹, and ** indicates a position of the bond with Si(R²)ₙ L₃₋ₙ.

When L⁷¹ is a single bond, the number of carbon atoms of R⁷⁴ is preferably 13 or more, more preferably 15 or more, and still more preferably 17 or more in order to further improve the acid resistance, the hot-water resistance, and the friction resistance of the surface-treated layer. Further, in view of the ease of the manufacturing, the number of carbon atoms of R⁷⁴ is preferably 36 or less.

When L⁷¹ is any of various bonds other than a single bond, the number of carbon atoms of R⁷⁴ is preferably 12 or more, more preferably 14 or more, and still more preferably 16 or more in order to further improve the acid resistance, the hot-water resistance, and the friction resistance of the surface-treated layer. Further, in view of the ease of the manufacturing of the compound (F), the number of carbon atoms of R⁷⁵ is preferably 2 to 6 and more preferably 3 to 6.

In order to further improve the acid resistance, the hot-water resistance, and the friction resistance of the surface-treated layer, L⁷¹ is preferably a single bond.

Examples of L¹ include groups shown below. Note that * indicates a position of the bond with R⁸¹, and ** indicates a position of the bond with Si(R²)ₙ L₃₋ₙ. Each n1 is independently an integer of 5 or more, and is preferably 32 or less.

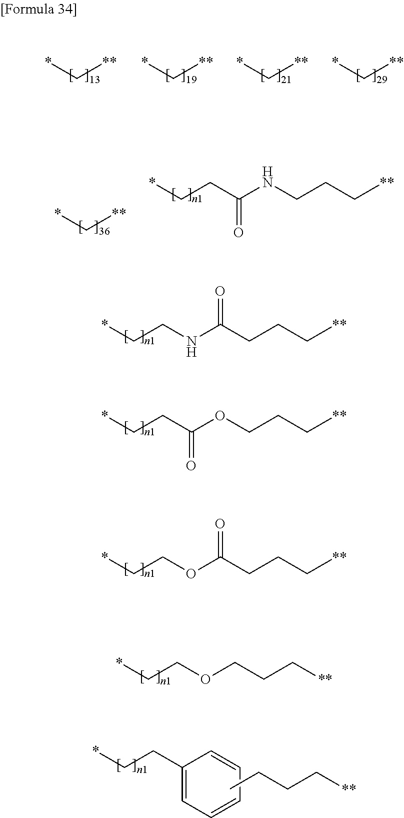

Examples of the Compound (F) include compounds shown below. However, they are not limited to these examples. Further, in the below-shown formula, the carbon atom at the end on the R⁸¹ side in L¹ is denoted by “1”, and the carbon atom at the end on the Si(R²)ₙ L₃₋ₙ side in L¹ is denoted by the number of carbon atoms constituting L¹ (e.g., 13, 19, and 21).

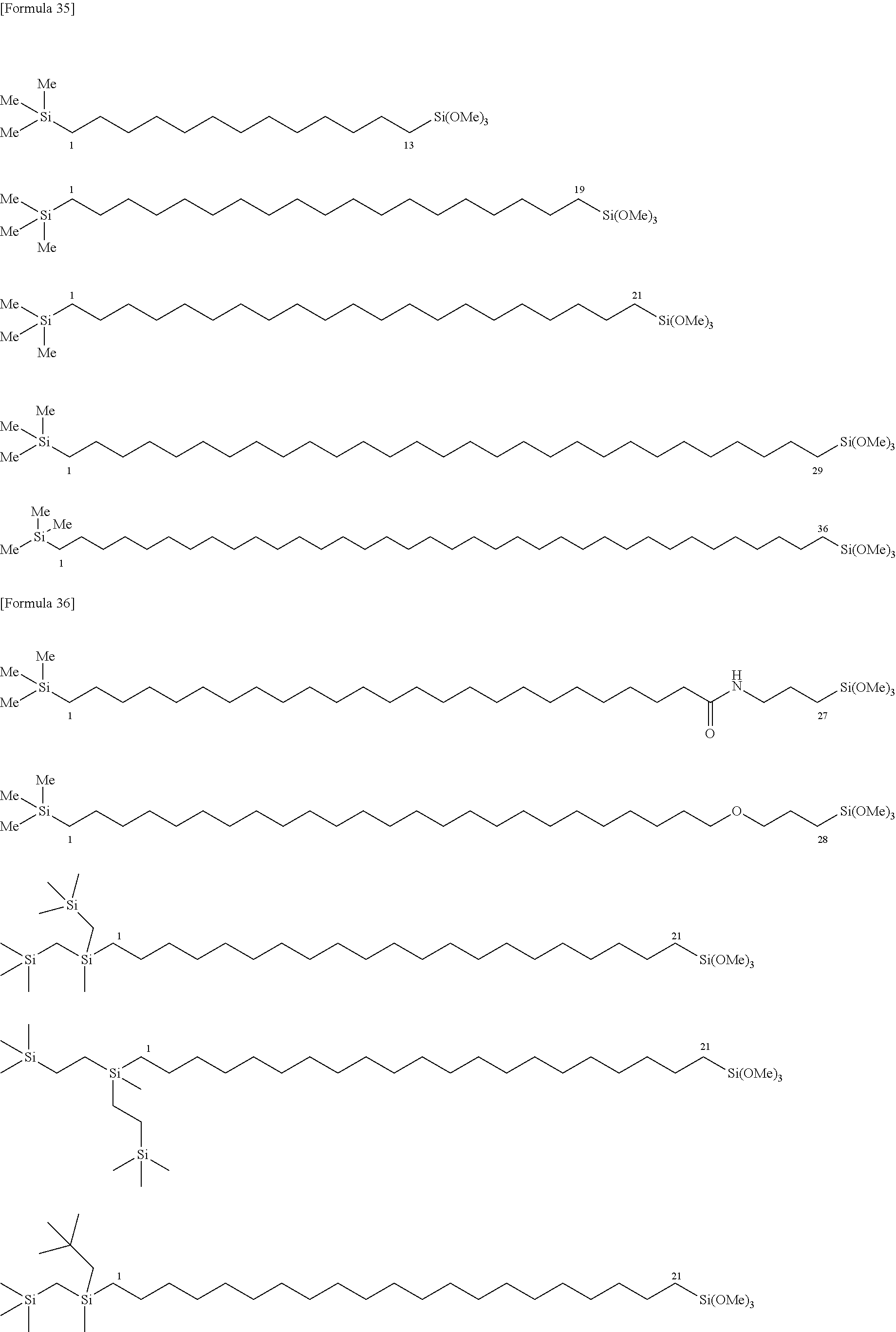

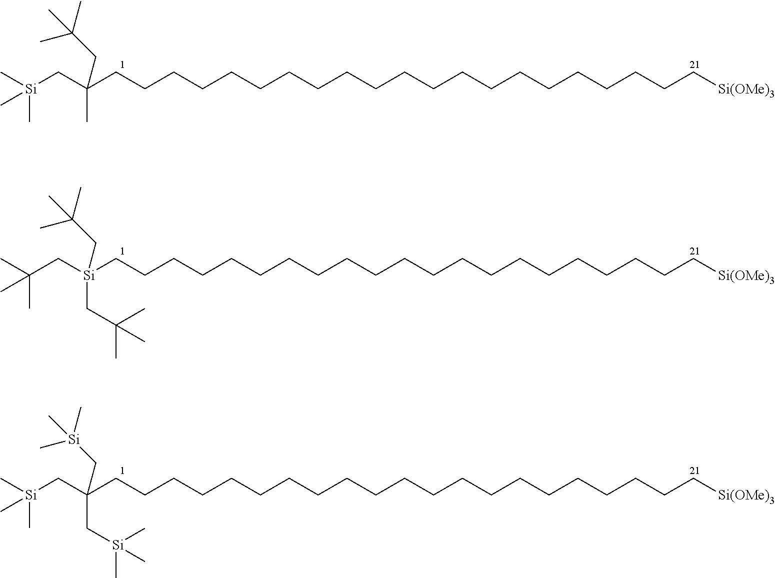

### <Requirements (1) and (2)>

The composition according to the present disclosure satisfies Requirements (1) and (2).
Requirement (1): in the first compound, one reactive silyl group a is connected to at least one of ends of the organo (poly)siloxane residue; and
Requirement (2): in the second compound, one reactive silyl group b is connected to at least one of ends of the hydrocarbon group.

Satisfying Requirements (1) and (2) means that, in both the first and second compounds, only one reactive silyl group is connected to one end of the compound, or one reactive silyl group is connected to each of both ends of the compound. Since the reactive silyl groups contained in the first and second compounds can each react with the substrate, each of the first and second compounds can exhibit its respective effects, thereby, making it possible to achieve both water repellency and abrasion resistance.

### —Requirement (1)—

In the first compound, the reactive silyl group a is preferably connected to only one of the ends of the organo (poly) siloxane residue.

The reactive silyl group a connected to at least one of the ends of the organo (poly) siloxane residue may be directly connected to the organo (poly) siloxane residue or connected thereto through another group(s).

### —Requirement (2)—

In the second compound, the reactive silyl group b is preferably connected to only one of the ends of the hydrocarbon group.

The reactive silyl group b connected to at least one of the ends of the hydrocarbon group may be directly connected to the hydrocarbon group or connected thereto through another group.

In the composition according to the present disclosure, the mass ratio of the second compound to the first compound is preferably 0.001 to 0.9, more preferably 0.002 to 0.7, still more preferably 0.03 to 0.5, and particularly preferably 0.04 to 0.2.

When the mass ratio of the second compound to the first compound is equal to or more than the lower limit value of the aforementioned range, the composition has excellent water repellency and excellent abrasion resistance.

When the mass ratio of the second compound to the first compound is equal to or lower than the upper limit value of the aforementioned range, the composition has excellent water repellency.

In the composition according to the present disclosure, the mass ratio of the second compound to the total mass of the first and second compounds is preferably 0.001 to 0.9 and more preferably 0.1 to 0.9.

The composition according to the present disclosure may comprise components other than the first and second compounds.

For example, the composition according to the present disclosure may comprise impurities such as by-products generated in the process for manufacturing the first and second compounds.

### (Liquid Medium)

The composition according to the present disclosure may comprise a liquid medium.

The composition according to the present disclosure may comprise only one type of liquid medium, or may comprise two or more types of liquid mediums.

The liquid medium is preferably an organic solvent.

Examples of organic solvents include compounds consisting solely of hydrogen atoms and carbon atoms, and compounds consisting solely of hydrogen atoms, carbon atoms, and oxygen atoms. Specifically, examples include hydrocarbon-based organic solvents, ketone-based organic solvents, ether-based organic solvents, ester-based organic solvents, glycol-based organic solvents, and alcohol-based organic solvents.

Specific examples of hydrocarbon-based organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene. Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, 3,3,5-trimethylcyclohexanone, and isophorone.

Specific examples of ether-based organic solvents include diethyl ether, cyclopentyl methyl ether, tetrahydrofuran, and 1,4-dioxane.

Specific examples of ester-based organic solvents include methyl acetate, ethyl acetate, propyl acetate, isopropyl acetate, butyl acetate, isobutyl acetate, tert-butyl acetate, amyl acetate, isoamyl acetate, ethyl 3-ethoxypropionate, ethyl lactate ethylene glycol monobutyl ether acetate, diethylene glycol monobutyl ether acetate, propylene glycol monomethyl ether acetate, dipropylene glycol methyl ether acetate, 3-methoxy-3-methylbutyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, propylene glycol monomethyl ether acetate, propylene glycol monomethyl ether propionate, propylene glycol monoethyl ether acetate, propylene glycol monobutyl ether acetate, propylene glycol monopropyl ether acetate, dipropylene glycol methyl ether acetate, 1,3-butylene glycol diacetate, 1,4-butanediol diacetate, 1,3-butylene glycol diacetate, 1,6-hexanediol diacetate, y-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monobutyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monomethyl ether, dipropylene glycol monopropyl ether, dipropylene glycol monomethyl ether, tripropylene glycol monobutyl ether tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, diethylene glycol diethyl ether, diethylene glycol dimethyl ether, diethylene glycol dimethyl ether, dipropylene glycol dimethyl ether, diethylene glycol dibutyl ether, tetraethylene glycol dimethyl ether, triethylene glycol dimethyl ether, and polyethylene glycol dimethyl ether.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4-methyl-2-pentanone, 2-ethyl-1-hexanol, 3,5,5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Further, examples of organic solvents include halogen-based organic solvents, nitrogen-containing compounds, sulfur-containing compounds, siloxane compounds, and fluorine-containing organic solvents.

Specific examples of halogen-based organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Examples of nitrogen-containing compounds include nitrobenzene, acetonitrile, benzonitrile, N,N-dimethylformamide, N,N-dimethylacetamide, N-methylpyrrolidone, and 1,3-dimethyl-2-imidazolidinone.

Examples of sulfur-containing compounds include carbon disulfide and dimethyl sulfoxide.

Examples of siloxane compounds include hexamethyldisiloxane, hexaethyldisiloxane, octamethyltrisiloxane, octaethyltrisiloxane, hexamethylcyclotrisiloxane, hexaethylcyclotrisiloxane, octamethylcyclotetrasiloxane, octaethylcyclotetrasiloxane, and decamethyltetrasiloxane.

Examples of fluorine-containing organic solvents include polyfluoro aromatic hydrocarbons (e.g., 1,3-bis(trifluoromethyl) benzene); polyfluoro aliphatic hydrocarbons (e.g., C₆F₁₃CH₂CH₃ (e.g., Asahikrin (Registered Trademark) AC-6000 manufactured by AGC Inc.,), 1,1,2,2,3,3,4-heptafluorocyclopentane (e.g., Zeorora (Registered Trademark) H manufactured by Zeon Corporation); hydrofluoroethers (HFE) (e.g., alkyl perfluoroalkyl ethers (perfluoroalkyl group and alkyl group may be linear chain or branched) such as perfluoropropyl methyl ether (C₃F₇OCH₃) (e.g., Novec (Registered Trademark) 7000 manufactured by 3M Japan Limited), perfluorobutyl methyl ether (C₄F₉OCH₃) (e.g., Novec (Registered Trademark) 7100 manufactured by 3M Japan Limited), perfluorobutyl ethyl ether (C₄F₉OC₂H₅) (e.g., Novec (Registered Trademark) 7200 manufactured by 3M Japan Limited), and perfluorohexyl methyl ether (C₂F₅CF(OCH₃)C₃F₇) (e.g., Novec (Registered Trademark) 7300 manufactured by 3M Japan Limited), and CF₃CH₂OCF₂CHF₂ (e.g., Asahikrin (Registered Trademark) AE-3000 manufactured by AGC Inc.,); and hydrofluoroolefins (HFO) (e.g., 1-chloro-2,3,3-trifluoro-1-propene (HCFO-1233yd) (e.g., Amolea (Registered Trademark) AS-300 manufactured by AGC Inc.,), and Opteon (Registered Trademark) SF01, SF05, SF10, SF30, SF33, SF70, SF79, SF80 manufactured by The Chemours Company).

The content of the liquid medium is preferably 50 to 99.999 wt %, more preferably 80 to 99.99 wt %, and still more preferably 90 to 99.9 wt % based on the total amount of the composition according to the present disclosure. In the case where the composition according to the present disclosure is used in a wet-coating method, the content of the liquid medium may be 90 to 99.99 wt %, 95 to 99.98 wt %, 97 to 99.97 wt %, or 98 to 99.95 wt % based on the total amount of the composition according to the present disclosure.

### (Other Components)

In addition to the first compound, the second compound, and the liquid medium, the composition according to the present disclosure may comprise other components in a range in which the effects of the present disclosure are not impaired.

Examples of other components include known additives, such as acid catalysts and base catalysts, which accelerate the hydrolysis and the condensation reaction of the reactive silyl group.

An arbitrary suitable acid or base, a transition metal (e.g., Ti, Ni, Sn, Zr, Al or B), a sulfur-containing compound having a non-covalent electron pair in the molecular structure, a nitrogen-containing compound (e.g., a sulfoxide compound, an aliphatic amine compound, an aromatic amine compound, a phosphoric acid amide compound, an amide compound, and a urea compound) can be used as the catalyst.

Examples of acid catalysts include acetic acid, formic acid, trifluoroacetic acid, hydrochloric acid, nitric acid, sulfuric acid, phosphoric acid, sulfonic acid, methanesulfonic acid, and p-toluenesulfonic acid.

Further, examples of base catalysts include ammonia, sodium hydroxide, and potassium hydroxide, and organic amines such as triethylamine and diethylamine.

Further, examples of other components include metal compounds having hydrolyzable groups (hereinafter, a metal compound having a hydrolyzable group is also referred to as a “specific metal compound”.). When the composition according to the present disclosure comprises a specific metal compound, the sliding property and the antifouling property of the surface-treated layer could be further improved. Examples of specific metal compounds include those represented by Formulas (M1) to (M3) shown below.

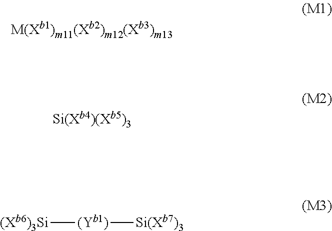

In Formula (M1),

M represents a trivalent or tetravalent metal atom.

Each X^{b1} each independently represents a hydrolyzable group.

Each X^{b2} each independently represents a siloxane skeleton-containing group.

Each X^{b3} each independently represents a hydrocarbon chain-containing group.

m11 is an integer of 2 to 4,

each m12 and m13 each independently represent an integer of 0 to 2,

when M is a trivalent metal atom, m11+m12+m13 is 3, and when M is a tetravalent metal atom, m11+m12+m13 is 4.

In Formula (M2).

X^{b4} represents a hydrolyzable silane oligomer residue.

each X^{b5} each independently represents a hydrolyzable group or an alkyl group comprising 1 to 4 carbon atoms.

In Formula (M3),

each X^{b6} and X^{b7} each independently represent a hydrolyzable group or a hydroxyl group.

Y^{b1} represents a divalent organic group.

The metal represented by M in Formula (M1) includes semimetals such as Si and Ge. M is preferably a trivalent metal or a tetravalent metal, more preferably Al, Fe, In, Hf, Si, Ti, Sn, or Zr, still more preferably Al, Si, Ti, or Zr, and particularly preferably Si.

Examples of the hydrolyzable group represented by X^{b1} in Formula (M1) include hydrolyzable groups the same as those represented by L in [—Si(R²)ₙ L₃₋ₙ] in the above-described reactive silyl group.

The siloxane skeleton-containing group represented by X^{b2} has a siloxane unit (—Si—O—), and may be linear or branched. The siloxane unit is preferably a dialkylsilyloxy group, and examples include a dimethylsilyloxy group and a diethylsilyloxy group. The number of repetitions of the siloxane unit in the siloxane skeleton-containing group is 1 or more, preferably 1 to 5, more preferably 1 to 4, and still more preferably 1 to 3.

The siloxane skeleton-containing group may comprise a divalent hydrocarbon group in a part of the siloxane skeleton. Specifically, an oxygen atom in a part of the siloxane skeleton may be replaced with a divalent hydrocarbon group. Examples of the aforementioned divalent hydrocarbon group include alkylene groups such as a methylene group, an ethylene group, a propylene group, and a butylene group.

A hydrolyzable group, a hydrocarbon group (preferably an alkyl group), or the like may be bonded to a silicon atom at the end of the siloxane skeleton-containing group.

The number of atoms of the siloxane skeleton-containing group is preferably 100 or less, more preferably 50 or less, and still more preferably 30 or less.

The number of atoms is preferably 10 or more. The siloxane skeleton-containing group is preferably a group represented by *-(0-Si(CH₃)₂)~CH₃, where n is an integer of 1 to 5 and * indicates a part bonded to an adjacent atom.

The hydrocarbon chain-containing group represented by X^{b3} may be a group consisting solely of a hydrocarbon chain or a group having an etheric oxygen atom between carbon atoms of a hydrocarbon chain. The hydrocarbon chain may be linear or branched, and is preferably linear. The hydrocarbon chain may be a saturated hydrocarbon chain or an unsaturated hydrocarbon chain, and is preferably a saturated hydrocarbon chain. The number of carbon atoms of the hydrocarbon chain-containing group is preferably 1 to 3, more preferably 1 to 2, and still more preferably 1. The hydrocarbon chain-containing group is preferably an alkyl group, and more preferably a methyl group, an ethyl group, or a propyl group.

m1 is preferably 3 or 4.

The compound represented by Formula (M1) is preferably a compound represented by one of Formulas (M1-1) to (M1-5) where M is Si, and more preferably a compound represented by Formula (M1-1). The compound represented by Formula (M1-1) is preferably tetraethoxysilane, tetramethoxysilane, or triethoxymethylsilane.

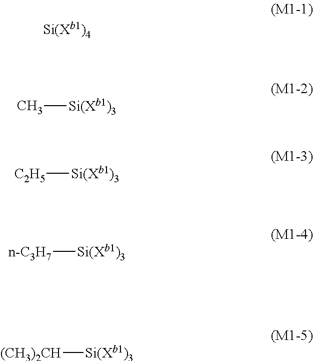

In Formula (M2), the number of silicon atoms contained in the hydrolyzable silane oligomer residue represented by X^{b4} is preferably 3 or more, more preferably 5 or more, and still more preferably 7 or more. The number of silicon atoms is preferably 15 or less, more preferably 13 or less, and still more preferably 10 or less.

The hydrolyzable silane oligomer residue may have an alkoxy group that is bonded to a silicon atom. Examples of the alkoxy group include a methoxy group, an ethoxy group, a propoxy group, a butoxy group, and the like. Further, the alkoxy group is preferably a methoxy group or an ethoxy group. The hydrolyzable silane oligomer residue may have one or two or more types of alkoxy groups, and preferably has one type of alkoxy group.

Examples of the hydrolyzable silane oligomer residue include (C₂H₅O)₃Si—(OSi(OC₂H₅)₂)₄O—*. Note that * indicates a part bonded to an adjacent atom.

Examples of the hydrolyzable group represented by X^{b}s in Formula (M2) include hydrolyzable groups the same as those represented by L in [—Si(R²)ₙ L₃₋ₙ] in the above-described reactive silyl group, a cyano group, a hydrogen atom, and an allyl group. Further, the hydrolyzable group is preferably an alkoxy group or an isocyanato group. The alkoxy group is preferably an alkoxy group comprising 1 to 4 carbon atoms.

X^{b5} is preferably a hydrolyzable group.

Examples of the compound represented by Formula (M2) include (H₅C₂O)₃—Si—(OSi(OC₂H₅)₂)₄OC₂H₅.

The compound represented by Formula (M3) is a compound having reactive silyl groups at both ends of a divalent organic group, i.e., is bissilane.

Examples of the hydrolyzable groups represented by X^{b6} and X^{b7} in Formula (M3) include an alkoxy group, an acyloxy group, a ketoxime group, an alkenyloxy group, an amino group, an aminoxy group, an amide group, an isocyanato group, and a halogen atom. Further, the hydrolyzable group is preferably an alkoxy group or an isocyanato group. The alkoxy group is preferably an alkoxy group comprising 1 to 4 carbon atoms, and more preferably a methoxy group or an ethoxy group.

In Formula (M3), X^{b6} and X^{b7} may be the same groups as each other or groups different from each other. In view of the availability, X^{b6} and X^{b7} are preferably the same groups as each other.

In Formula (M3), Y^{b1} is a divalent organic group connecting reactive silyl groups at both ends. The number of carbon atoms of Y^{b1} of the divalent organic group is preferably 1 to 8 and more preferably 1 to 3.

Examples of Y^{b1} include an alkylene group, a phenylene group, and an alkylene group having an etheric oxygen atom between carbon atoms. Examples include —CH₂CH₂—, —CH₂CH₂CH₂—, —CH₂CH₂CH₂CH₂—, —CH₂CH₂CH₂CH₂CH₂—, —CH₂CH₂CH₂CH₂CH₂CH₂—, —CH₂C(CH₃)₂CH₂—, —C(CH₃)₂CH₂CH₂C(CH₃)₂—, —CH₂CH₂OCH₂CH₂—, —CH₂CH₂CH₂OCH₂CH₂CH₂—, —CH(CH₃)CH₂OCH₂CH(CH₃)—, and —C₆H₄—.

Examples of the compound represented by Formula (M3) include

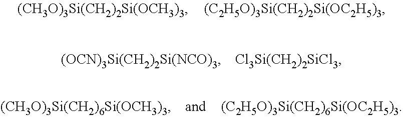

The contents of other components which may be contained in the composition according to the present disclosure are preferably 10 mass % or less and more preferably 1 mass % or less based on the total amount of the composition according to the present disclosure. When the composition according to the present disclosure comprises a specific metal compound(s), the content of the specific metal compound(s) is preferably 0.01 to 30 mass %, more preferably 0.01 to 10 mass %, and still more preferably 0.05 to 5 mass % based on the total amount of the composition according to the present disclosure.

The total content (hereinafter also referred to as “solid content concentration”) of the first and second compounds and the other components is preferably 0.001 to 40 wt. %, more preferably 0.01 to 20 wt. %, and still more preferably 0.1 to 10 wt. % based on the total amount of the composition according to the present disclosure. The solid content concentration of the composition according to the present disclosure is a value calculated from the mass of the composition before being heated and the mass thereof after being heated in a convection-type dryer at a temperature 50° C. more than the boiling point of the solvent contained in the composition for 4 hours.

### [Surface Treatment Agent]

A surface treatment agent according to the present disclosure is the composition described above. The surface treatment agent according to the present disclosure may comprise a liquid medium as required, and may also comprise components other than the first and second compound and the liquid medium.

Since the surface treatment agent according to the present disclosure comprises the first and second compounds, and satisfies at least one of the above-described Requirements (1) and (2), a surface-treated layer with excellent water repellency and excellent abrasion resistance can be formed.

### [Article]

In an embodiment, an article according to the present disclosure includes a substrate and a surface-treated layer which is disposed on the substrate and of which the surface is treated with a surface treatment agent according to the present disclosure.

The surface-treated layer may be formed on a part of the surface of the substrate or over the entire surface of the substrate. The surface-treated layer may be spread in the form of a film on the surface of the substrate or scattered in the form of dots.

In the surface-treated layer, the first and second compounds contained in the composition according to the present disclosure are contained therein in a state in which the hydrolysis of some or all of reactive silyl groups has progressed and the dehydration condensation reaction of silanol groups has progressed.

The thickness of the surface-treated layer is preferably 1 to 100 nm and more preferably 1 to 50 nm. When the thickness of the surface-treated layer is 1 nm or larger, the effects of the surface treatment are likely to be obtained satisfactorily. When the thickness of the surface-treated layer is 100 nm or less, the usage efficiency is high. The thickness of the surface-treated layer can be calculated from the oscillation cycle of the interference pattern of the reflected X-ray, which is obtained by an X-ray reflectivity method using an X-ray diffractometer for thin film analysis (Product name: ATX-G, manufactured by Rigaku Corporation).

The type of the substrate is not limited to any particular types, and examples include a substrate which is required to have water repellency. Examples of the substrate include a substrate which may be used while touching it with another article (e.g., a stylus) or a human hand or fingers; a substrate which may be held by a human hand or fingers during the operation; and a substrate which may be placed on another article (e.g., a mounting table).

Examples of the material of the substrate include metals, resins, glass, sapphire, ceramics, semiconductors, stones, fibers, nonwoven fabric, paper, wood, fur, natural leather, artificial leather, ceramics, and composite materials thereof. The glass may be one that is chemically reinforced.

Examples of substrates including building materials, decorative building materials, interior goods, transportation apparatuses (e.g., automobiles), signboards, bulletin boards, drinking containers, tableware, water tanks, ornamental apparatuses (e.g., frames and boxes), laboratory apparatuses, furniture, textile products, and packaging containers; glass or resins used for art, sports, games and the like; glass or resins used for exterior parts (excluding display parts) of apparatuses such as mobile phones (e.g., smartphones), mobile information terminals, game machines, and remote controllers. The shape of the substrate may be plate-like or film-like.

The substrate is preferably a substrate for a touch panel, a substrate for a display, or a lens for eyeglasses, and particularly preferably a substrate for a touch panel. The material of a substrate for a touch panel is preferably glass or a transparent resin.

The substrate may be a substrate of which a surface treatment such as a corona discharge treatment, a plasma treatment, a plasma graft polymerization treatment, or the like has been performed on one or both of the surfaces. The substrate subjected to the surface treatment has a more excellent adhesive property for the surface-treated layer, and the abrasion resistance of the surface-treated layer is further improved. Therefore, it is preferred to perform a surface treatment on the surface of the substrate on the side which is brought into contact with the surface-treated layer. Further, in the case where an underlayer (which will be described later) is provided, the substrate subjected to the surface treatment has a more excellent adhesive property for the underlayer, and the abrasion resistance of the surface-treated layer is further improved. Therefore, in the case where an underlayer is provided, it is preferred to perform a surface treatment on the surface of the substrate on the side which is brought into contact with the underlayer.

The surface-treated layer may be directly disposed on the surface of the substrate, or an underlayer may be provided between the substrate and the surface-treated layer. In order to further improve the water repellency and the abrasion resistance of the surface-treated layer, an article according to the present disclosure preferably includes a substrate, an underlayer disposed on the substrate, and a surface-treated layer which is disposed on the underlayer and of which the surface is treated with a surface treatment agent according to the present disclosure.

The underlayer is preferably a layer comprising an oxide comprising silicon and at least one specific element selected from the group consisting of Group 1 elements, Group 2 elements, Group 4 elements, Group 5 elements, Group 13 elements, and Group 15 elements in the periodic table.

Group 1 elements in the periodic table (hereinafter also referred to simply as “Group 1 elements”) mean lithium, sodium, potassium, rubidium, and cesium. Group 1 elements are preferably lithium, sodium, and potassium, and more preferably sodium and potassium because the surface-treated layer can be formed more uniformly on the underlayer without defects or because variations in the composition of the underlayer among samples are more suppressed. The underlayer may contain two or more Group 1 elements.

Group 2 elements in the periodic table (hereinafter also referred to simply as “Group 2 elements”) mean beryllium, magnesium, calcium, strontium, and barium. Group 2 elements are preferably magnesium, calcium, and barium, and more preferably magnesium and calcium because the surface-treated layer can be formed more uniformly on the underlayer without defects or because variations in the composition of the underlayer among samples are more suppressed. The underlayer may contain two or more Group 2 elements.

Group 4 elements in the periodic table (hereinafter also referred to simply as “Group 4 elements”) mean titanium, zirconium, and hafnium. Group 4 elements are preferably titanium and zirconium, and more preferably titanium because the surface-treated layer can be formed more uniformly on the underlayer without defects or because variations in the composition of the underlayer among samples are more suppressed. The underlayer may contain two or more Group 4 elements.

Group 5 elements in the periodic table (hereinafter also referred to simply as “Group 5 elements”) mean vanadium, niobium, and tantalum. Group 5 elements are particularly preferably vanadium because the abrasion resistance of the surface-treated layer becomes more excellent. The underlayer may contain two or more Group 5 elements.

Group 13 elements in the periodic table (hereinafter also referred to simply as “Group 13 elements”) mean boron, aluminum, gallium, and indium. Group 13 elements are preferably boron, aluminum, and gallium, and more preferably boron and aluminum because the surface-treated layer can be formed more uniformly on the underlayer without defects or because variations in the composition of the underlayer among samples are more suppressed. The underlayer may contain two or more Group 13 elements.

Group 15 elements in the periodic table (hereinafter also referred to simply as “Group 15 elements”) mean nitrogen, phosphorus, arsenic, antimony, and bismuth. Group 15 elements are preferably phosphorus, antimony, and bismuth, and more preferably phosphorus and bismuth because the surface-treated layer can be formed more uniformly on the underlayer without defects or because variations in the composition of the underlayer among samples are more suppressed. The underlayer may contain two or more Group 15 elements.

The specific element contained in the underlayer is preferably a Group 1 element, a Group 2 element, and a Group 13 element, more preferably a Group 1 element and a Group 2 element, and still more preferably a Group 1 element because the abrasion resistance of the surface-treated layer becomes more excellent.

Only one element or two or more elements may be contained as the specific element(s).

The oxide contained in the underlayer may be a mixture of oxides each comprising only one of the aforementioned elements (silicon and specific element) (e.g., a mixture of silicon oxide and an oxide of a specific element), a composite oxide comprising two or more of the aforementioned elements, or a mixture of an oxide comprising only one of the aforementioned elements and a composite oxide.

The ratio of the total molarity of the specific element in the underlayer to the molarity of silicon in the underlayer (specific element/silicon) is preferably 0.02 to 2.90, more preferably 0.10 to 2.00, and still more preferably 0.20 to 1.80 because the abrasion resistance of the surface-treated layer becomes more excellent.

The molarity (mol %) of each element in the underlayer can be measured, for example, by a depth-direction analysis by X-ray photoelectron spectroscopy (XPS) using ion sputtering.

The underlayer may be a single layer or may consist of a plurality of layer. The underlayer may have an uneven surface(s).

The thickness of the underlayer is preferably 1 to 100 nm, more preferably 1 to 50 nm, and still more preferably 2 to 20 nm. When the thickness of the underlayer is equal to or larger than the aforementioned lower limit value, the adhesive property of the surface-treated layer by the underlayer is further improved, so that the abrasion resistance of the surface-treated layer becomes more excellent. When the thickness of the underlayer is equal to or less than the aforementioned upper limit value, the abrasion resistance of the underlayer itself becomes excellent.

The thickness of the underlayer is measured by observing the cross section of the underlayer by a transmission electron microscope (TEM).

The underlayer can be formed, for example, by a vapor-deposition method using a vapor-deposition material or a wet coating method.

The vapor-deposition material used in the vapor-deposition method preferably contains silicon and an oxide comprising a specific element.

Specific examples of the form of the vapor-deposition material include a powder, a molten material, a sintered compact, granules, and a crushed material. Further, a molten material, a sintered compact, and granules are preferred in view of the handling property.

Note that the molten material refer to a solid material obtained by melting a powder of a vapor-deposition material at a high temperature, and then cooling and solidifying the molten vapor-deposition material. The sintered compact refer to a solid material obtained by firing a powder of a vapor-deposition material. Further, if necessary, instead of the powder of the vapor-deposition material, a molded compact formed by pressing the powder may be used. The granules mean a solid material obtained by mixing and kneading a powder of a vapor-deposition material and a liquid medium (e.g., water or an organic solvent) and thereby obtaining particles thereof, and then drying the obtained particles.

The vapor-deposition material can be manufactured, for example, by the following methods.
A method in which a powder of a vapor-deposition material is obtained by mixing a powder of silicon oxide with a powder of an oxide of a specific element.
A method in which granules of a vapor-deposition material is obtained by, after obtaining particles by mixing and kneading a powder of the aforementioned vapor-deposition material and water, drying the obtained particles.
A method in which a sintered compact is obtained by drying a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water, and then firing the dried mixture or a molded article obtained by press-molding the dried mixture.
A method in which a molten material is obtained by melting a mixture obtained by mixing a powder comprising silicon (e.g., a powder made of silicon oxide, silica sand, or silica gel), a powder comprising a specific element (e.g., a powder of an oxide of a specific element, a carbonate, a sulfate, a nitrate, an oxalate, or a hydroxide), and water at a high temperature, and then cooling and solidifying the molten substance.

Specific examples of the vapor-deposition method using a vapor-deposition material include a vacuum vapor-deposition method. The vacuum vapor-deposition method is a method in which a vapor-deposition material is evaporated in a vacuum chamber and deposited on the surface of a substrate.

The temperature during the vapor-deposition (e.g., in the case where a vacuum deposition apparatus is used, the temperature of a boat in which the deposition material is disposed) is preferably 100 to 3,000° C. and more preferably 500 to 3,000° C.

The pressure during the vapor-deposition (e.g., in the case where a vacuum deposition apparatus is used, the pressure in a chamber in which the deposition material is disposed) is preferably 1 Pa or lower and more preferably 0.1 Pa or lower.

When an underlayer is formed by using a vapor-deposition material, one vapor-deposition material may be used, or two or more vapor-deposition materials comprising different elements may be used.

Specific examples of the method for evaporating a vapor-deposition material include a resistive heating method in which a vapor-deposition material is melted and evaporated on a resistive heating boat made of a high melting-point metal, and an electron gun method in which a vapor-deposition material is irradiated with an electron beam and thereby directly heated, so that its surface is melted and evaporated. As the method for evaporating a vapor-deposition material, the electron gun method is preferred because since the material can be locally heated, even a material having a high melting point can be evaporated, and since an area that is not irradiated with the electron beam is kept at a low temperature, there is no risk of reaction with the container nor risk of contamination by impurities.

As the method for evaporating a vapor-deposition material, a plurality of boats may be used, or the whole vapor-deposition materials may be put in a single boat. The vapor-deposition method may be co-vapor deposition or alternating vapor deposition. Specific examples include an example in which silica and a specific source are mixed and used in the same boat, an example in which co-vapor deposition is performed in a state in which silica and a specific element source put in separate boats, and an example in which alternating vapor deposition is performed in a similar manner, i.e., in a state in which silica and a specific element source are put in separate boats. The conditions for the vapor deposition, the order, and the like are selected as appropriate according to the structure of the underlayer.

In the wet coating method, it is preferred to form an underlayer on a substrate by a wet coating method using a coating liquid comprising a compound comprising silicon, a compound comprising a specific element, and a liquid medium.

Specific examples of silicon compounds include silicon oxide, silicic acid, partial condensate of silicic acid, alkoxysilane, and partial hydrolysis condensate of alkoxysilane.

Specific examples of compounds comprising a specific element include oxides of the specific element, alkoxides of the specific element, carbonates of the specific element, sulfates of the specific element, nitrates of the specific element, oxalates of the specific element, and hydroxides of the specific element.

Examples of liquid mediums include those the same as liquid mediums which may be contained in the composition according to the present disclosure.

The content of the liquid medium is preferably 80 to 99.99 mass % and more preferably 90 to 99.9 mass % based on the total amount of the coating liquid used for the formation of the underlayer.

Specific examples of the wet coating method for forming an underlayer include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

After the substrate or the like is wet-coated with the coating liquid, the coating is preferably dried. The drying temperature of the coating is preferably 20 to 200° C. and more preferably 80 to 160° C.

The article according to the present disclosure may be an optical material including a surface-treated layer as the outermost layer.

Examples of preferred optical materials include a wide variety of optical materials in addition to optical materials related to displays or the like.

Examples of optical materials include a cathode ray tube (CRT; e.g., a computer monitor), a display such as a liquid crystal display, a plasma display, an organic EL display, an inorganic thin film EL dot matrix display, a rear projection-type display, a vacuum fluorescent display (VFD), and a field emission display (FED), a protective plate for such a display, and those in which an antireflection film treatment is performed on their surfaces.

The article according to the present disclosure is preferably an optical member. Examples of optical members include a car navigation system, a mobile phone, a smartphone, a digital camera, a digital video camera, a PDA, a portable audio player, a car audio system, a game apparatus, a lens for eyeglasses, a camera lens, a lens filter, sunglasses, a medical apparatus such as a gastroscope, a copying machine, a PC, a display (e.g., a liquid crystal display, an organic EL display, a plasma display, and a touch panel display), a touch panel, a protective film, and an antireflection film.

Further, examples of optical members include a front protective plate for a display such as a PDP and an LCD, an antireflection plate, a polarizing plate, and an antiglare plate; a disk surface of an optical disk such as a Blu-ray (Blu-ray (Registered Trademark)) disk, a DVD disk, a CD-R, and an MO; an optical fiber; and a display surface of a clock or a watch.

In particular, the article according to the present disclosure is preferably a display or a touch panel.

The article according to the present disclosure may be a medical apparatus or a medical material. Further, the article according to the present disclosure may also be an automobile interior or exterior member. Examples of exterior members include a window, a light cover, and an external camera cover. Examples of interior members include an instrument panel cover, a navigation system touch panel, and a decorative interior member.

When the article according to the present disclosure is an optical member, the material constituting the surface of the substrate is a member for an optical member, e.g., glass or transparent plastic. Further, when the article according to the present disclosure is an optical member, a functional layer such as a hard coat layer or an antireflection layer may be formed on the surface (outermost layer) of the substrate. The antireflection layer may be either a single-layer antireflection layer or a multi-layer antireflection layer. Examples of inorganic substances that can be used for the antireflection layer include SiO₂, SiO, ZrO₂, TiO₂, TiO, Ti₂O₃, Ti₂O₅, Al₂O₃, Ta₂O₅, Ta₃O₅, Nb₂O₅, HfO₂, Si₃N₄, CeO₂, MgO, Y₂O₃, SnO₂, MgF₂, and WO₃. These inorganic substances may be used alone or in combination (e.g., as a mixture) of two or more of them. In the case of the multi-layer antireflection layer, it is preferred to use SiO₂ and/or SiO in the outermost layer. When the article according to the present disclosure is an optical glass component for a touch panel, a thin film using a transparent electrode, e.g., indium tin oxide (ITO), indium zinc oxide, or the like, may be provided on a part of the surface of the substrate (glass). Further, the substrate may also include an insulating layer, an adhesive layer, a protective layer, a decorative frame layer (I—CON), an atomization film layer, a hard coating film layer, a polarizing film, a phase difference film, a liquid crystal display module, or the like according to its specific specifications.

### [Method for Manufacturing Article]

A method for manufacturing an article according to the present disclosure is, for example, a method for manufacturing an article including a surface-treated layer formed on a substrate by performing a surface treatment on the substrate by using a surface treatment agent according to the present disclosure. Examples of surface treatments include a dry coating method and a wet coating method.

Examples of dry coating methods include techniques such as vacuum vapor deposition, CVD, and sputtering. As the dry coating method, a vacuum vapor-deposition method is preferred in order to suppress the decomposition of the compound and in view of the simplicity of the apparatus. During the vacuum deposition, a pellet-like substance obtained by impregnating a porous material made of a metal such as iron or steel with a compound according to the present disclosure may be used. A pellet-like substance, which is obtained by impregnating a porous material made of a metal such as iron or steel with a composition comprising a compound according to the present disclosure and a liquid medium, and drying the liquid medium, may be used.

Examples of wet coating methods include a spin coating method, a wipe coating method, a spray coating method, a squeegee coating method, a dip coating method, a die coating method, an ink jet method, a flow coating method, a roll coating method, a casting method, a Langmuir-Blodgett method, and a gravure coating method.

In order to improve the abrasion resistance of the surface-treated layer, when necessary, an operation for accelerating the reaction between the compound according to the present disclosure and the substrate may be performed.

Examples of such operations include heating, humidification, and irradiation with light. For example, it is possible to accelerate, by heating a substrate on which a surface-treated layer is formed in an atmosphere comprising moisture, the reaction such as a hydrolysis reaction of a hydrolyzable group, a reaction between a hydroxyl group or the like and a silanol group on the surface of the substrate, and formation of a siloxane bond by a condensation reaction of a silanol group.

After the surface treatment, compounds which are contained in the surface-treated layer and are not chemically bonded to other compounds nor the substrate may be removed as required. Examples of removal methods include a method in which a solvent is poured over the surface-treated layer, and a method in which the surface-treated layer or the like is wiped with a cloth impregnated with a solvent.

### EXAMPLES

The present disclosure will be described hereinafter in a more detailed manner by using examples, but the present disclosure is not limited to these examples. Examples 1 to 4 and 8 to 13 are examples according to the present disclosure, and Examples 5 to 7 are comparative examples.

### <Synthesis of First Compound (Compound X1)>

### [Synthesis of Compound 11]

Tetrahydrofuran (THF) (101 g) was added to hexamethylcyclotrisiloxane (65 g), and the mixture was stirred at 25° C. until THF was dissolved. Next, a solution in which a lithium salt of trimethylsilanol (5.1 g) was suspended in THF (20 g) was added, and the mixture was stirred at 25° C. for 2 hours. Next, chlorodimethylsilane (10.5 g) was added, and the mixture was stirred at 25° C. for 1 hour. Extraction was performed by adding hexane and water. Then, 25 g of a compound 11 was obtained by removing the solvent and volatiles by distillation under a reduced pressure, and performing flash column chromatography (developing solvent: hexane/dichloromethane) using silica gel. The average value of n10 in the compound 11 was 13. The structure of the compound 11 was confirmed from NMR data shown below.

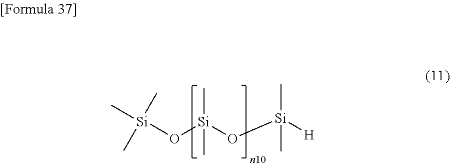

¹H-NMR (400 MHz, CDCl₃) δ 4.63 (hept, J=2.8 Hz, 1H), 0.21-0.08 (m, 6H), 0.07-−0.12 (m, 87H).

### [Synthesis of Compound 12]

Dichloromethane (20 g) and 18-bromo-1-octadecene (1.0 g) were added to the compound 11 (2.0 g), and the mixture was stirred at 25° C. until it became homogeneous. Next, a toluene solution of platinum/1,3-divinyl-1,1,3,3-tetramethyldisiloxane complex (platinum content: 3 mass %, 4.1 mg) was added, and the mixture was stirred at 25° C. for 2 hours. 1.2 g of a compound 12 was obtained by removing volatiles by distillation under a reduced pressure, and then performing flash column chromatography (developing solvent: hexane/dichloromethane) using silica gel. The average value of n10 in the compound 12 was 13. The structure of the compound 12 was confirmed from NMR data shown below.

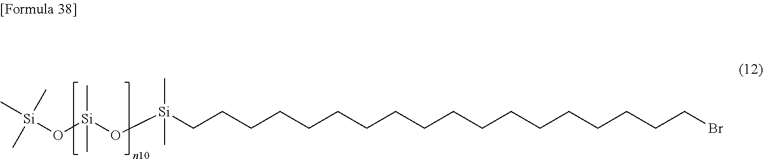

¹H-NMR (400 MHz, CDCl₃) δ 3.41 (t, J=6.9 Hz, 2H), 1.85 (p, J=7.1 Hz, 2H), 1.75-0.95 (m, 30H), 0.53 (s, 2H), 0.34-−0.25 (m, 93H).

### [Synthesis of Compound 13]

THF (20 g), a THF solution of allylmagnesium chloride (2.0M) (20 mL), and copper(II) chloride (0.02 g) were added to the compound 12 (1.2 g), and the mixture was stirred at 50° C. for 2 hours. Extraction was performed by adding hydrochloric acid and hexane, and volatiles were removed by distillation under a reduced pressure. Then, 1.1 g of a compound 13 was obtained by performing flash column chromatography (developing solvent: hexane/dichloromethane) using silica gel. The average value of n10 in the compound 13 was 13. The structure of the compound 13 was confirmed from NMR data shown below.

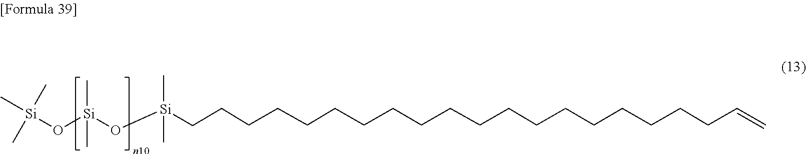

¹H-NMR (400 MHz, CDCl₃) δ 5.74 (ddt, J=16.9, 10.2, 6.7 Hz, 1H), 5.01-4.74 (m, 2H), 2.08-1.84 (m, 2H), 1.75-0.95 (m, 34H), 0.45 (dd, J=9.4, 5.7 Hz, 2H), 0.34-0.25 (m, 93H).

### [Synthesis of Compound X1]

Dichloromethane (10 g) was added to and dissolved in the compound 13 (1.1 g). Next, a toluene solution of platinum/1,3-divinyl-1,1,3,3-tetramethyldisiloxane complex (platinum content: 3 mass %, 4.1 mg), aniline (2.6 mg), and trimethoxysilane (0.60 g) were added, and the mixture was stirred at 50° C. for 2 hours. 1.1 g of a compound X1 was obtained by removing the solvent by distillation under a reduced pressure. The average value of n10 in the compound X1 was 13. The structure of the compound X1 was confirmed from NMR data shown below.

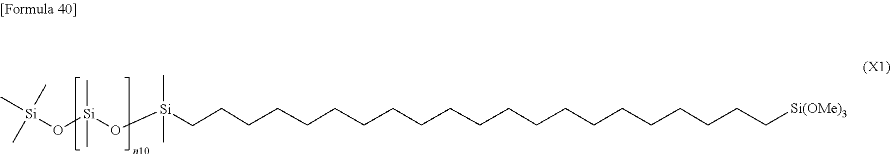

¹H-NMR (400 MHz, CDCl₃) δ 3.50 (s, 9H), 1.75-0.95 (m, 38H), 0.62-0.54 (m, 2H), 0.45 (dd, J=9.4, 5.9 Hz, 2H), 0.34-−0.25 (m, 93H).

### <Synthesis of First Compound (Compound X2)>

### [Synthesis of Compound 21]

Dichloromethane (100 g) and trichloroisocyanuric acid (14 g) were added to 1,1,1,3,5,5,5-heptamethyltrisiloxane (10 g), and the mixture was stirred at 25° C. for 3 hours. Next, insoluble substances were removed by filtering the reaction solution, and then volatiles were removed by distilling the filtrate. Water (20 g), THF (40 g), and triethylamine (10 g) were added to the obtained crude solution, and the mixture was stirred at 25° C. for 2 hours. Extraction was performed by adding hexane and water, and volatiles were removed by distillation under a reduced pressure. 8.3 g of a compound 21 was obtained by performing, for the obtained crude solution, flash column chromatography (developing solvent: hexane/ethyl acetate) using silica gel. The structure of the compound 21 was confirmed from NMR data shown below.

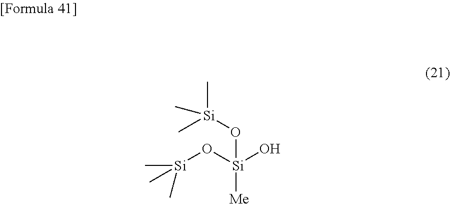

¹H-NMR (400 MHz, CDCl₃) δ 2.41 (q, J=7.2 Hz, 1H), 0.20-−0.21 (m, 21H).

### [Synthesis of Compound 22]

THF (20 g) was added to the compound 21 (2.0 g), and after cooling the mixture to 0° C., a diethoxymethane solution of methyllithium (3.1M) (2.7 mL) was added, and the mixture was stirred for 10 minutes. Next, a solution obtained by dissolving hexamethylcyclotrisiloxane (5.6 g) in THF (20 g) was added, and the mixture was stirred at 25° C. for 4 hours. Next, chlorodimethylsilane (2.0 g) was added, and the mixture was stirred at 25° C. for 1 hour. After performing extraction by adding hexane and water, volatiles were removed by distillation under a reduced pressure. 4.3 g of a compound 22 was obtained by performing, for the obtained crude solution, flash column chromatography (developing solvent: hexane/dichloromethane) using silica gel. The average value of n10 in the compound 22 was 9. The structure of the compound 22 was confirmed from NMR data shown below.

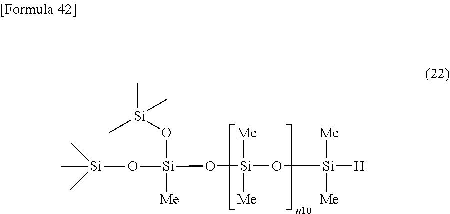

¹H-NMR (400 MHz, CDCl₃) δ 4.63 (p, J=2.8 Hz, 1H), 0.11 (d, J=2.8 Hz, 6H), 0.09-−0.12 (m, 75H).

### [Synthesis of Compound 23]

Dichloromethane (20 g) and 18-bromo-1-octadecene (0.75 g) were added to the compound 22 (2.3 g), and the mixture was stirred until it became homogeneous. Next, a toluene solution of platinum/1,3-divinyl-1,1,3,3-tetramethyldisiloxane complex (platinum content: 3 mass %, 4.1 mg) was added, and the mixture was stirred at 25° C. for 2 hours. 1.8 g of a compound 23 was obtained by removing volatiles by distillation under a reduced pressure, and then performing flash column chromatography (developing solvent: hexane/dichloromethane) using silica gel. The average value of n10 in the compound 23 was 9. The structure of the compound 23 was confirmed from NMR data shown below.

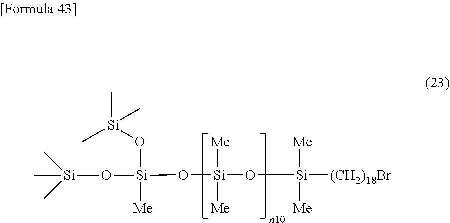

¹H-NMR (400 MHz, CDCl₃) δ 3.33 (t, J=6.9 Hz, 2H), 1.78 (dt, J=14.5, 7.0 Hz, 2H), 1.42-1.08 (m, 30H), 0.45 (t, J=7.7 Hz, 2H), 0.09-−0.12 (m, 81H).

### [Synthesis of Compound 24]

THF (20 g), a THF solution of allylmagnesium chloride (2.0M) (20 mL), and copper(II) chloride (0.02 g) were added to the compound 23 (1.8 g), and the mixture was stirred at 50° C. for 2 hours. Extraction was performed by adding hydrochloric acid and hexane, and volatiles were removed by distillation under a reduced pressure. 1.5 g of a compound 24 was obtained by performing, for the obtained crude solution, flash column chromatography (developing solvent: hexane/dichloromethane) using silica gel. The average value of n10 in the compound 24 was 9. The structure of the compound 24 was confirmed from NMR data shown below.

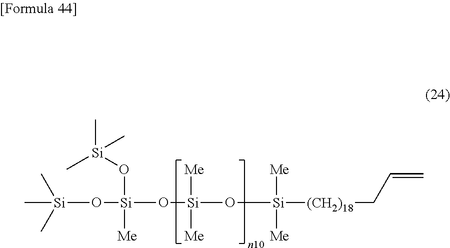

¹H-NMR (400 MHz, CDCl₃) δ 5.74 (ddt, J=17.0, 10.2, 6.7 Hz, 1H), 5.01-4.76 (m, 2H), 2.07-1.87 (m, 2H), 1.41-0.97 (m, 34H), 0.45 (dd, J=9.5, 5.9 Hz, 2H), 0.09-−0.12 (m, 81H).

### [Synthesis of Compound X2]

Dichloromethane (10 g) was added to and dissolved in the compound 24 (1.5 g). Next, a toluene solution of platinum/1,3-divinyl-1,1,3,3-tetramethyldisiloxane complex (platinum content: 3 mass %, 4.1 mg), aniline (2.6 mg), and trimethoxysilane (0.60 g) were added, and the mixture was stirred at 50° C. for 2 hours. 1.6 g of a compound X2 was obtained by removing the solvent by distillation under a reduced pressure. The average value of n10 in the compound X2 was 9. The structure of the compound X2 was confirmed from NMR data shown below.

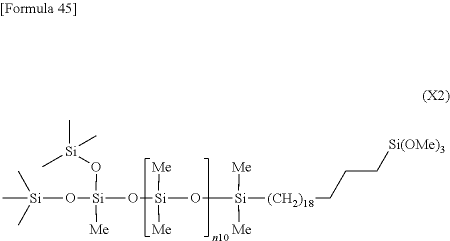

¹H-NMR (400 MHz, CDCl₃) δ 3.49 (s, 9H), 1.81-0.97 (m, 38H), 0.65-0.51 (m, 2H), 0.45 (dd, J=9.8, 5.3 Hz, 2H), 0.09-−0.12 (m, 81H).

### <Preparation of Second Compound (Compound Y1)>

Octadecyltrimethoxysilane (CH₃(CH₂)₁₇—Si(OCH₃)₃ manufactured by Tokyo Chemical Industry Co., Ltd.) was prepared as a compound Y1.

### <Synthesis of Second Compound (Compound Y2)>

### [Synthesis of Compound 31]

THF (10 g) and copper(II) chloride (0.05 g) were added to 18-bromo-1-octadecene (1.0 g), and the mixture was stirred at 25° C. Then, a diethyl-ether solution of trimethylsilylmethylmagnesium chloride (1.0M) (10 mL) was added, and the mixture was stirred at 60° C. for 24 hours. Extraction was performed by adding hydrochloric acid and hexane, and volatiles were removed by distillation under a reduced pressure. Then, 0.5 g of a compound 31 was obtained by performing flash column chromatography (developing solvent: hexane/dichloromethane) using silica gel. The structure of the compound 31 was confirmed from NMR data shown below.

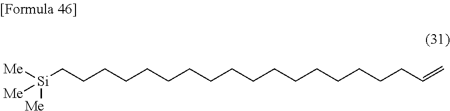 [SMILES: C=CCCCCCCCCCCCCCCCCC[Si](C)(C)C]

¹H-NMR (400 MHz, CDCl₃) δ 5.82 (ddt, J=17.0, 10.2, 6.7 Hz, 1H), 5.19-4.75 (m, 2H), 2.04 (dt, J=8.0, 6.7 Hz, 2H), 1.53-1.10 (m, 30H), 0.60-0.27 (m, 2H), −0.03 (s, 9H).

### [Synthesis of Compound Y2]

Dichloromethane (10 g) was added to and dissolved in the compound 31 (0.5 g). Then, a toluene solution of platinum/1,3-divinyl-1,1,3,3-tetramethyldisiloxane complex (platinum content: 3 mass %, 5 mg), aniline (3 mg), and trimethoxysilane (0.60 g) were added, and the mixture was stirred at 50° C. for 2 hours. 0.7 g of a compound Y2 was obtained by removing the solvent by distillation under a reduced pressure. The structure of the compound Y2 was confirmed from NMR data shown below.

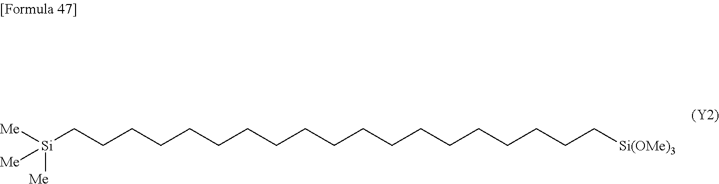

¹H-NMR (400 MHz, CDCl₃) δ 3.57 (s, 9H), 1.53-1.05 (m, 34H), 0.74-0.59 (m, 2H), 0.47 (t, J=7.3 Hz, 2H), −0.03 (s, 9H).

### <Synthesis of Second Compound (Compound Y3)>

### [Synthesis of Compound 41]

THF (10 g), a toluene solution of platinum/1,3-divinyl-1,1,3,3-tetramethyldisiloxane complex (platinum content: 3 mass %, 5 mg), and chlorodimethylsilane (10 g) were added to 18-bromo-1-octadecene (10 g), and the mixture was stirred at 25° C. for 24 hours. 12 g of a compound 41 was obtained by removing volatiles by distillation under a reduced pressure. The structure of the compound 41 was confirmed from NMR data shown below.

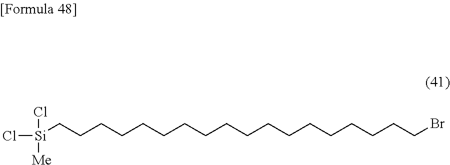 [SMILES: C[Si](Cl)(Cl)CCCCCCCCCCCCCCCCCCBr]

¹H-NMR (400 MHz, CDCl₃) δ 3.40 (t, J=6.9 Hz, 2H), 1.92-1.74 (m, 2H), 1.46-1.06 (m, 30H), 0.88-0.71 (m, 2H), 0.40 (s, 6H).

### [Synthesis of Compound 42]

THF (10 g) and a THF solution of methylmagnesium chloride (1.0M) (40 mL) were added to the compound 41 (12 g), and the mixture was stirred at 25° C. for 1 hour. Extraction was performed by adding hydrochloric acid and hexane, and volatiles were removed by distillation under a reduced pressure. Then, 8 g of a compound 42 was obtained by performing flash column chromatography (developing solvent: hexane/dichloromethane) using silica gel. The structure of the compound 42 was confirmed from NMR data shown below.

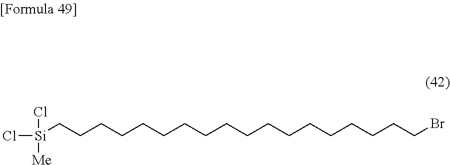 [SMILES: C[Si](Cl)(Cl)CCCCCCCCCCCCCCCCCCBr]

¹H-NMR (400 MHz, CDCl₃) δ 3.41 (t, J=6.9 Hz, 2H), 1.85 (p, J=7.0 Hz, 2H), 1.46-1.06 (m, 30H), 0.47 (t, J=7.6 Hz, 2H), −0.03 (s, 9H).

### [Synthesis of Compound 43]

THF (20 g) and magnesium (1.1 g) were added to 11-bromo-1-undecene (10 g), and the mixture was stirred at 60° C. for 2 hours. 30 g of a compound 43 was obtained by filtrating the reaction solution. It was confirmed that the concentration of the product was 0.8 M by titration using 1,10-phenanthroline.

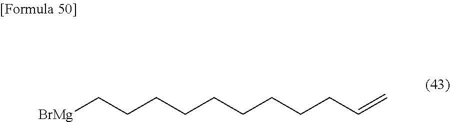

### [Synthesis of Compound 44]

THF (10 g), the compound 43 (0.8M) (10 mL), and copper(II) chloride (0.05 g) were added to the compound 42 (1 g), and the mixture was stirred at 60° C. for 24 hours. Extraction was performed by adding hydrochloric acid and hexane, and volatiles were removed by distillation under a reduced pressure. Then, 0.4 g of a compound 44 was obtained by performing flash column chromatography (developing solvent: hexane/dichloromethane) using 10% silver nitrate silica gel. The structure of the compound 44 was confirmed from NMR data shown below.

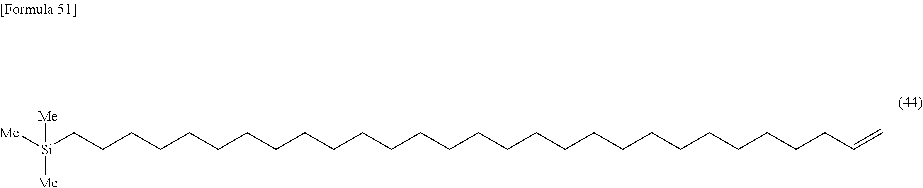 [SMILES: C=CCCCCCCCCCCCCCCCCCCCCCCCCCCC[Si](C)(C)C]

¹H-NMR (400 MHz, CDCl₃) δ 5.82 (ddt, J=16.9, 10.2, 6.7 Hz, 1H), 5.09-4.78 (m, 2H), 2.04 (q, J=7.1 Hz, 2H), 1.46-1.06 (m, 50H), 0.47 (t, J=7.7 Hz, 2H), −0.03 (s, 9H).

### [Synthesis of Compound Y3]

Dichloromethane (10 g) was added to and dissolved in the compound 44 (0.4 g). Next, a toluene solution of platinum/1,3-divinyl-1,1,3,3-tetramethyldisiloxane complex (platinum content: 3 mass %, 5 mg), aniline (3 mg), and trimethoxysilane (0.60 g) were added, and the mixture was stirred at 50° C. for 2 hours. 0.5 g of a compound Y3 was obtained by removing the solvent by distillation under a reduced pressure. The structure of the compound Y3 was confirmed from NMR data shown below.

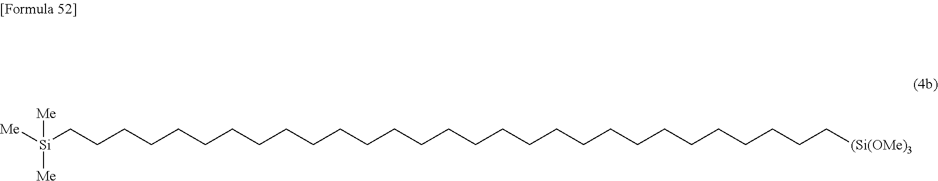

¹H-NMR (400 MHz, CDCl₃) δ 3.57 (s, 9H), 1.46-1.06 (m, 54H), 0.72-0.59 (m, 2H), 0.48 (d, J=8.0 Hz, 2H), −0.03 (s, 9H).

### [Preparation of Surface Treatment Agent]

A surface treatment agent having a solid content of 20 mass % was obtained by mixing a first compound and a second compound shown in Table 1 at a mass ratio shown in Table 1, and further adding heptane as a liquid medium.

A surface treatment was performed on a substrate by using the surface treatment agent. A dry-coating method was used as a surface treatment method.

A chemically reinforced glass was used as the substrate.

30 g of silicon oxide was disposed as a vapor-deposition source on a copper hearth in a vacuum vapor-deposition apparatus (“VTR-350M” manufactured by ULVAC KIKKO Inc.). A glass substrate was disposed in the vacuum vapor-deposition apparatus, and the vacuum vapor-deposition apparatus was evacuated of air so that the pressure inside the apparatus became 5×10⁻³ Pa or lower. A substrate including a silicon oxide layer having a thickness of about 20 nm was manufactured by heating the aforementioned hearth to about 2,000° C. and thereby vacuum-depositing silicon oxide on the surface of the substrate.

For each of the surface treatment agent, 0.5 g of the surface treatment agent was charged into a boat made of molybdenum in the vacuum vapor-deposition apparatus, and the vacuum vapor-deposition apparatus was evacuated of air so that the pressure inside the apparatus became 1×10⁻³ Pa or lower. The boat, in which the surface treatment agent was disposed, was heated at a temperature rising rate of 10° C./min or lower. Then, at the moment when the vapor-vapor-deposition rate measured by a quartz oscillation-type film thickness gauge exceeded 1 nm/sec, the shutter was opened and film formation (i.e., the vapor-deposition of the surface treatment agent) on the surface of the substrate was thereby started.

When the film thickness became about 50 nm, the shutter was closed and the film formation on the surface of the substrate including silicon oxide layer was thereby finished. By heat-treating the substrate, on which the compound or the composition had been deposited, at 140° C. for 30 min and washing it with ethanol, an article including a surface-treated layer on the surface of the substrate was obtained.

The article obtained by the dry-coating method was evaluated for water repellency, abrasion resistance, and fingerprint removal property. The evaluation method is described below.

### <Water Repellency>

About 2 μL of distilled water was added dropwise on the surface-treated layer of the article, and the initial water contact angle was measured by using a contact angle measuring apparatus (product name: DM-500 manufactured by Kyowa Interface Science Co., Ltd). An average value of values measured at five points on the surface-treated layer was defined as the water contact angle. Note that a 2θ method was used for the calculation of the water contact angle. The evaluation criteria are as follows. AA, A, and B are practically acceptable levels.

AA: The initial water contact angle is 105° or larger.

A: The initial water contact angle is 100° or larger and less than 1050.

B: The initial water contact angle is 95° or larger and less than 1000.

C: The initial water contact angle is less than 95°.

### <Abrasion Resistance 1>

For the surface-treated layer of the article, the water contact angle after the friction test was measured according to JIS L0849:2013 (corresponding ISO: 105-X12:2001) by using a reciprocating traverse tester (manufactured by K.N.T.). In particular, the water contact angle after the friction test was measured every time a steel wool bonster (#0000) was reciprocated 100 times at a pressure of 98.07 kPa and at a speed of 320 cm/min. The method for measuring the water contact angle after the friction test was the same as that for the initial water contact angle in the above-described method for evaluating liquid repellency. Firstly, when the value of the obtained water contact angle was less than 90° after the steel wool was reciprocated 100 times, the friction test was terminated and the number of times of rubbing at the end of the test was recorded. When the value of the obtained water contact angle was 90° or larger, the friction test was continued. The above-described operation was repeated, and the maximum number of times of rubbing was set to 10,000. The evaluation criteria were as follows. A and B are practically acceptable levels.

A: The number of times of rubbing is 2,000 or more.

B: The number of times of rubbing is 1,000 or more and less than 2,000.

C: The number of times of rubbing is less than 1,000.

### <Abrasion Resistance 2>

For the surface-treated layer of the article, the water contact angle after the friction test was measured according to JIS L0849:2013 (corresponding ISO: 105-X12:2001) by using a reciprocating traverse tester (manufactured by K.N.T.). In particular, the water contact angle after the friction test was measured every time a steel wool bonster (#0000) was reciprocated 100 times at a pressure of 98.07 kPa and at a speed of 320 cm/min. The method for measurement of the water contact angle after the friction test was the same as that for the initial water contact angle in the above-described method for evaluating the liquid repellency. Firstly, when the value of the obtained water contact angle was less than 100° after the steel wool was reciprocated 100 times, the friction test was terminated and the number of times of rubbing at the end of the test was recorded. When the value of the obtained water contact angle was 100° or larger, the friction test was continued. The above-described operation was repeated, and the maximum number of times of rubbing was set to 10,000. The evaluation criteria are as follows. AA, A, and B are practically acceptable levels.

A: The number of times of rubbing is 400 or more.

B: The number of times of rubbing is 200 or more and less than 400.

C: The number of times of rubbing is less than 200.

### <Fingerprint Removal Property>

A weight of 1 kg equipped with a red rubber stopper having a diameter of 2 cm, which served as a fingerprint stamp part, was prepared. Next, 70 μL of an artificial fingerprint liquid (manufactured by ISEKYU) was added dropwise onto a waste cloth, and the fingerprint stamp was made to adhere to the artificial fingerprint liquid for 1 minute. The fingerprint stamp was made to adhere to a new waste cloth for 20 seconds in order to remove an excessive artificial fingerprint liquid that had adhered to the fingerprint stamp. After that, an article in which a surface-treated layer was formed was placed on a hot plate of which the temperature was adjusted to 23° C. The fingerprint stamp was stamped on the surface-treated layer.

The article to which the artificial fingerprint liquid adhered was placed on a sliding apparatus (product name “HHS-2000” manufactured by Shinto Scientific Co., Ltd.). A wiping cloth (Savina Minimax manufactured by KB Seiren Ltd.) was attached to a planar indenter having an area of 1 cm square with double-sided tape, and the wiping cloth with the indenter was set on the sliding apparatus. The artificial fingerprint liquid adhered to the surface-treated layer was wiped off by moving the wiping cloth thereon in one direction with a load of 100 g. The haze of the wiped area was measured with a haze meter (product name “NDH7000SP” manufactured by Denshoku Industries Co., Ltd.). The evaluation criteria are as follows.

A: The haze value is lower than 1%.

B: The haze value is 1% or more and lower than 5%.

C: The haze value is 5% or more.

The evaluation results are shown in Table 1.

In Table 1, each of Y in Requirements (1) and (2) refer to that Requirements (1) and (2) are both satisfied. Further, “-” refer to that the first compound or the second compound is not contained. Further, “-” in Abrasion Resistance 2 indicates that the test was not carried out.

TABLE 1

| | | | | | Ratio of second |
|---|---|---|---|---|---|
| | First | Requirement | Second | Requirement | compound to first |
| | compound | (1) | compound | (2) | compound |
| Example 1 | X1 | Y | Y1 | Y | 0.1 |
| Example 2 | X2 | Y | Y1 | Y | 0.1 |
| Example 3 | X1 | Y | Y1 | Y | 0.6 |
| Example 4 | X2 | Y | Y1 | Y | 0.6 |
| Example 5 | X1 | Y | — | — | — |
| Example 6 | X2 | Y | — | — | — |
| Example 7 | — | — | Y1 | Y | ∞ |
| Example 8 | X2 | Y | Y2 | Y | 1.0 |
| Example 9 | X2 | Y | Y2 | Y | 3.0 |
| Example 10 | X2 | Y | Y3 | Y | 0.25 |
| Example 11 | X2 | Y | Y3 | Y | 0.67 |
| Example 12 | X2 | Y | Y3 | Y | 1.5 |
| Example 13 | X2 | Y | Y3 | Y | 4.0 |

| | Ratio of second | | | | | |
|---|---|---|---|---|---|---|
| | compound to sum total | | | | | Fingerprint |
| | of first and second | Water contact | Water | Abrasion | Abrasion | removable |
| | compounds | angle [°] | repellency | Resistance 1 | Resistance 2 | property |
| Example 1 | 0.09 | 102 | A | A | C | A |
| Example 2 | 0.09 | 104 | A | A | C | A |
| Example 3 | 0.38 | 93 | B | A | — | C |
| Example 4 | 0.38 | 95 | B | A | — | C |
| Example 5 | — | 105 | AA | C | C | A |
| Example 6 | — | 107 | AA | C | C | A |
| Example 7 | 1 | 91 | C | A | — | C |
| Example 8 | 0.5 | 105 | AA | A | B | A |
| Example 9 | 0.75 | 104 | A | A | B | A |
| Example 10 | 0.2 | 106 | AA | A | A | A |
| Example 11 | 0.4 | 105 | A | A | A | A |
| Example 12 | 0.6 | 105 | AA | A | A | A |
| Example 13 | 0.8 | 106 | AA | A | A | A |

As shown in Table 1, it has been found out that since each of Examples 1 to 4 and 8 to 13 comprised the first and second compounds, and satisfied Requirements (1) and (2), they had excellent water repellency and excellent abrasion resistance. Based on the comparison between Example 1 and Example 3, the fingerprint removal property of Example 1 was superior to that of Example 3. Based on the comparison between Example 2 and Example 4, the fingerprint removal property of Example 2 was superior to that of Example 4. Further, it has been found out that, in Examples 8 to 13, in each of which the compound F was used as the second compound, the abrasion resistances, in particular, were more excellent.

The composition and the surface treatment agent according to the present disclosure can be used, for example, for substrates in display devices such as touch panel displays, optical elements, semiconductor elements, building materials, automobile components, and nanoimprinting technologies. Further, the composition and the surface treatment agent can be used for bodies, window glasses (front glasses, side glasses, and rear glasses), mirrors, bumpers, and the like in transportation apparatuses such as trains, automobiles, ships, and airplanes. Further, the composition and the surface treatment agent can be used for exterior walls of buildings, tents, photovoltaic modules, sound insulating plates, and outdoor articles such as concrete; and fishing nets, sweep nets, and water tanks. Further, the composition and the surface treatment agent can be used for kitchens, bathrooms, washstands, mirrors, and toiletry components; chandeliers and ceramics such as tiles; and artificial marble and various indoor apparatuses such as air conditioners. Further, the composition and the surface treatment agent can be used for antifouling treatments of jigs, inner walls, pipes, and the like in factories. Further, the composition and the surface treatment agent can be used for goggles, glasses, helmets, pachinko, fibers, umbrellas, play equipment, and soccer balls. Further, the composition and the surface treatment agent can be used as abherents for various packaging materials such as packaging materials for foods, packaging materials for cosmetics, and the interior of pots. Further, the composition and the surface treatment agent can be used for car navigation systems, mobile phones, smart phones, digital cameras, digital video cameras, PDAs, portable audio players, car audios, game apparatuses, lenses for eyeglasses, camera lenses, lens filters, sunglasses, medical apparatuses such as gastroscopes, copy machines, PCs, displays (e.g., liquid crystal displays, organic EL displays, plasma displays, and touch panel displays), touch panels, protective films, and optical components such as antireflection films.

What is claimed is:

1. A composition comprising:
a first compound having an organo (poly) siloxane residue, an alkylene chain comprising three or more carbon atoms, and a reactive silyl group a; and
a second compound having: a hydrocarbon group comprising four or more carbon atoms, which has no organo (poly) siloxane residue and may have a functional group or a substituent; and a reactive silyl group b, wherein
the composition satisfies Requirements (1) and (2) shown below:
Requirement (1): in the first compound, one reactive silyl group a is connected to at least one of ends of the organo (poly) siloxane residue; and
Requirement (2): in the second compound, one reactive silyl group b is connected to at least one of ends of the hydrocarbon group.

2. The composition according to claim 1, wherein the reactive silyl groups a and b are each independently represented by Formula (S1) or Formula (S2) shown below, 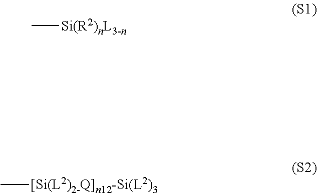
where
each R² is independently a monovalent hydrocarbon group,
each L is independently a hydrolyzable group, a group having a hydrolyzable group, or a hydroxyl group,
each L² is independently a hydrolyzable group, a group having a hydrolyzable group, a hydroxyl group, or a hydrocarbon group,
at least four of L² are hydrolyzable groups, groups having a hydrolyzable group, or hydroxyl groups,
each Q is independently an oxygen atom or an organic group having one carbon atom bonded to adjacent Si on both sides,
n is an integer of 0 to 2, and
n12 is an integer of 1 to 3.

3. The composition according to claim 1, wherein the organo (poly)siloxane residue contained in the first compound is represented by Formula (B1) shown below, 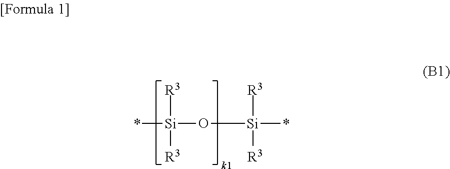
in Formula (B1),
each R³ is independently a hydrocarbon group,
k1 is a number of 1 or more, and
* indicates a part bonded to an adjacent atom.

4. The composition according to claim 1, wherein the number of carbon atoms of the alkylene chain contained in the first compound is 11 or more.

5. The composition according to claim 1, wherein the first compound is represented by Formula (C) shown below, 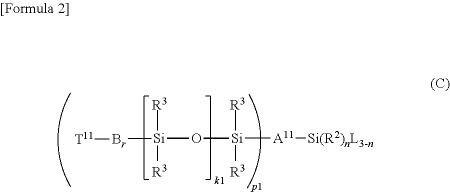
in Formula (C),
T¹¹ is a monovalent group comprising no reactive silyl group,
each B is independently —O— or —C(═O)—,
each r is independently 0 or 1,
each R³ is independently a hydrocarbon group,
each k1 is independently a number of 1 or more,
p1 is an integer of 1 or more,
A¹¹ is a linking group having a valence of (p1+1),
each R² is independently a hydrocarbon group,
each L is independently a hydrolyzable group, a group having a hydrolyzable group, or a hydroxyl group,
each n is independently an integer of 0 to 2, and
at least one of T¹¹ and A comprises an alkylene chain comprising three or more carbon atoms.

6. The composition according to claim 5, wherein k1 is 2 to 600 in Formula (C).

7. The composition according to claim 1, wherein the hydrocarbon group contained in the second compound is not directly bonded to an oxygen atom or a nitrogen atom.

8. The composition according to claim 1, wherein in the second compound, the reactive silyl group b is connected to only one of ends of the hydrocarbon group.

9. The composition according to claim 1, wherein the second compound is represented by Formula (G), 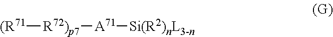
in Formula (G),
R⁷¹ is a hydrogen atom or [(CH₃)₃Q⁷¹-R⁷³]ₘ₇Q⁷²(CH₃)₃₋ₘ₇—,
each Q⁷¹ and Q⁷² is independently C or Si,
each R⁷³ is independently an alkylene group comprising 1 to 6 carbon atoms,
m7 is an integer of 0 to 3,
R⁷² is an alkylene group, and may have, when the number of carbon atoms is 2 or more, one or more groups selected from —O—, —S—, —C(═O)NH—, —NHC(═O)—, —C(═O)O—, —OC(═O)—, —C(═O)S—, —SC(═O)—, —S (═O)₂NH—, —NHS(═O)₂—, —S(═O)₂O—, —OS(═O)₂—, and a phenylene group between carbon atoms,
A⁷¹ is a single bond or a linking group having a valence of (p7+1),
each R² is independently a hydrocarbon group,
each L is independently a hydrolyzable group, a group having a hydrolyzable group, or a hydroxyl group,
n is an integer of 0 to 2, and
p7 is an integer of 1 or more.

10. The composition according to claim 1, wherein the second compound is represented by Formula (E) shown below, 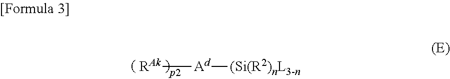
in Formula (E),
R^{Ak} is an alkyl group,
A^{d} is a single bond or a linking group having a valence of (p2+1),
p2 is an integer of 1 or more,
each R² is independently a hydrocarbon group,
each L is independently a hydrolyzable group, a group having a hydrolyzable group, or a hydroxyl group, and
n is an integer of 0 to 2.

11. The composition according to claim 10, wherein R^{Ak} is an alkyl group comprising 4 to 50 carbon atoms.

12. The composition according to claim 10, wherein R^{Ak} is an alkyl group comprising 8 to 30 carbon atoms.

13. The composition according to claim 1, wherein the second compound is a composition represented by Formula (F) shown below, 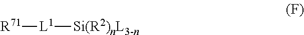
in Formula (F),
R⁷¹ is a hydrogen atom or [(CH₃)₃Q⁷¹-R⁷³—]ₘ₇Q⁷²(CH₃)₃₋ₘ₇—,
each Q⁷¹ and Q⁷² is independently C or Si,
at least one of Q⁷¹ and Q⁷² is Si,
each R⁷³ is independently an alkylene group comprising 1 to 6 carbon atoms,
m7 is an integer of 0 to 3,
L¹ is an alkylene group comprising 13 or more carbon atoms, and may have one or more groups selected from —O—, —S—, —C(═O)NH—, —NHC(═O)—, —C(═O)O—, —OC(═O)—, —C(═O)S—, —SC(═O)—, —S(═O)₂NH—, —NHS(═O)₂—, —S(═O)₂O—, —OS(═O)₂—, and a phenylene group between carbon atoms,
each R² is independently a hydrocarbon group,
each L is independently a hydrolyzable group, a group having a hydrolyzable group, or a hydroxyl group, and
n is an integer of 0 to 2.

14. The composition according to claim 13, wherein L¹ is an alkylene group comprising 13 to 36 carbon atoms.

15. The composition according to claim 13, wherein R¹ is (CH₃)₃Si—.

16. The composition according to claim 1, wherein a mass ratio of the second compound to the first compound is 0.01 to 0.9.

17. The composition according to claim 1, wherein a mass ratio of the second compound to a total mass of the first and second compounds is 0.001 to 0.9.

18. The composition according to claim 1, further comprising a liquid medium.

19. A surface treatment agent comprising a composition according to claim 1.

20. A method for manufacturing an article including a surface-treated layer formed on a substrate by performing a surface treatment on the substrate by using the surface treatment agent according to claim 19.

21. An article comprising a substrate, and a surface-treated layer disposed on the substrate, a surface of the surface-treated layer being treated with the surface treatment agent according to claim 19.

22. The article according to claim 21, wherein the article is an optical member.

23. The article according to claim 22, wherein the article is a display or a touch panel.
